(19) United States
(12) Patent Application Publication
(10) Pub. No.: US 2014/0350966 A1
(43) Pub. Date: Nov. 27, 2014

(54) SYSTEMS AND METHODS FOR MANAGING MEDICAL SERVICES

(71) Applicant: BOSTON SCIENTIFIC NEUROMODULATION CORPORATION, Valencia, CA (US)

(72) Inventors: Bhumika Khatana, Valencia, CA (US); Stanley Leonard Van Gent, Stevenson Ranch, CA (US); Tom Jozef Smolders, Stevenson Ranch, CA (US); Jessica Anne Hoogs, Valencia, CA (US)

(73) Assignee: BOSTON SCIENTIFIC NEUROMODULATION CORPORATION, Valencia, CA (US)

(21) Appl. No.: 14/286,865

(22) Filed: May 23, 2014

Related U.S. Application Data
(60) Provisional application No. 61/827,540, filed on May 24, 2013.
(60) Provisional application No. 61/896,575, filed on Oct. 28, 2013.

(51) Int. Cl. G06F 19/00

(52) U.S. Cl. CPC G06F 19/322
USPC 705/3

(57) ABSTRACT

Systems and methods are provided for managing patients during pain management treatment that includes a server and a medical database including patient information associated with patients within a territory, the medical information including a status of each patient indicating a stage of treatment between a candidate for treatment stage, one or more pre-treatment stages, and one or more treatment stages. The system also includes team electronic devices communicating with the server to add and/or update information regarding patients in the medical database and/or synchronize local databases of the team electronic devices with the medical database.

### RELATED APPLICATION DATA

This application claims benefit of co-pending provisional applications Ser. No. 61/827,540, filed May 24, 2013, and 61/896,575, filed Oct. 28, 2013, the entire disclosures of which are expressly incorporated by reference herein.

### FIELD OF THE INVENTION

The present invention relates to systems and methods for managing medical information and/or services, e.g., by sales representatives, medical personnel, and the like. For example, the systems and methods herein may facilitate identifying candidate patients for treatment, monitoring trial, surgical procedures, and/or other treatment, locating equipment from distributed inventory for procedures, managing sales activities, and the like, using an electronic device, such as a wireless and/or mobile device, e.g., a tablet computer, smart cellular telephone, and the like, via a network, such as a telecommunications network and/or the Internet.

### BACKGROUND

In many medical fields, sales personnel actively interact with patients, physicians, and/or medical facilities. For example, sales personnel may interact with patients to discuss treatment options and/or may be present or actively involved with physicians or other healthcare providers in determining appropriate treatments for patients and/or monitoring such treatments. In addition, such sales personnel may operate in teams, e.g., with multiple individuals involved in various stages of advising and/or treating patients, and therefore may want to share information between members of the teams. Presently, such information may be shared in a piecemeal, ad hoc manner, which may be inefficient to all involved.

Accordingly, systems and methods that facilitate managing medical services and/or sales would be useful.

### SUMMARY

The present invention is directed to systems and methods for managing medical information and/or services, e.g., by sales representatives, medical personnel, and the like. For example, the systems and methods herein may facilitate identifying candidate patients for treatment, monitoring trial, surgical procedures, and/or other treatment, locating equipment from distributed inventory for procedures, managing sales activities, and/or otherwise managing information, using an electronic device, such as a wireless and/or mobile device, e.g., a tablet computer, smart cellular telephone, and the like, via a network, such as a telecommunications network and/or the Internet.

As described elsewhere herein, the systems and methods herein may have particular application in pain management programs, e.g., in facilitating identifying, monitoring, and/or managing patients considered for pain treatment procedures. However, the systems and methods may have broader applications in other medical treatments and/or fields.

In accordance with one embodiment, a system is provided for managing patients during medical treatment, e.g., during pain management treatment, that includes a server; and a medical database communicating with the server, the medical database including patient information associated with patients within a territory undergoing medical treatment, the medical information including a status of each patient indicating a stage of treatment between a candidate for treatment stage, one or more pre-treatment stages, and one or more treatment stages. A communication interface communicates between the server and a plurality of team electronic devices associated with respective team members within the territory, the communication interface configured to receive communications from individual team electronic devices indicating that patients have advanced between stages of treatment, whereupon the server updates the status of the patients in the medical database to reflect the current status of patients between the stages of treatment. The server may be configured to synchronize local databases of the team electronic devices with the medical database to update the local databases with the statuses of patients in the medical database such that team members may review the current status of an individual patient in the medical database.

In accordance with another embodiment, a method is provided for managing patients during medical treatment, e.g., pain management treatment, using a server communicating with a plurality of team electronic devices associated with respective team members within a territory; a medical database communicating with the server that includes patient information associated with patients within the territory undergoing medical treatment, the medical information including a status of each patient indicating a stage of treatment between a candidate for treatment stage, one or more pre-treatment stages (e.g., trial pre-op and implant prep stages), and one or more treatment stages (e.g., trial and implant stages). The method may include receiving, at the server, a first communication from a team electronic device indicating that a patient at a candidate for treatment stage has decided to proceed with treatment, the server updating the status of the patient to pre-treatment stage; receiving, at the server, a second communication from a team electronic device indicating that the patient has been scheduled for treatment, the server updating the status of the patient in the medical database to treatment stage; and receiving, at the server, a third communication from a team electronic device indicating that the patient has completed treatment, wherein the server intermittently synchronizes the medical database with local databases on the team electronic devices to update the local databases with information regarding the patient including the status of the patient.

In accordance with still another embodiment, a system is provided for managing patients considering medical treatment, e.g., pain management treatment, that includes an administrator server; a medical database communicating with the administrator server, the medical database including patient information associated with patients within a territory considering pain management treatment, the medical information including a status of each patient indicating a stage of treatment selected from one of: a) candidate stage, b) rep contact stage, c) trial pre-op stage, d) trial stage, e) implant prep stage, and f) implant stage; and a plurality of team electronic devices associated with respective team members within the territory. Each team electronic device may include a local database, a graphical user interface via which a team member updates status of a patient in the local database when the team member encounters the patient, and a communication interface for communicating updates in status of patients to the medical database via the administrator server. A server communication interface may communicate between the administrator server and the team electronic devices for synchronizing local databases with the medical database.

In accordance with yet another embodiment, a method is provided for managing a patient during medical treatment, e.g., pain management treatment, by a team of sales representatives using team electronic devices that includes presenting on a display of a first team electronic device information regarding a patient who is a candidate for pain management treatment and a scale including a plurality of icons representing stages of treatment of the patient. After initial consultation with the patient, the method may include: i) entering, via a user interface of the first team electronic device, patient information including confirmation that the patient would like to enter trial pain management treatment; and ii) selecting an icon presented on the display of the first team electronic device to advance the patient to a trial pre-op stage.

Thereafter, during or after pre-trial consultation with the patient, the method may also include: i) presenting, on a display of a second team electronic device, information regarding the patient including information entered using the first team electronic device, wherein a second icon on the scale is highlighted relative to other icons on the scale indicating the patient is at the trial pre-op stage; ii) entering, via a user interface of the second team electronic device, pain information regarding pain being experienced by the patient; and iii) selecting an icon presented on the display of the second team electronic device to advance the patient to a trial stage.

Thereafter, after a trial procedure in which a set of leads are implanted in the patient's body, the method may also include: i) presenting, on a display of a third team electronic device, pain information regarding the patient including information entered using the second team electronic device, wherein a third icon on the scale is highlighted relative to other icons on the scale indicating the patient is at the trial stage; and ii) entering, via a user interface of the third team electronic device, trial treatment information regarding pain treatment being experienced by the patient after the second procedure.

Optionally, the second team electronic device may be the same electronic device as the first team electronic device, the third team electronic device may be the same electronic device as the second team electronic device, the second team electronic device may be a different electronic device than the first team electronic device, or the third team electronic device may be a different electronic device than the second team electronic device.

Optionally, after consultation with the patient after the trial procedure, the method may also include: i) presenting, on a display of a fourth team electronic device, patient information regarding the patient including information entered using the third team electronic device, wherein a third icon on the scale is highlighted relative to other icons on the scale indicating the patient is at the trial stage; i) entering, via a user interface of the fourth team electronic device, patient information including confirmation that the patient would like to complete implantation of a permanent pain management system; and ii) selecting an icon presented on the display of the team electronic device to advance the patient to an implant prep stage.

Optionally, thereafter, after confirming scheduling of a second procedure, the method may also include: i) presenting, on a display of a fifth team electronic device, patient information regarding the patient, wherein a fourth icon on the scale is highlighted relative to other icons on the scale indicating the patient is at the implant prep stage; and ii) selecting an icon presented on the display of the team electronic device to advance the patient to an implant stage.

Optionally, thereafter, after a second procedure in which a second set of leads are implanted in the patient's body, the method may also include: i) presenting, on the display of a sixth team electronic device, pain information regarding the patient, wherein a fifth icon on the scale is highlighted relative to other icons on the scale indicating the patient is at the implant stage; and ii) entering, via a user interface of the sixth team electronic device, treatment information regarding pain treatment being experienced by the patient after the second procedure.

In accordance with still another embodiment, a method is provided for managing a patient during medical treatment, e.g., pain management treatment, using a portable electronic device that includes presenting, on a display of the electronic device, information regarding a patient who is a candidate for pain management treatment and a scale including a plurality of icons representing stages of treatment of the patient. After initial consultation with the patient, the method may include: i) presenting, on the display, information regarding the patient, wherein a first icon on the scale is highlighted relative to other icons on the scale indicating the patient is at a candidate stage; ii) entering, via a user interface of the electronic device, patient information including confirmation that the patient would like to enter trial pain management treatment; and iii) selecting an icon presented on the display to advance the patient to a trial pre-op stage.

Thereafter, during or after pre-trial consultation with the patient, the method may also include: i) presenting, on the display, information regarding the patient, wherein a second icon on the scale is highlighted relative to other icons on the scale indicating the patient is at the trial pre-op stage; ii) entering, via the user interface, pain information regarding pain being experienced by the patient; and iii) selecting an icon presented on the display to advance the patient to a trial stage.

Thereafter, after a trial procedure in which a set of leads are implanted in the patient's body, the method may also include: i) presenting, on the display, pain information regarding the patient, wherein a third icon on the scale is highlighted relative to other icons on the scale indicating the patient is at the trial stage; and ii) entering, via the user interface, trial treatment information regarding pain treatment being experienced by the patient after the trial procedure.

In accordance with yet another embodiment, a portable electronic device is provided for managing a patient during medical treatment, e.g., pain management treatment, that includes a processor, a display, and a user interface, the processor configured to present on the display an information field and a scale including a plurality of icons representing stages of treatment of the patient. The processor may be configured for presenting, on the display, information regarding a patient who is a candidate for pain management treatment and a scale including a plurality of icons representing stages of treatment of the patient, and after initial consultation with the patient: i) presenting, on the display, information regarding the patient, wherein a first icon on the scale is highlighted relative to other icons on the scale indicating the patient is at a candidate stage; ii) receiving, via the user interface, patient information including confirmation that the patient would like to enter trial pain management treatment; and iii) receiving, via the user interface, indication that an icon presented on the display has been selected to advance the patient to a trial pre-op stage.

Thereafter, during or after pre-trial consultation with the patient, the processor may be configured for: i) presenting, on the display, information regarding the patient, wherein a second icon on the scale is highlighted relative to other icons on the scale indicating the patient is at the trial pre-op stage; ii) receiving, via the user interface, pain information regarding pain being experienced by the patient; and iii) receiving, via the user interface, indication that an icon presented on the display has been selected to advance the patient to a trial stage. Thereafter, after a trial procedure in which a set of leads are implanted in the patient's body, the processor may be configured for: i) presenting, on the display, pain information regarding the patient, wherein a third icon on the scale is highlighted relative to other icons on the scale indicating the patient is at the trial stage; and ii) receiving, via the user interface, trial treatment information regarding pain treatment being experienced by the patient after the trial procedure.

Optionally, the processor is further configured for, after consultation with the patient after the trial procedure: i) presenting, on the display, patient information, wherein a third icon on the scale is highlighted relative to other icons on the scale indicating the patient is at the trial stage; ii) receiving, via the user interface, patient information including confirmation that the patient would like to complete implantation of a permanent pain management system; and ii) receiving, via the user interface, indication that an icon presented on the display has been selected to advance the patient to an implant prep stage. Thereafter, after confirming scheduling of second procedure, the processor may be configured for: i) presenting, on the display, patient information regarding the patient, wherein a fourth icon on the scale is highlighted relative to other icons on the scale indicating the patient is at the implant prep stage; and ii) receiving, via the user interface, indication that an icon presented on the display has been selected to advance the patient to an implant stage.

Thereafter, after a second procedure in which a second set of leads are implanted in the patient's body, the processor may be configured for: i) presenting, on the display, pain information regarding the patient, wherein a fifth icon on the scale is highlighted relative to other icons on the scale indicating the patient is at the implant stage; and ii) receiving, via the user interface, treatment information regarding pain treatment being experienced by the patient after the second procedure.

In accordance with another embodiment, a method is provided for monitoring treatment of a patient using a portable electronic device that includes, during a consultation with a patient: i) presenting, on a touchscreen of the electronic device, a graphical image of at least a portion of a body; ii) entering consultation indicia, via the touchscreen, that is superimposed on the graphical image to create a consultation image that identifies one or more regions of the patient's body for treatment based at least in part on the patient's input. After completing an initial treatment of the patient, the method may include: i) presenting, on the touchscreen, the consultation image including the consultation indicia superimposed on the graphical image; and ii) entering treatment indicia, via the touchscreen, that is superimposed on the consultation image to create a treatment image that identifies one or more regions of the patient's body affected by the treatment based at least in part on the patient's input.

In accordance with still another embodiment, a method is provided for monitoring medical treatment, e.g., pain management treatment, of a patient using a portable electronic device that includes, during a consultation with a patient: i) presenting, on a touchscreen of the electronic device, a graphical image of at least a portion of a body; and ii) entering consultation indicia, via the touchscreen, that is superimposed on the graphical image to create a consultation image that identifies one or more regions of the patient's body experiencing pain based at least in part on the patient's input. After providing a pain treatment device for the patient, the method may include: i) presenting, on the touchscreen, the consultation image including the consultation indicia superimposed on the graphical image; and ii) entering treatment indicia, via the touchscreen, that is superimposed on the consultation image to create a treatment image that identifies one or more regions of the patient's body where the pain previously experienced by the patient has been improved based at least in part on the patient's input.

In accordance with yet another embodiment, a method is provided for managing a patient during medical treatment, e.g., pain management treatment, by a team of sales representatives using team electronic devices that includes: a) presenting on a display of a team electronic device information regarding a patient who is a candidate for pain management treatment, and, after initial consultation with the patient: i) entering, via a user interface of the team electronic device, patient information including confirmation that the patient would like to enter trial pain management treatment; and ii) selecting an icon presented on the display of the team electronic device to advance the patient to a trial pre-op stage.

Thereafter, during or after pre-trial consultation with the patient, the method may include: i) presenting, on a display of a team electronic device, information regarding the patient including a graphical image of a human body; ii) entering, via a user interface of the team electronic device, consultation indicia on the graphical image regarding pain being experienced by the patient; and iii) selecting an icon presented on the display of the team electronic device to advance the patient to a trial stage.

Thereafter, after a trial procedure in which a set of leads are implanted in the patient's body, the method may include: i) presenting, on a display of a team electronic device, information regarding the patient including the graphical image and the consultation indicia; and ii) entering, via a user interface of the team electronic device, trial indicia on the graphical image regarding pain treatment being experienced by the patient after the trial procedure.

In accordance with still another embodiment, a portable electronic device is provided for monitoring treatment of a patient using a portable electronic device that includes a processor and a touchscreen communicating with the processor. The processor may be configured to present, on the touchscreen during a consultation with a patient, a graphical image of at least a portion of a body, the touchscreen configured for entering consultation indicia that is superimposed on the graphical image to create a consultation image displayed on the touchscreen that identifies one or more regions of the patient's body for treatment based at least in part on the patient's input. The processor may be further configured, after completing an initial treatment of the patient, to present, on the touchscreen, the consultation image including the consultation indicia superimposed on the graphical image, the touchscreen further configured for entering treatment indicia that is superimposed on the consultation image to create a treatment image that identifies one or more regions of the patient's body affected by the treatment based at least in part on the patient's input.

In accordance with yet another embodiment, a method is provided for managing a patient during medical treatment, e.g., pain management treatment, by a team of sales representatives using team electronic devices that includes, after consultation with the patient, receiving from a first team electronic device a consultation image file including a graphical image of a human body and consultation indicia superimposed on the graphical image by the first team electronic device regarding pain being experienced by the patient; adding the consultation image file to a medical database including information regarding treatment of the patient; transmitting the consultation image to a plurality of team electronic devices when local database of the plurality of team electronic devices are synchronized with the medical database; after a trial procedure is performed on the patient, receiving from a second team electronic device a trial treatment image file including the consultation image and trial treatment indicia superimposed on the graphical image and the consultation indicia by the second team electronic device regarding pain treatment being experienced by the patient after the trial procedure; and adding the trial treatment image file to the medical database.

In accordance with another embodiment, a method is provided for managing physicians involved in medical treatment, e.g., pain management treatment, of patients using a portable electronic device having a local database including information regarding physicians within a territory and patients associated with respective physicians, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure. The method may include entering, via a user interface of the electronic device, a request to review patients associated with a selected physician; accessing a local database of the electronic device to identify patients associated with the selected physician; and presenting, on a display of the electronic device, a first graphical output including names of the patients associated with the selected physician and the status of the patients.

In accordance with still another embodiment, a portable electronic device is provided for managing physicians involved in medical treatment, e.g., pain management treatment, of patients that includes a local database including a plurality of physicians and patients associated with respective physicians; a user interface for submitting a request to review patients associated with a selected physician; a processor for accessing the local database to identify patients associated with the selected physician and a status of the patients, the status identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure; and a display for presenting a first graphical output including names of the patients and the status of the respective patients.

In accordance with still another embodiment, a method is provided for managing physicians involved in medical treatment, e.g., pain management treatment, of patients using an electronic device having a local database including information regarding physicians within a territory and patients associated with respective physicians, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure. Generally, the method may include entering, via a user interface of the electronic device, a request to review physicians within the territory; accessing the local database to determine the number of patients associated with each physician within the territory and a current status of the patients associated with each physician; and presenting, on a display of the electronic device, a graphical output including rows of physician information, each row including a name of a physician and total numbers of patients associated with each physician separated by the current stage of treatment of the patients.

In accordance with yet another embodiment, a portable electronic device is provided for managing physicians involved in medical treatment, e.g., pain management treatment, of patients that includes a local database including information regarding physicians within a territory and patients associated with respective physicians, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure; a user interface for submitting a request to review physicians within the territory; a processor for accessing the local database to determine the number of patients associated with each physician within the territory and a current status of the patients associated with each physician; and a display for presenting a first graphical output including rows of physician information, each row including a name of a physician and total numbers of patients associated with each physician separated by the current stage of treatment of the patients.

In accordance with still another embodiment, a method is provided for managing physicians involved in medical treatment, e.g., pain management treatment, of patients using an electronic device that includes entering, via a user interface of the electronic device, a request to review physicians within the territory; sending, via a communication interface of the electronic device to a remote server, an inquiry including a request to review physicians within the territory using a medical database including information regarding physicians within a territory and patients associated with respective physicians, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure; receiving, via the communication interface, a communication including the number of patients associated with each physician within the territory and a current status of the patients associated with each physician; and presenting, on a display of the electronic device, a graphical output including rows of physician information, each row including a name of a physician and total numbers of patients associated with each physician separated by the current stage of treatment of the patients.

In accordance with another embodiment, a method is provided for managing medical facilities involved in medical treatment, e.g., pain management treatment, of patients using a portable electronic device having a local database including information regarding medical facilities within a territory and patients associated with respective medical facilities, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure. Generally, the method may include entering, via a user interface of the electronic device, a request to review patients associated with a selected medical facility; accessing a local database of the electronic device to identify patients associated with the selected medical facility; and presenting, on a display of the electronic device, a first graphical output including names of the patients associated with the selected medical facility and the status of the patients.

In accordance with still another embodiment, a portable electronic device is provided for managing medical facilities involved in medical treatment, e.g., pain management treatment, of patients that includes a local database including a plurality of medical facilities and patients associated with respective medical facilities; a user interface for submitting a request to review patients associated with a selected medical facility; a processor for accessing the local database to identify patients associated with the selected medical facility and a status of the patients, the status identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure; and a display for presenting a first graphical output including names of the patients and the status of the respective patients.

In accordance with yet another embodiment, a method is provided for managing medical facilities involved in medical treatment, e.g., pain management treatment, of patients using an electronic device having a local database including information regarding physicians and medical facilities within a territory and patients associated with respective physicians and facilities, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure. Generally, the method may include entering, via a user interface of the electronic device, a request to review physicians associated with a selected medical facility; accessing the local database to determine the number of patients associated with each physician also associated with the selected medical facility and a current status of the patients associated with each physician; and presenting, on a display of the electronic device, a graphical output including rows of physician information, each row including a name of a physician and total numbers of patients associated with each physician separated by the current stage of treatment of the patients.

In accordance with still another embodiment, a portable electronic device is provided for managing medical facilities involved in medical treatment, e.g., pain management treatment, of patients that includes a local database including information regarding physicians and medical facilities within a territory and patients associated with respective physicians and medical facilities, the local database including a status of each patient identifying a current stage of treatment of each patient, the status including one or more of candidate for pain treatment, scheduled for a trial pain treatment procedure, completed a trial pain treatment, scheduled for a long term pain treatment implantation procedure, and completed a long term pain treatment implantation procedure; a user interface for submitting a request to review physicians associated with a selected medical facility; a processor for accessing the local database to determine the number of patients associated with each physician also associated with the selected medical facility and a current status of the patients associated with each physician; and a display for presenting a first graphical output including rows of physician information, each row including a name of a physician and total numbers of patients associated with each physician separated by the current stage of treatment of the patients.

In accordance with another embodiment, a method is provided for locating a medical device using a portable electronic device that includes transmitting a request, via a communication interface of the electronic device, to a remote server via a network, the request identifying a desired medical device and a geographical region; receiving from the remote server a data file including a list of available medical devices satisfying the request; and presenting, on a display of the electronic device, the list of available medical devices including identifiers and expiration dates unique to each of the medical devices on the list, and wherein the list is color coded to identify status of each of the available medical devices relative to the expiration dates.

In accordance with still another embodiment, a method is provided for locating a medical device using a portable electronic device having a local database within an environment in which inventory is distributed to multiple team members and the local database includes information regarding parts distributed to respective team members. Generally, the method may include entering, via a user interface of the electronic device, a search request identifying one or more desired medical devices; accessing the local database of the electronic device to generate a list of available medical devices satisfying the search request; and presenting, on a display of the electronic device, the list of available medical devices including identifiers and expiration dates unique to each of the medical devices on the list, and wherein the list is color coded to identify status of each of the available medical devices relative to the expiration dates.

In accordance with yet another embodiment, a method is provided for locating a medical device using a portable electronic device having a local database within an environment in which inventory is distributed to multiple team members and the local database includes information regarding parts distributed to respective team members. Generally, the method may include entering, via a user interface of the electronic device, a search request identifying at least one of a team member, a geographical region, a part number, and a part description; accessing the local database of the electronic device to generate a list of available medical devices satisfying the search request; and presenting, on a display of the electronic device, the list of available medical devices.

In accordance with still another embodiment, a portable electronic device is provided for locating a medical device within an environment in which inventory is distributed to multiple team members that includes a local database including information regarding parts distributed to respective team members; a user interface for entering a search request identifying at least one of a team member, a geographical region, a part number, and a part description; a processor for accessing the local database of the electronic device to generate a list of available medical devices satisfying the search request; and a display coupled to the processor for presenting the list of available medical devices.

In accordance with yet another embodiment, a system is provided for locating a medical device within an environment in which inventory is distributed to multiple team members that includes a server communicating with a medical database including information regarding parts distributed to respective team members; a communication interface for receiving a search request from a remote electronic device, the search request identifying a desired medical device and a geographical region; the server configured to access the medical database and generate a data file including a list of available medical devices satisfying the search request; and wherein the communication interface is configured for transmitting the list to the remote electronic device for presentation on a display of the electronic device, the list of available medical devices including identifiers and expiration dates unique to each of the medical devices on the list, and wherein the list is color coded to identify status of each of the available medical devices relative to the expiration dates.

Other aspects and features of the present invention will become apparent from consideration of the following description taken in conjunction with the accompanying drawings.

### BRIEF DESCRIPTION OF THE DRAWINGS

The drawings illustrate exemplary embodiments of the invention, in which:

FIG. 1 is a schematic drawing showing a network architecture providing an exemplary embodiment of a system for managing medical services.

FIG. 2 is a schematic of an exemplary electronic device that may be used to manage medical services, e.g., by a sales representative, medical personnel, and the like.

FIG. 3 is a flow chart showing an exemplary configuration for an application for managing medical services, e.g., using the electronic device of FIG. 2.

FIGS. 4A and 4B are screen shots showing an exemplary General screen that may be displayed on an electronic device, such as that shown in FIG. 2, from which a user may select a territory that will form the basis for subsequent use of the application.

FIG. 5 is a flowchart showing exemplary stages that may be available in a Patient module for identifying, monitoring, and/or managing patients using the systems and methods herein.

FIGS. 6A-6L(2) are exemplary screen shots of a Patient module including information related to patients considering or undergoing treatment that may be presented and/or modified by a representative using an electronic device, such as the electronic device of FIG. 2.

FIGS. 7A-7G are exemplary screen shots of a Physician module including information related to physicians and their patients that may be presented and/or generated by a representative using an electronic device, such as the electronic device of FIG. 2.

FIGS. 8A-8C are exemplary screen shots of a Facilities module including information related to medical facilities that may be presented and/or generated by a representative using an electronic device, such as the electronic device of FIG. 2.

FIGS. 9A-9C are exemplary screen shots of an Activities module including activities information that may be presented and/or generated by a representative using an electronic device, such as the electronic device of FIG. 2.

FIGS. 10A-10B are exemplary screen shots of an Inventory module including inventory-related information that may be presented and/or generated by a representative using an electronic device, such as the electronic device of FIG. 2.

FIGS. 11A-11E are exemplary screen shots of a Sales Activities module including sales and/or other business information that may be presented and/or generated by a representative using an electronic device, such as the electronic device of FIG. 2.

### DETAILED DESCRIPTION OF THE EXEMPLARY EMBODIMENTS

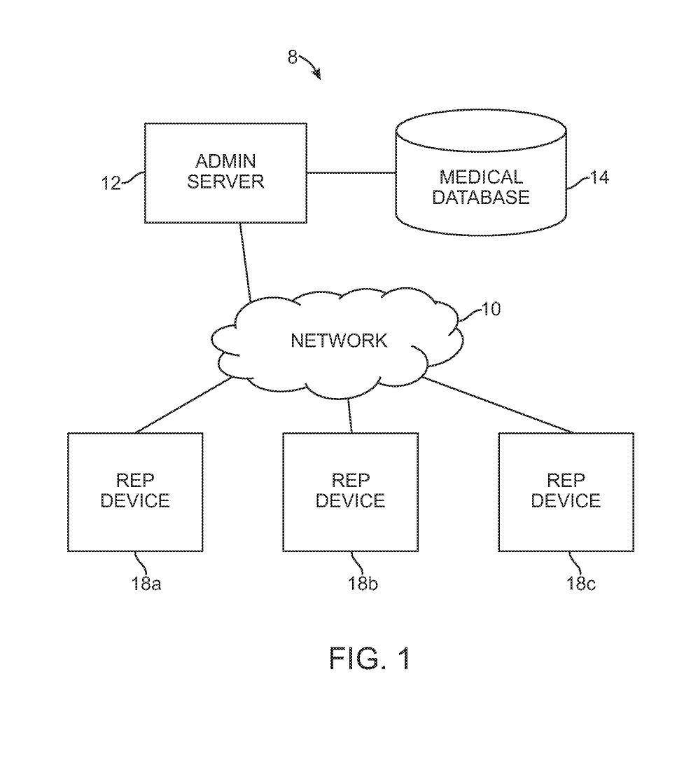

Turning to the drawings, FIG. 1 shows an exemplary embodiment of a system 8 for managing medical information and/or services, e.g., via a network 10, such as a telecommunications network and/or the Internet. Although the systems and methods herein have particular utility with identifying, managing, and/or monitoring patients considering and/or undergoing pain management treatments, such as spinal cord stimulation pain management, the systems and methods may be used for other medical treatments and/or sales arrangements. For example, the systems and methods herein may also be useful for managing information related to deep brain stimulation (e.g., Parkinson's disease, dystonia, essential tremor, migraine, and the like), treatment for overactive bladder, asthma, and/or other types of medical treatments where management of a trial and permanent implant may be involved and/or non-surgical indications/procedures. In addition or alternatively, the systems and methods herein may be useful for managing information involving medical implants (which may or may not include trial and permanently implanted systems), such as a pacemaker, a defibrillator, a cochlear stimulator, a retinal stimulator, a stimulator configured to produce coordinated limb movement, a cortical stimulator, a deep brain stimulator, peripheral nerve stimulator, micro-stimulator, and/or other neural stimulator configured to treat urinary incontinence, sleep apnea, shoulder sublaxation, headache, and the like.

As shown in FIG. 1, the system 8 generally includes one or more administrator or other servers 12 including a medical database 14, and a plurality of sales rep or other user electronic devices, such as representative electronic devices 18a, 18b, 18c, connected to and/or communicating via the network 10.

In exemplary embodiments, the network 10 may be a telecommunications network, including a wide area network (“WAN”), a local area network (“LAN”), an intranet, a wireless network, and/or a telephony network. For example, the network 10 may incorporate several different types of networks including a WAN, a LAN, and/or a wireless network; one such network including multiple different types of networks is the Internet.

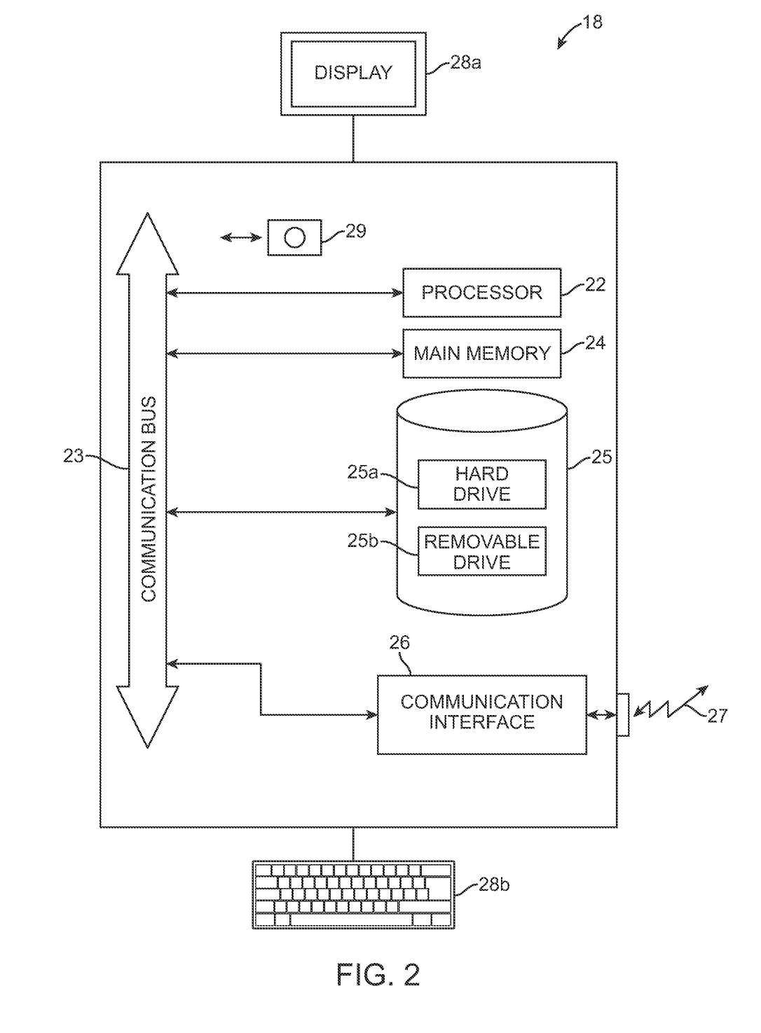

Each of the user electronic devices 18 may be an electronic and/or computing device, such as a tablet computer, a mobile, smart, and/or cellular telephone, a personal digital assistant, a wi-fi device, a desktop computer, a laptop computer, and the like, capable of communicating via the network 10. Generally, as shown in FIG. 2 and described further below, each of the electronic devices 18 may be a portable or mobile device including one or more processors 22, memory and/or other storage devices 24, 25, communication interfaces 26, and/or user interfaces 28, e.g., as shown in FIG. 2, and described further below. In an exemplary embodiment, each of the user electronic devices 18 may be an iPad® or other tablet device.

The administrator server 12 may include one or more computer systems including one or more processors, memory and/or storage devices, and communication interfaces (not shown) for communicating via the network 10, e.g., with the electronic devices 18. The administrator server 12 may include one or more hardware-based components and/or software-based modules for performing the various functions related to the system 8, as described elsewhere herein. For example, the administrator server 12 may a) synchronize portions of the medical database 14 with the electronic devices 18, e.g., periodically or otherwise intermittently, b) receive requests for information or other inquiries from the electronic devices 18 and process such inquiries, e.g., using the medical database 14, and/or c) may facilitate communications and/or other information sharing between the electronic devices 18, as described further elsewhere herein.

As shown, the administrator server 12 may communicate directly with the medical database 14, e.g., if the administrator server 12 is at the same physical location as the medical database 14. Alternatively, the administrator server 12 and medical database 14 may be located at one or more different locations from one another, and may communicate via the network 10. Although only one administrator server 12 and medical database 14 are shown, it will be appreciated that a single administrator server 12 may communicate with multiple and/or distributed medical databases 14 (not shown), e.g., each database responsible for different geographic regions, and/or that multiple administrator servers (also not shown) may be provided for the same or different medical databases.

Turning to FIG. 2, an exemplary embodiment of an electronic device 18 is shown that includes one or more hardware and/or software components for performing the methods described herein. As shown, the electronic device 18 may be a wireless device, e.g., a tablet computer, a mobile, smart, and/or cellular telephone, a personal digital assistant, a Wi-Fi device, a desktop computer, a laptop computer, and the like, capable of communicating via the network 10 (not shown, see FIG. 1). The electronic device 18 generally includes one or more processors, such as exemplary processor 22, for completing the various tasks described herein, e.g., to display and/or modify patient information, physician information, facilities information, activities, inventory, and the like, as described further below. Additional processors (not shown) may be provided, such as an auxiliary processor to manage input/output or perform floating point mathematical operations, a special-purpose microprocessor having an architecture rapid execution of signal processing algorithms, a slave processor subordinate to the main processing system (“back-end processor”), and/or a coprocessor (not shown). Such auxiliary processors may be discrete processors or may be integrated with the processor 22.

The processor 22 is generally connected to a communication bus 23. The communication bus 23 may include a data channel for facilitating information transfer between storage and/or other components of the electronic device 18. The communication bus 23 may also provide signals required for communication with the processor 12, including a data bus, address bus, and/or control bus (not shown). The communication bus 23 may include any known bus architecture, for example, industry standard architecture (ISA), extended industry standard architecture (EISA), Micro Channel Architecture (MCA), peripheral component interconnect (PCI) local bus, IEEE 488 general-purpose interface bus (GPIB), IEEE 696/S-100, and the like.

The electronic device 18 also includes memory and/or storage devices, e.g., main memory 24 and secondary memory or storage devices 25. The main memory 24 may provide storage of instructions and/or data for programs executed on the processor 22. In exemplary embodiments, the main memory 24 may be semiconductor-based memory, such as dynamic random access memory (DRAM) and/or static random access memory (SRAM). In addition, other semiconductor-based memory may also be provided, such as synchronous dynamic random access memory (SDRAM), Rambus dynamic random access memory (RDRAM), ferroelectric random access memory (FRAM), and the like, as well as read only memory (ROM).

The secondary memory 25 may include a hard disk drive 25a and/or a removable storage drive 25b, for example, a flash drive, a floppy disk drive, a magnetic tape drive, an optical disk drive, a CDROM drive, a DVDROM drive, and the like (not shown). The removable storage drive 25b may read from and/or write to a removable storage unit (not shown) in a well-known manner. In exemplary embodiments, the removable storage unit may include a floppy disk, magnetic tape, optical disk, CDROM disk, DVDROM disk, and the like, which may be read from and/or written to removable storage drive 25b. Additionally, the removable storage unit may include a computer usable storage medium with computer software and computer data stored thereon.

Optionally, the secondary memory 25 may include other components allowing computer programs and/or other instructions to be loaded into the electronic device 18. For example, such components may include semiconductor-based memory such as programmable read-only memory (PROM), erasable programmable read-only memory (EPROM), electrically erasable read-only memory (EEPROM), or flash memory (block oriented memory similar to EEPROM). Also included are any other interfaces and removable storage units that allow software and data to be transferred from the removable storage unit to the electronic device 18.

The electronic device 18 also generally includes one or more communication interfaces 26, e.g., one or more transceivers, receivers, and/or transmitters. Communication interface(s) 26 may allow software and/or data to be transferred between the electronic device 18 and the administrator server 12, other electronic devices 18, and/or other external devices, networks, or information sources. Examples of communication interface 26 include but are not limited to an infrared or radiofrequency (“RF”) interface (such as those that use the Bluetooth standard), a modem, a network interface (for example, an Ethernet card), a communications port, a PCMCIA slot and card, and the like. The communication interface(s) 26 may implement industry promulgated architecture standards, such as Ethernet IEEE 802 standards, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and the like. Software and/or data transferred via the communication interface 26 may be transferred using signals 27, such as electronic, electromagnetic, optical signals, and the like. The signals 27 may be implemented using wires, cables, fiber optics, telephone lines, cellular phone links, radio frequency (RF) links, inductive links, and/or other communications channels.

Computer programming instructions, e.g., computer programs, software, or firmware, may be stored in the main memory 24 and/or the secondary memory 25. Computer programs may also be received via the communication interface 26. Such computer programs, when executed, may enable the electronic device 18 to perform one or more of the features described elsewhere herein.

As used herein, “computer program product” may refer to any media used to provide programming instructions to the electronic device 18. Examples of such media include removable storage units in removable storage drive 25b, a hard disk installed in hard disk drive 25a, and signals 27. Thus, a computer program product may include means for providing programming instructions to the electronic device 18.

Where the methods and/or features described herein are completed using software, the software may be stored in a computer program product and loaded into the electronic device 18, e.g., using the hard disk drive 25a, removable storage drive 25b, and/or communication interface 26. The computer programming instructions, when executed by the processor 22, may cause the processor 22 to perform the methods and/or features described herein. In addition or alternatively, one or more of the methods and/or features may be implemented primarily in hardware using hardware components, such as application specific integrated circuits (“ASICs”).

In addition, the electronic device 18 may include one or more user interfaces 28, e.g., a display or other output device 28a, and a keyboard, mouse, touch pad, voice recognition device, and/or other input device 28b. The input device(s) 28b may facilitate a user controlling and/or otherwise communicating with the processor 22 or other components of the electronic device 18, while the output device(s) 28a may allow information to be presented and/or manipulated in a desired manner, e.g., to present a series of menus, fields, pages, and/or other images, as described elsewhere herein. In one embodiment, the electronic device 18 may include a touch screen (not shown) that may act as both a display 28a and as an input device 28b, allowing the user to scroll through menus or images, and/or select icons, e.g., by touching or otherwise selecting corresponding images on the touch screen, as described elsewhere herein.

Optionally, the electronic device 18 may include one or more additional components, such as a camera 29, voice recognition device, recorder, and the like. For example, as described elsewhere herein, the user may access the camera 29 to add one or more image files to the temporary and/or local database, e.g., during or after treatment of a patient.

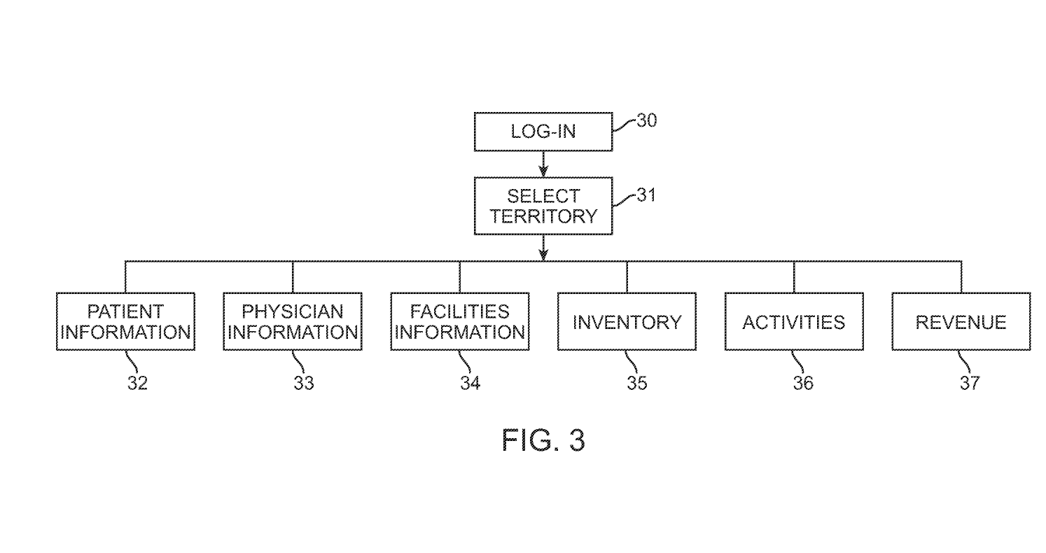

Turning to FIG. 3, an exemplary configuration is shown of the general functionality and/or modules of the application available using an electronic device, such as the electronic device 18 of FIG. 2 (also referenced below), e.g., to review and/or modify information related to medical services and/or devices according to the systems and methods herein. As shown in FIG. 3 and described further below, in an exemplary embodiment, the modules may include Patient Information 32, Physician Information 33, Facilities Information 34, Inventory 35, Activities 36, and Sales Activities 37.

Generally, the electronic device 18 may include one or more software or other modules downloaded and/or otherwise stored in the memory 24 and/or 25 of the electronic device 18. For example, the application may be initially downloaded via the network 10, e.g., from the administrator server 12, a general application server, or other available server. When the application is downloaded or otherwise stored in memory 24 and/or 25, in addition to any modules saved, the application may create a long-term or local database, e.g., stored indefinitely in memory 25, and, optionally, a short-term or temporary database, e.g., stored in memory 24 and/or 25.

For example, the local database may include at least a portion of the medical database 14 maintained by the administrator server 12, e.g., including information regarding patients, physicians, health care facilities, inventory, and the like within a geographic region or other desired segment of the medical database 14, as described further below. The temporary database may be used to store information, e.g., when a user of the electronic device 18 modifies information from the local database before it is communicated to the administrator server 12 (e.g., before the data is synchronized with the medical database 14). The temporary database may also be used when the user requests and receives additional information, e.g., from information requests, e.g., requesting that one or more reports be generated by the administrator server 12, and/or from search requests, e.g., searching for medical device inventory, as described further below.

The electronic device 18 may periodically and/or intermittently synchronize information from the temporary database with the medical database 14 via the administrator server 12, whereupon the modified information may be stored in the local database, e.g., to update the local database and then clear the temporary database. In addition or alternatively, a user of the electronic device 18 may manually request synchronization, as described elsewhere herein.

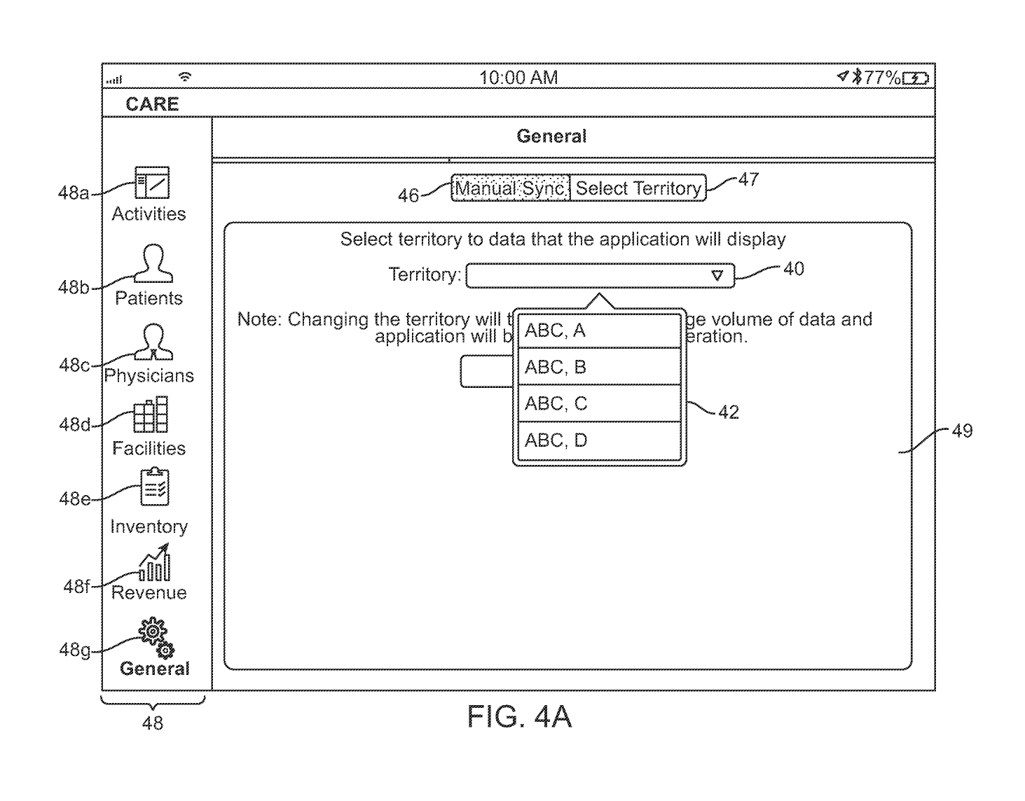

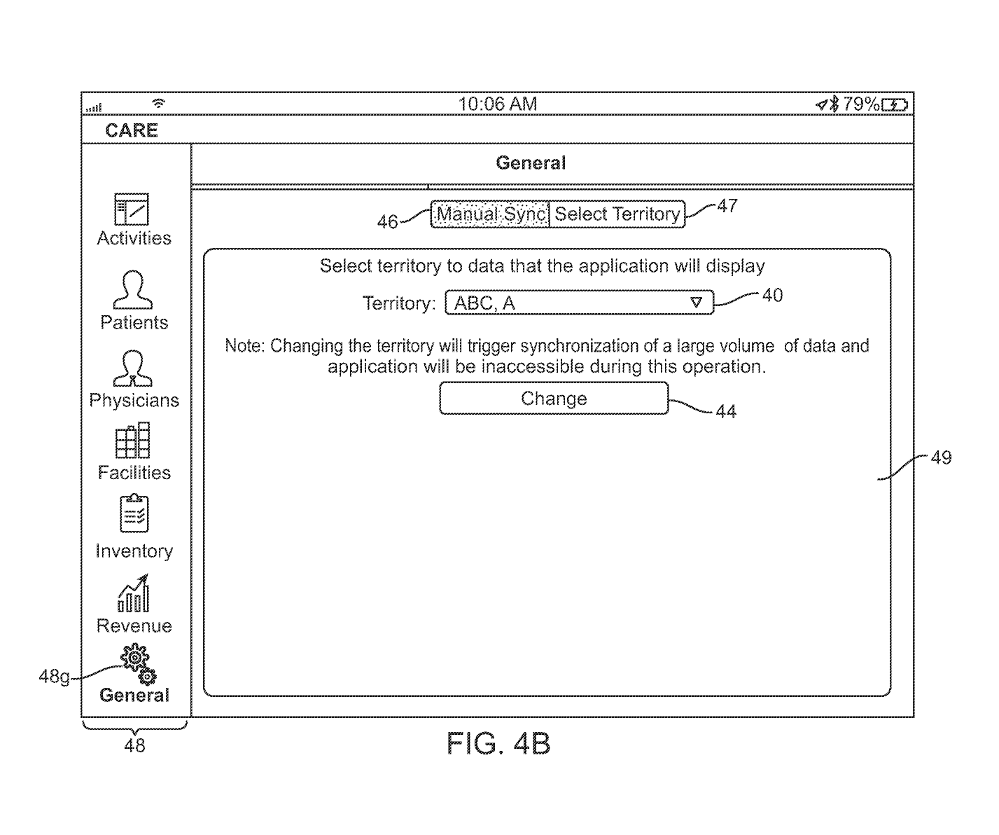

Turning to FIGS. 4A and 4B, a General page or screen is shown that may be presented on the display 28a when the application is initially launched. Initially, as shown at “Log-in” 30 in FIG. 3, a user may first be prompted to enter a Username and Password into respective active fields (not shown) presented on the display 28a, e.g., using an input device 28b (generally described herein as being a touchscreen, although it will be appreciated that other input devices may be used in addition to or instead of a touchscreen). Upon entry of the Username and Password, the processor 22 may confirm that the user is authorized to use the application, and then present the General screen shown in FIGS. 4A and 4B.

When the application is launched for the first time, at step 31 in FIG. 3, the user may be required to select a territory, which may limit the information included in the local database stored in memory 25 of the electronic device 18 and/or otherwise available using the application. Once a territory is selected, the local database may be created and synchronized with at least a portion of the medical database 14, e.g., via the administrator server 12. After a territory has been selected, subsequent sessions may default to the first selected territory when the user logs in, e.g., until the user decides to change the territory. Alternatively, the application may require the user to select a territory each time the application is subsequently launched.

In FIG. 4A, the “Territory” field 40 has been selected, whereupon a drop-down menu 42 may be presented of territories available to the user (i.e., available to the user whose Username and Password have been entered and accepted). The user may scroll through the menu 42 until a desired territory is included in the visible portion of the menu 42, and then the user may select the desired territory, e.g., by touching the touchscreen over the desired territory. The menu 42 may close leaving the desired territory in the “Territory” field 40, as shown in FIG. 4B. The user may then select the “Change” icon or button 44 to confirm that the desired territory is to replace any previous territory. At any time, the user may return to the General page of FIGS. 4A and 4B and select the Select Territory icon or button 47, e.g., the user may want to change to another authorized territory, whereupon the procedure described above may be repeated.

When an individual or new “territory” is selected, the electronic device 18 may synchronize the local database in memory 25 to include data only for the selected territory, e.g., deleting any information for another previously selected territory. If the territory is not changed when the application is launched from a previous session, the electronic device 18 may retain the previous local database, but may synchronize, e.g., to update the local database with any changes since the most-recent synchronization, before allowing further action.

As shown in FIG. 4A, the “territories” in the menu 42 are a list of names (generic or gibberish names have been provided in name fields throughout the drawings, such as ABC, A., ABC, B. etc., shown in FIG. 4A), which may represent territory managers who oversee or are otherwise responsible for one or more respective geographic regions. Alternatively, the territories menu may include a list of geographic regions themselves or other limiters, which may be selected by authorized users to create a local database and review and/or modify information for those territories, as described further below. For example, some sales representatives or other personnel may work with multiple territory managers and/or within multiple geographic regions.

In a further alternative, some users may not have the authority to change territories, e.g., territory managers assigned to a set geographic region, in which case the local database may be based on the same geographic region or other factors for that particular user each time that user launches the application. In this alternative embodiment, for such dedicated territory users, step 31 (in FIG. 3) may be skipped and/or the Select Territory button 47 may be omitted from the General page of FIGS. 4A and 4B.

During use of the application, the electronic device 18 may periodically and/or intermittently synchronize changes with the medical database 14. For example, any changes entered by the user may be communicated to the administrator server 12 (upon manual or scheduled synchronization) using the communication interface 26, and/or any changes in the medical database 14 may be communicated to the local database (again upon manual or scheduled synchronization) via the communication interface 26. The frequency of synchronization may be set or may be selected by the user, e.g., using a menu (not shown) on the General page or other location within the application. If the electronic device 18 is not currently connected to the network 10, e.g., does not have access to the Internet or a telecommunications network, any scheduled synchronization may be initiated automatically once a network connection is available. Optionally, as shown in FIG. 4B, at any time, the user may select the “Manual Sync” icon or button 46 to force such synchronization with the medical database 14, e.g., as often as desired.

As shown in FIGS. 4A-4B, pages shown on the display 28a of the electronic device 18 during use of the application generally include a main menu 48 and an information field 49. As shown, the main menu 48 is arranged vertically adjacent the information field 49, although it will be appreciated that the main menu 48 may be arranged horizontally across the top or bottom of the information field 49 (not shown) or otherwise instead of on either side of the information field 49, as desired. In addition or alternatively, the main menu 48 may be omitted on some pages and/or may “fade out,” e.g., disappear or slide off the page after a predetermined period of inactivity, and return when the user selects a predetermined region of the page, which may maximize the area available for the information field 49.

As shown, the main menu 48 may include a set of icons or buttons showing the available module options that may be selected by the user, such as Activities 48a, Patients 48b, Physicians 48c, Facilities 48d, Inventory 48e, and optionally, Sales Activities 48f, e.g., corresponding to the modules shown in FIG. 3. Each of these options and the associated functionality are described further elsewhere herein. Optionally, as shown, the main menu 48 may also include a General icon or button 48g, allowing the user to return to the page shown in FIGS. 4A and 4B at any time, e.g., to complete a manual synchronization, change territory, and/or change other settings for the application.

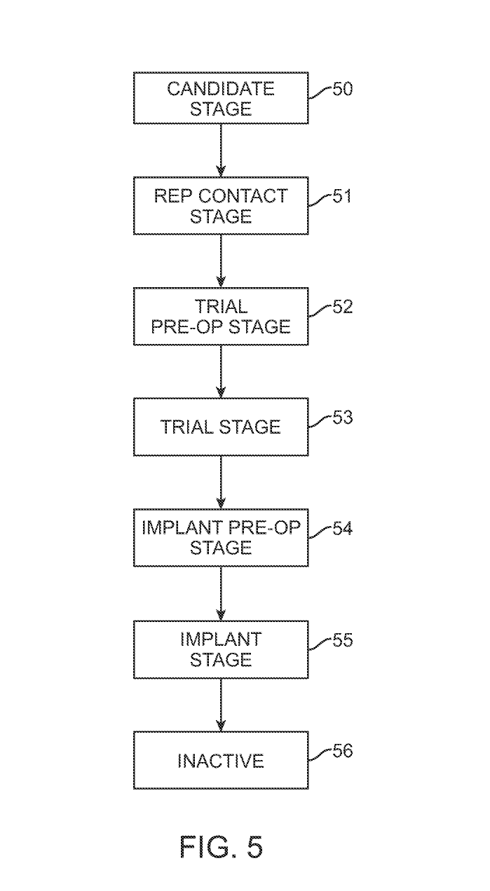

When the Patient Information module 32 (shown in FIG. 3) is selected from the main menu 48, e.g., by selecting the Patients icon 48b, the application may be used to identify, monitor, and/or manage patients, e.g., from candidates for treatment through one or more stages of treatment. Turning to FIG. 5, an exemplary flowchart is shown of the status with which patients and their information may be organized using the Patient Information module 32, e.g., within the context of pain treatment, such as spinal cord stimulation (“SCS”) treatment. Alternatively, patient information may be organized for other medical treatments, such as deep brain stimulation (e.g., Parkinson's, dystonia, essential tremor, migraine, and the like), treatment for overactive bladder, and/or other types of medical treatments where management of a trial and permanent implant may be involved. In addition or alternatively, the patient information may be organized for procedures involving medical implants (which may or may not include trial and permanently implanted systems), such as a pacemaker, a defibrillator, a cochlear stimulator, a retinal stimulator, a stimulator configured to produce coordinated limb movement, a cortical stimulator, a deep brain stimulator, peripheral nerve stimulator, micro-stimulator, and/or other neural stimulator configured to treat urinary incontinence, sleep apnea, shoulder sublaxation, headache, and the like. In a further alternative, the systems and methods herein may be used for treating and/or tracking non-surgical and/or non-stimulation indications and/or procedures, such as the treatment of asthmatics.

As shown, patient information may be categorized based on six stages, namely Candidate Stage 50, Rep Contact Stage 51, Trial Pre-Op Stage 52, Trial Stage 53, Implant Prep Stage 54, and Implant Stage 55. Optionally, one or more additional stages may be added, as desired. For example, a seventh stage may be added called Post-Implant Follow-Up (not shown), as described elsewhere herein. The six (or other predefined number of) stages may easily indicate the current status of each patient as they consider and undergo treatment, as described further elsewhere herein.

Finally, a patient may be categorized as Inactive 56, e.g., after a predetermined time has lapsed after the patient has completed treatment or declined to proceed with proposed treatment. Once inactive, the patient's information may be archived, e.g., stored only in the medical database 14 and removed from the local database on individual electronic devices 18, e.g., also as described further elsewhere herein.

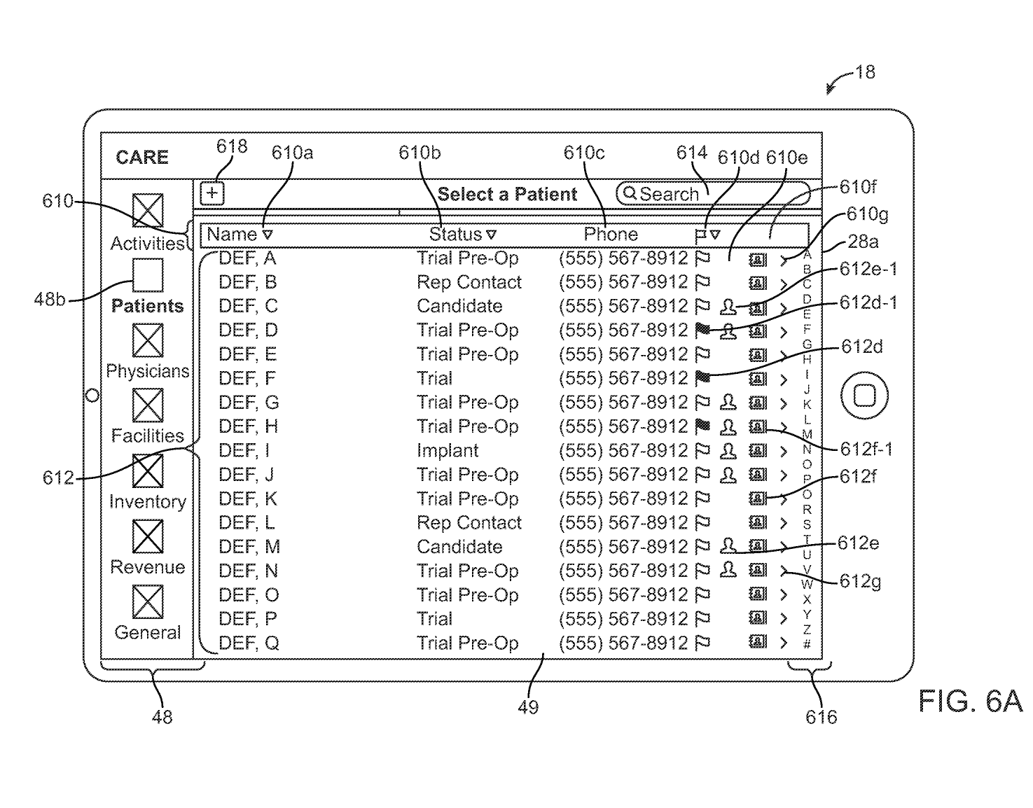

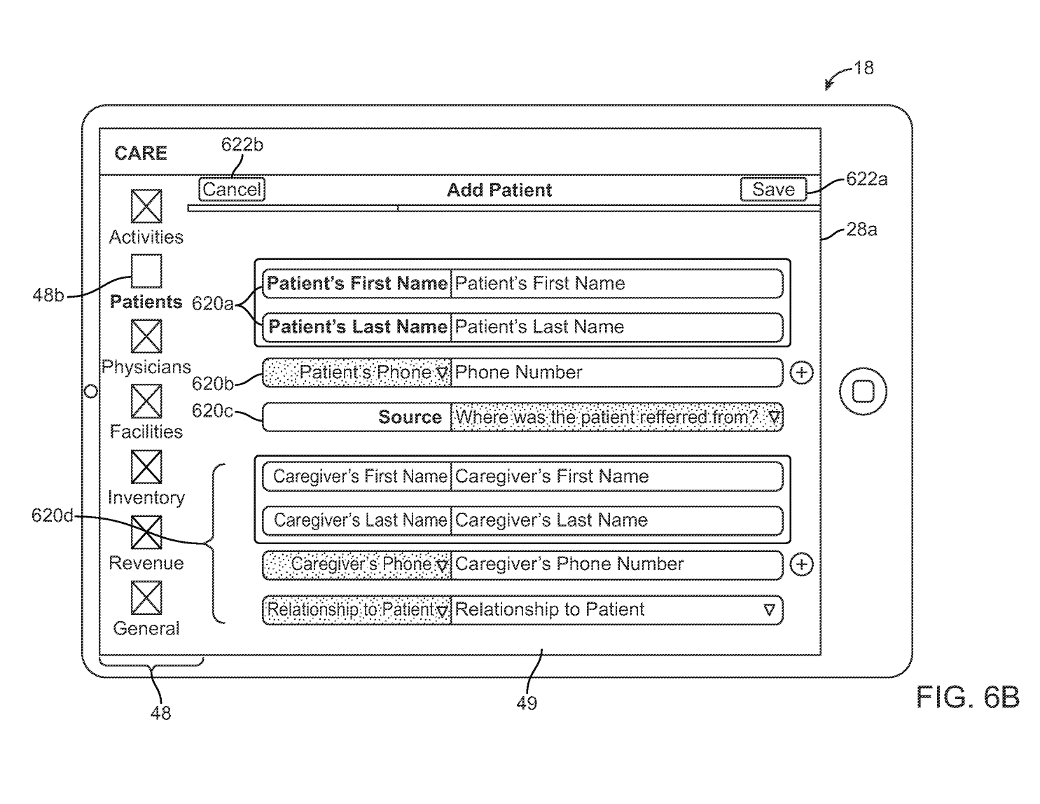

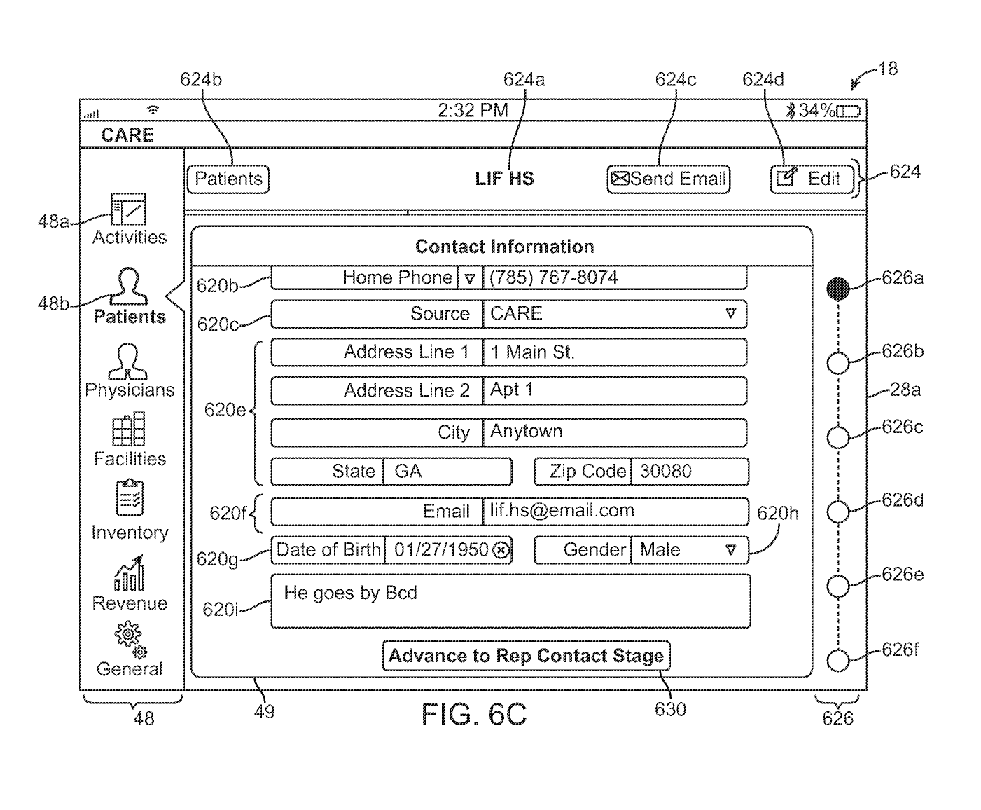

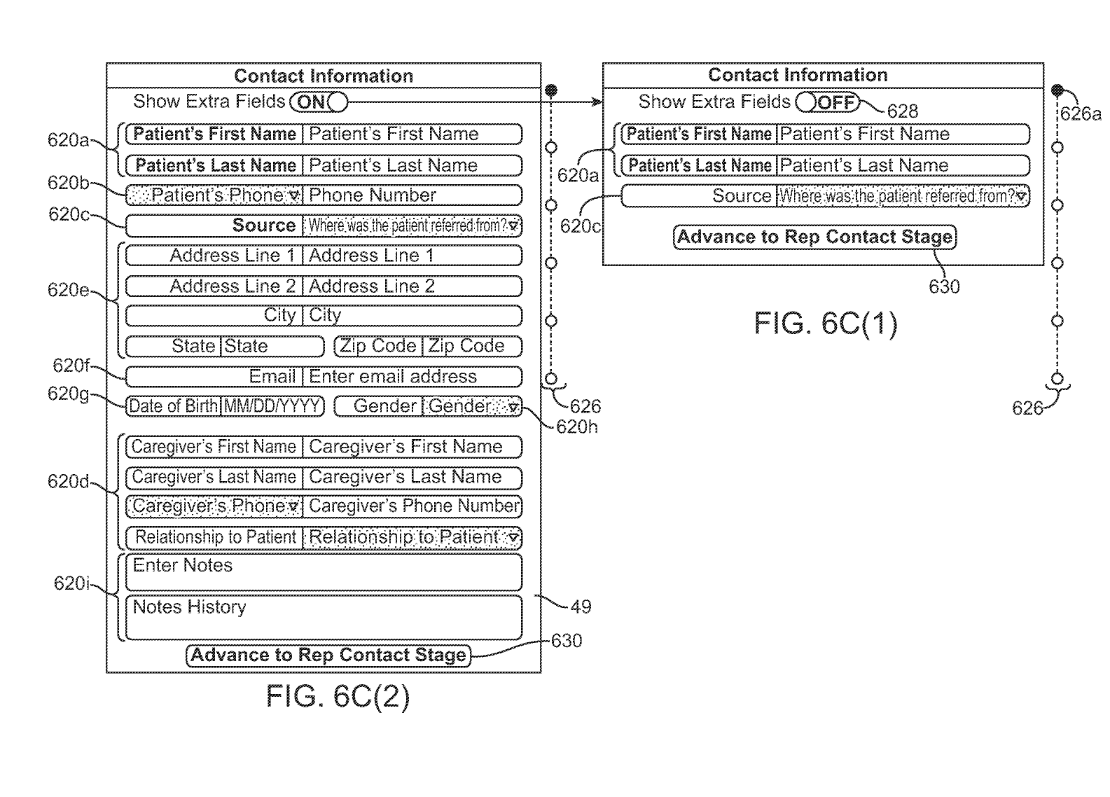

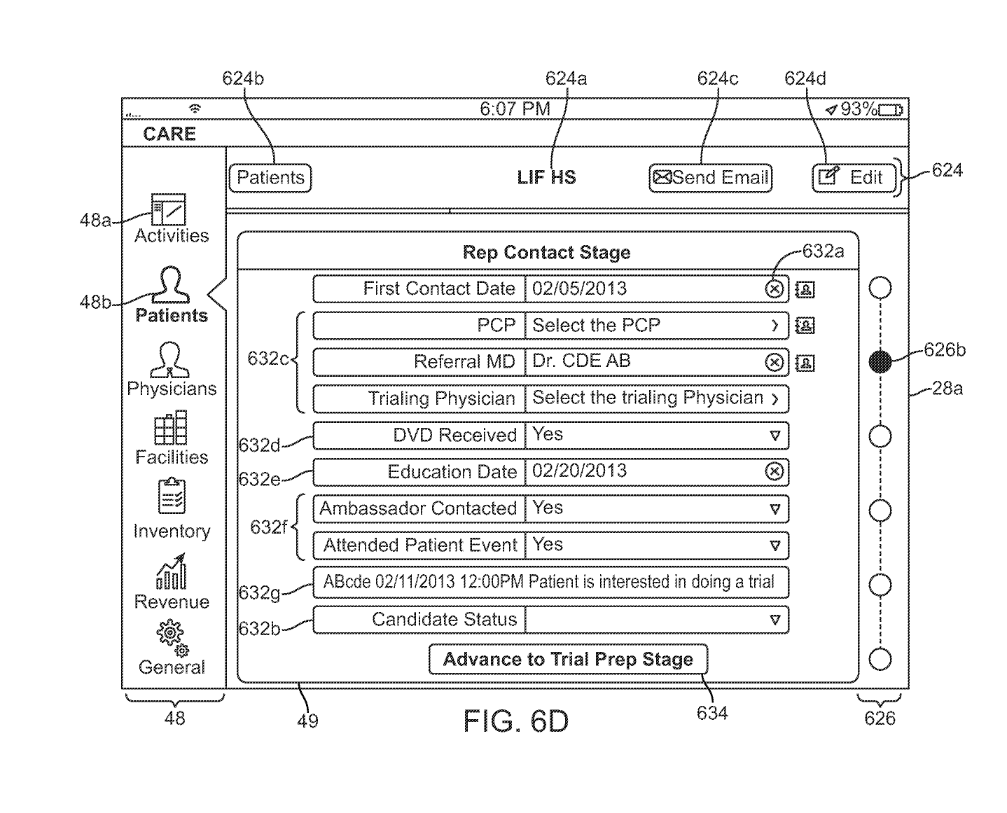

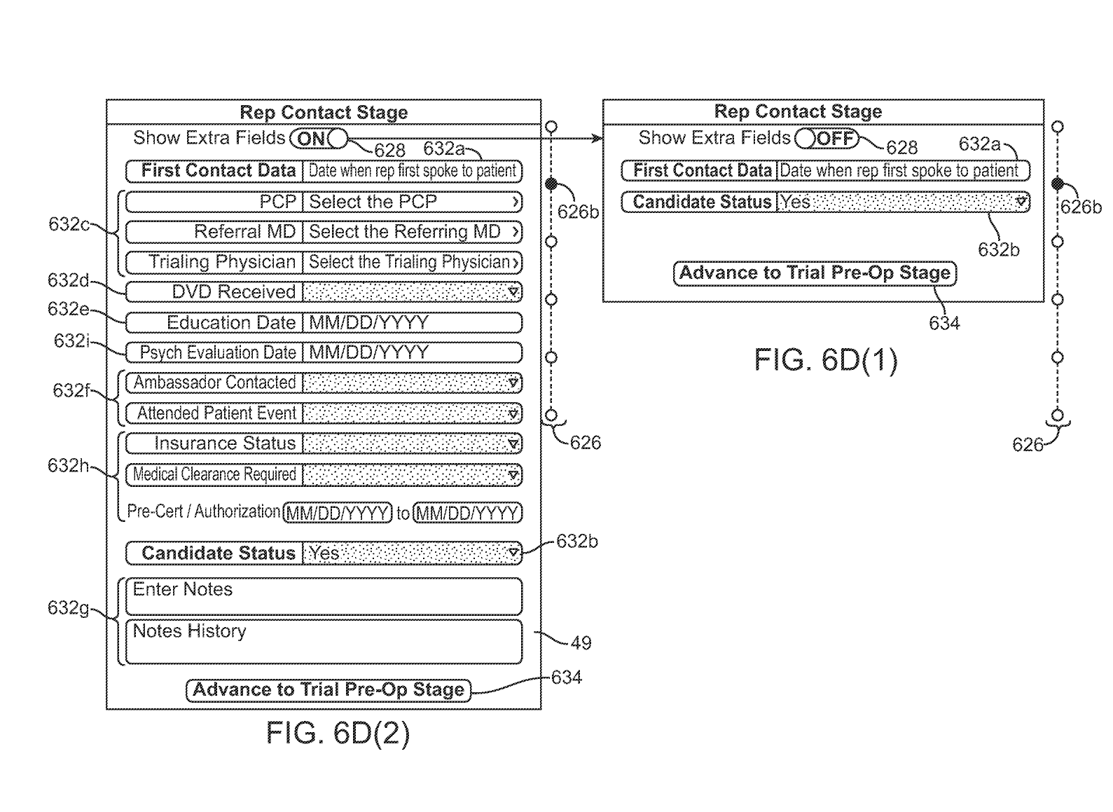

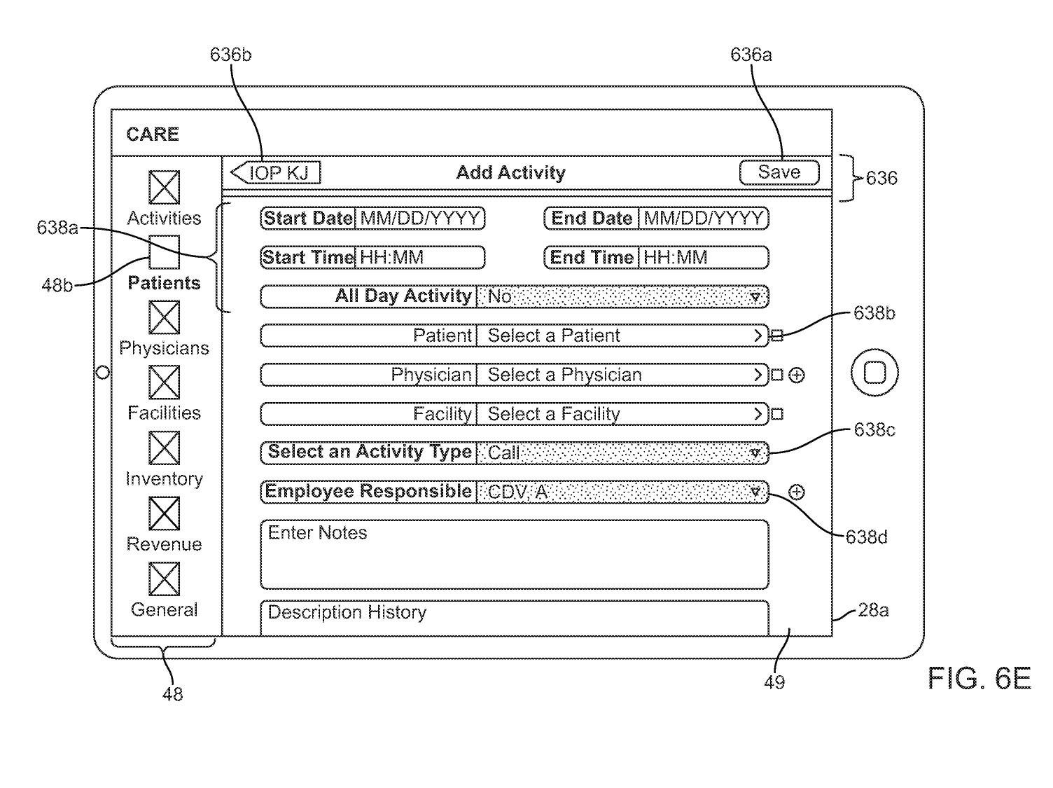

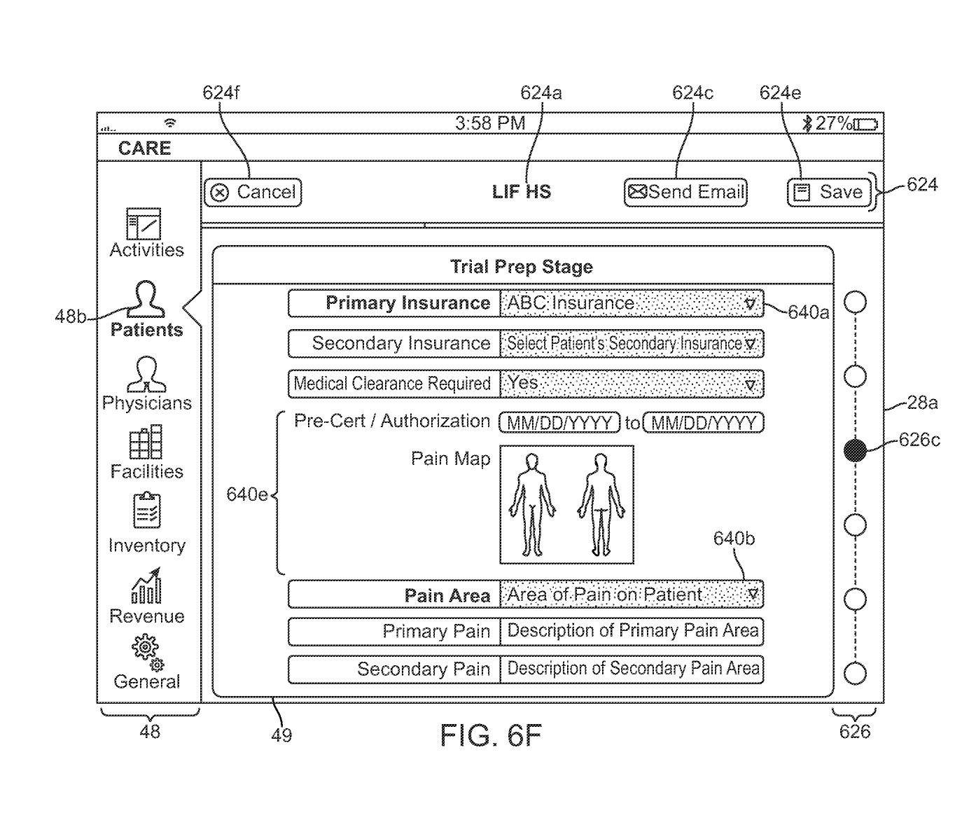

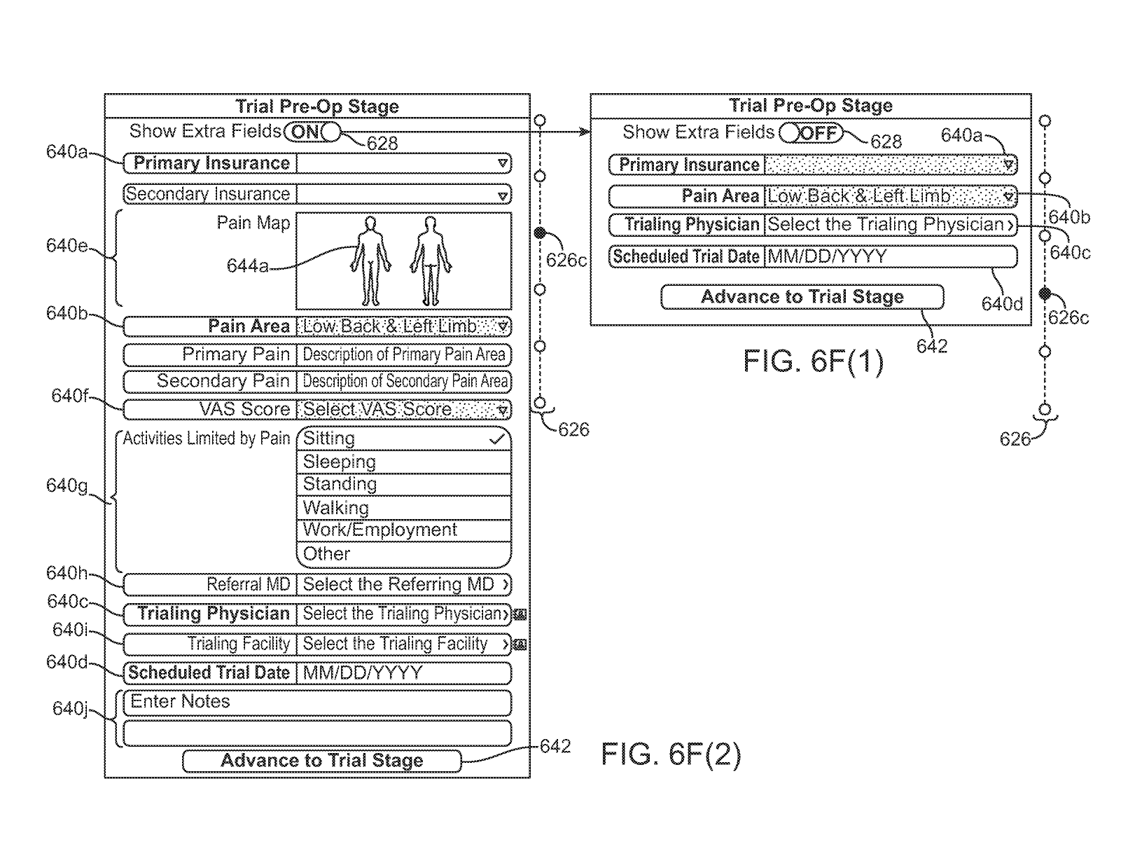

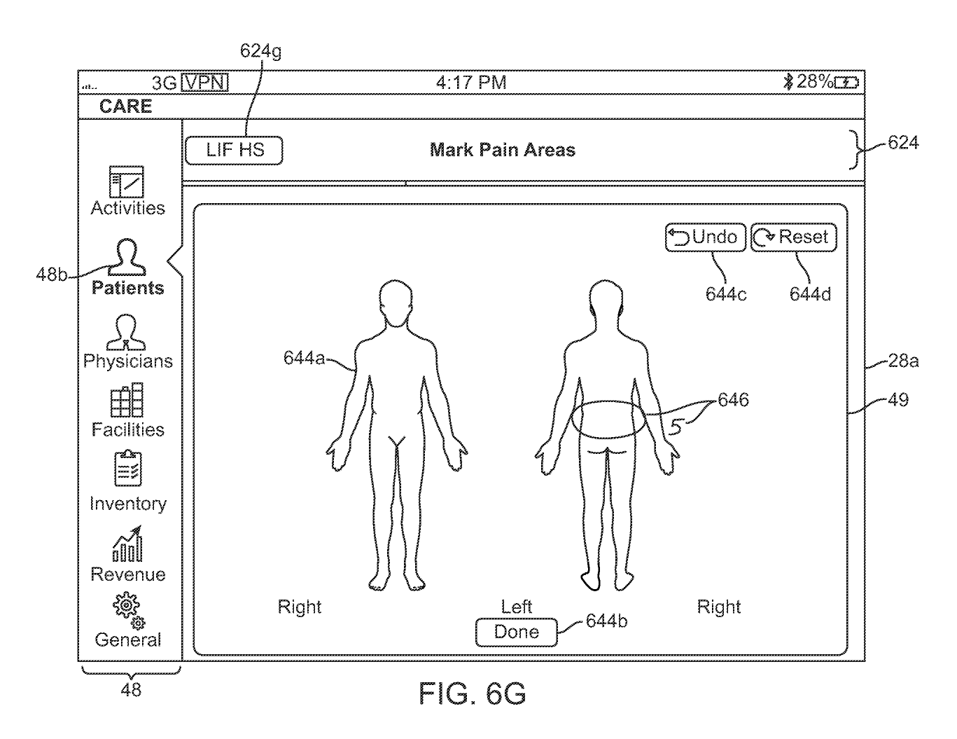

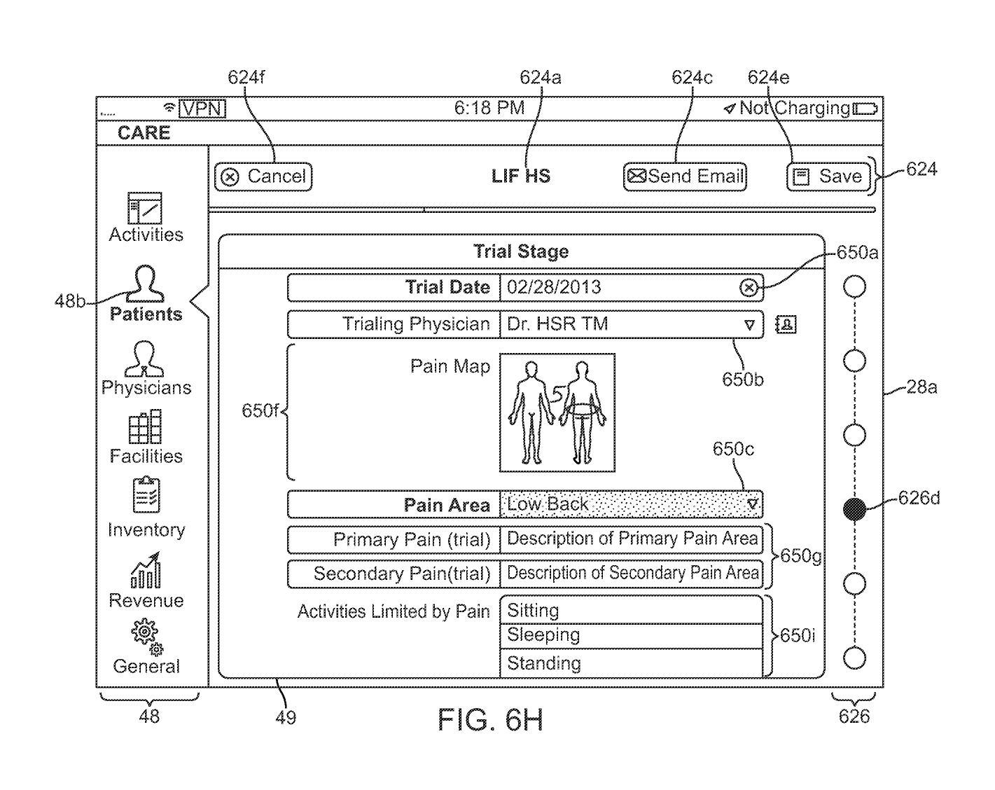

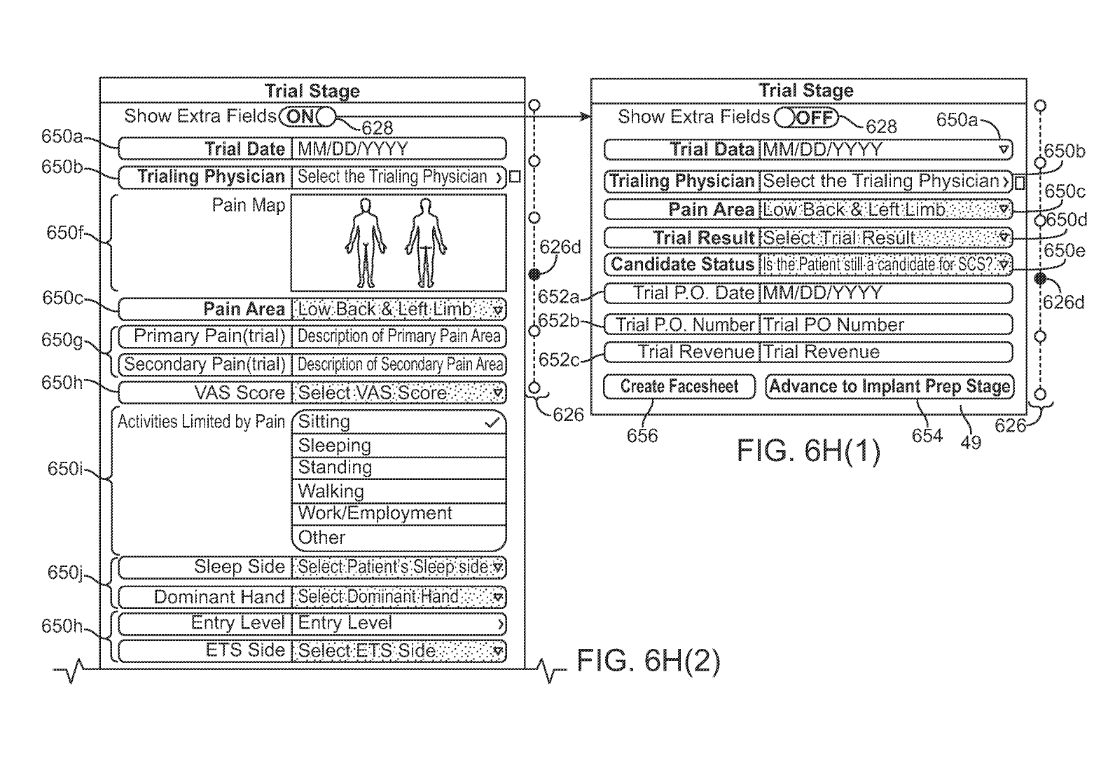

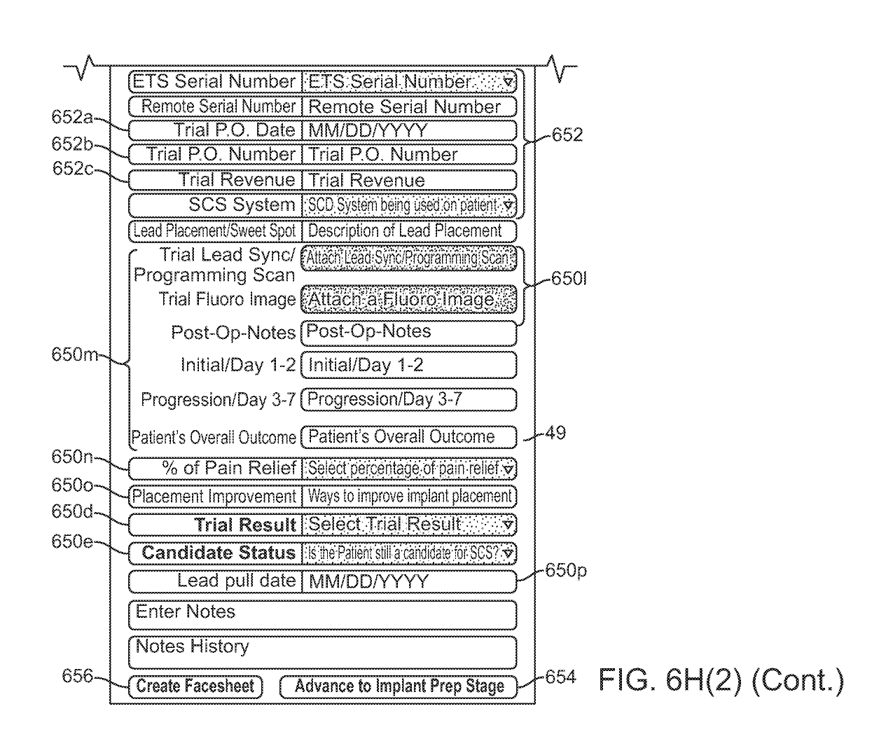

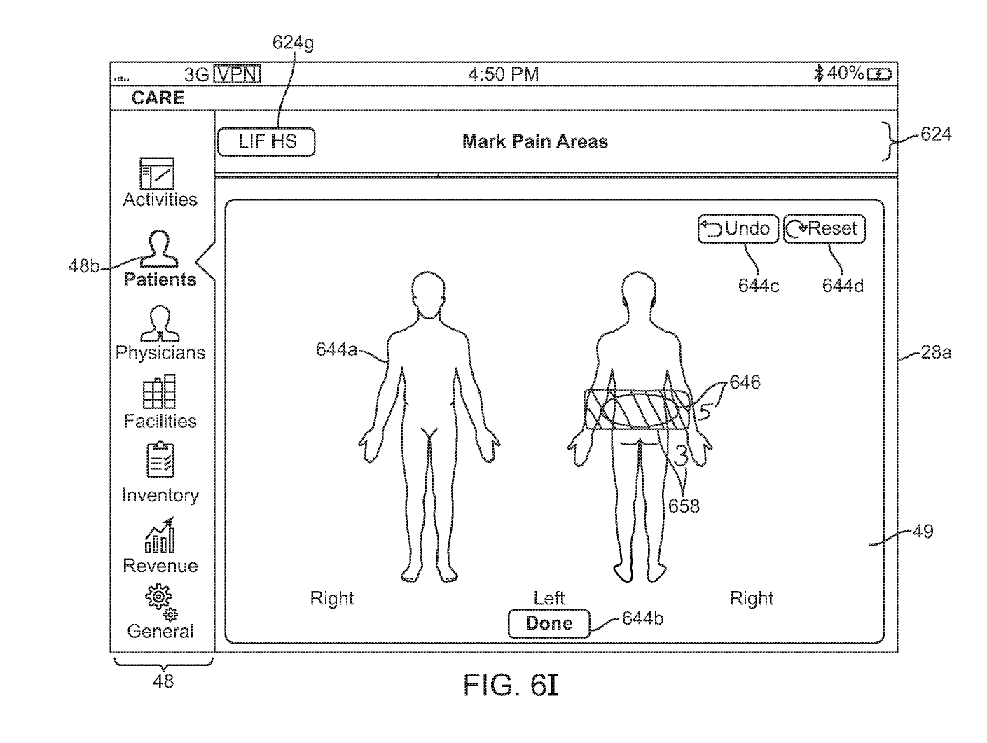

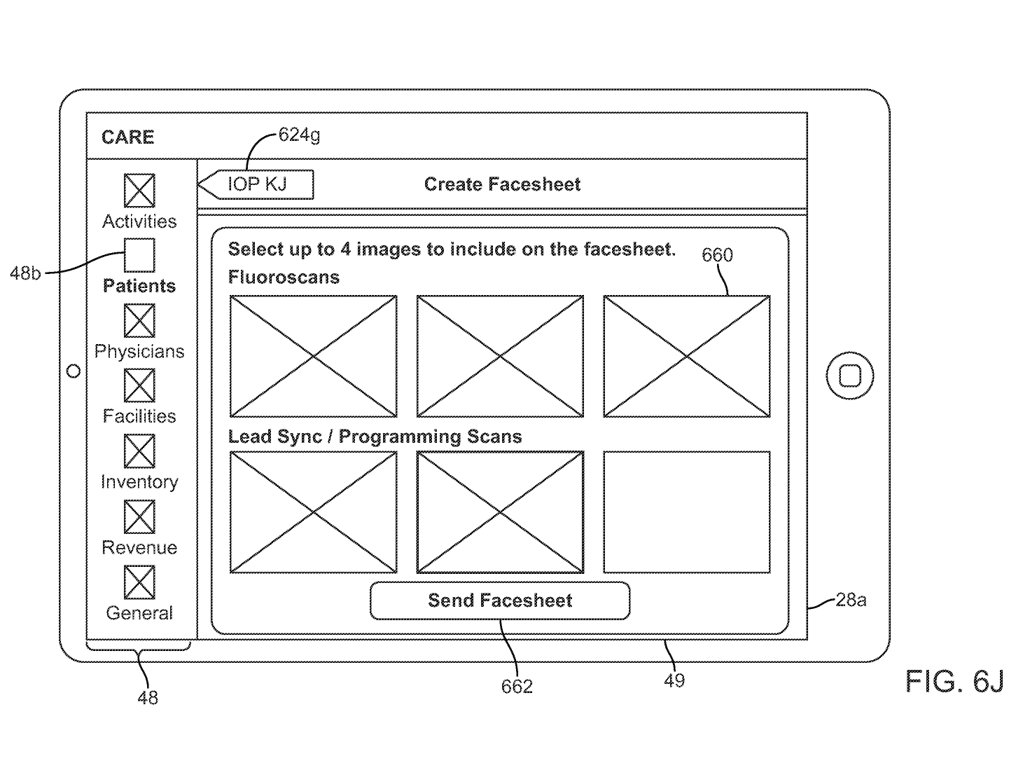

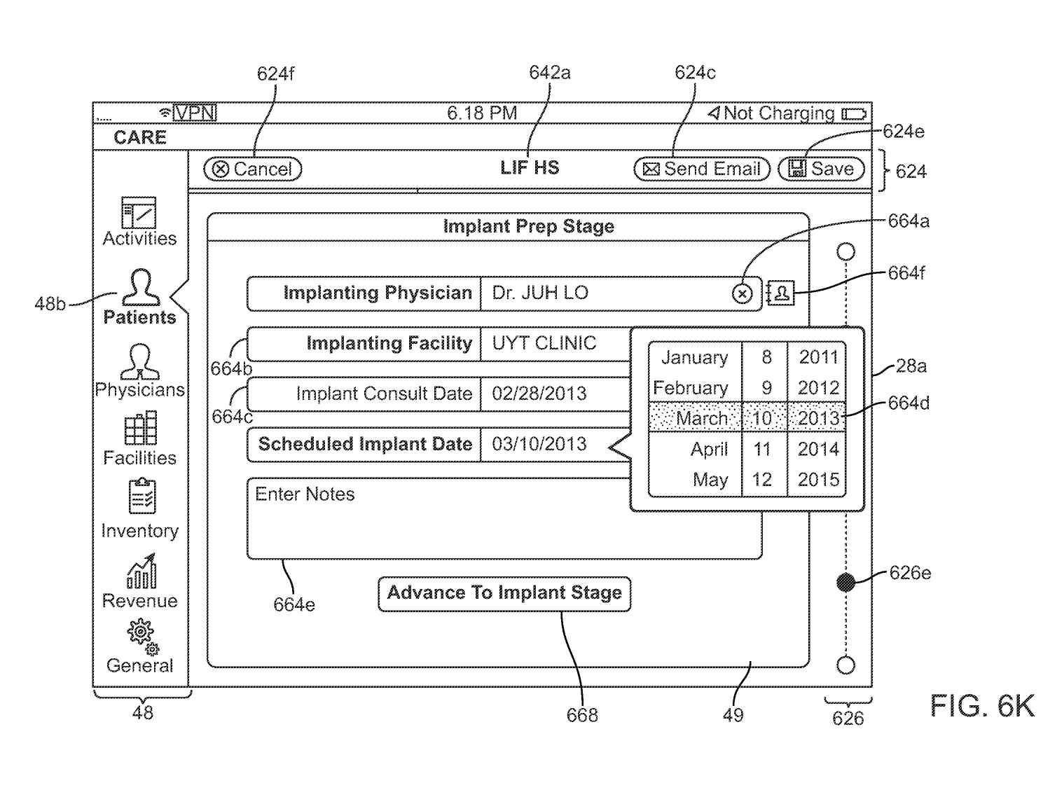

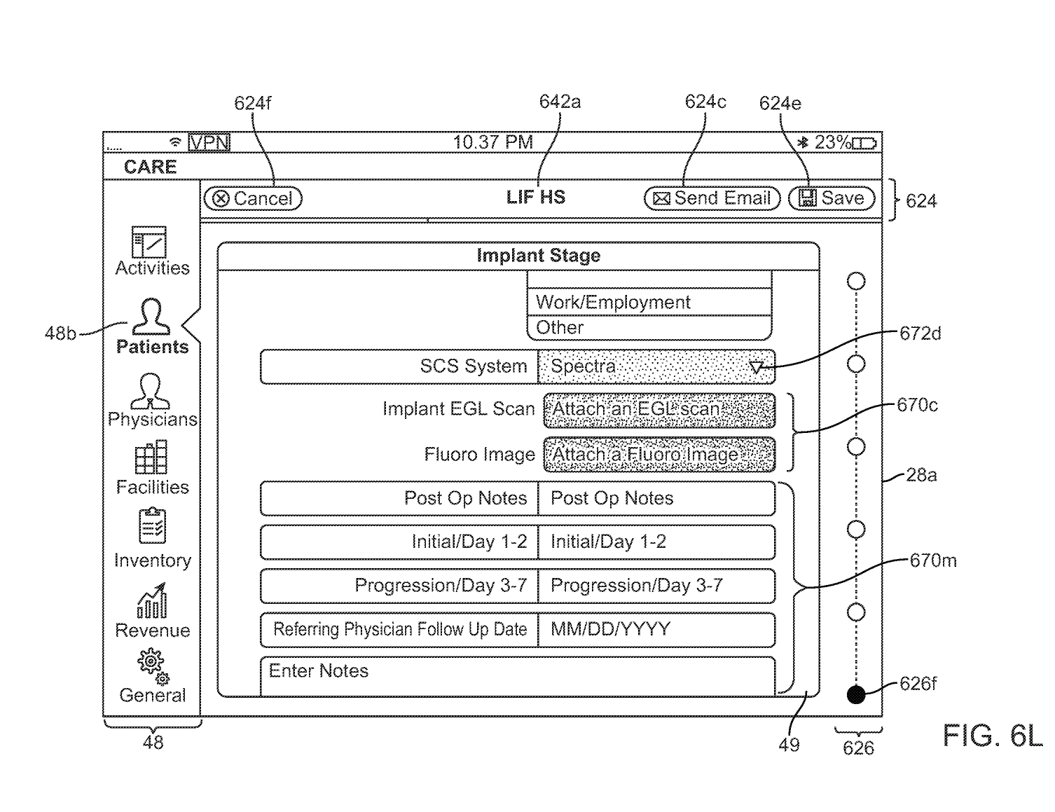

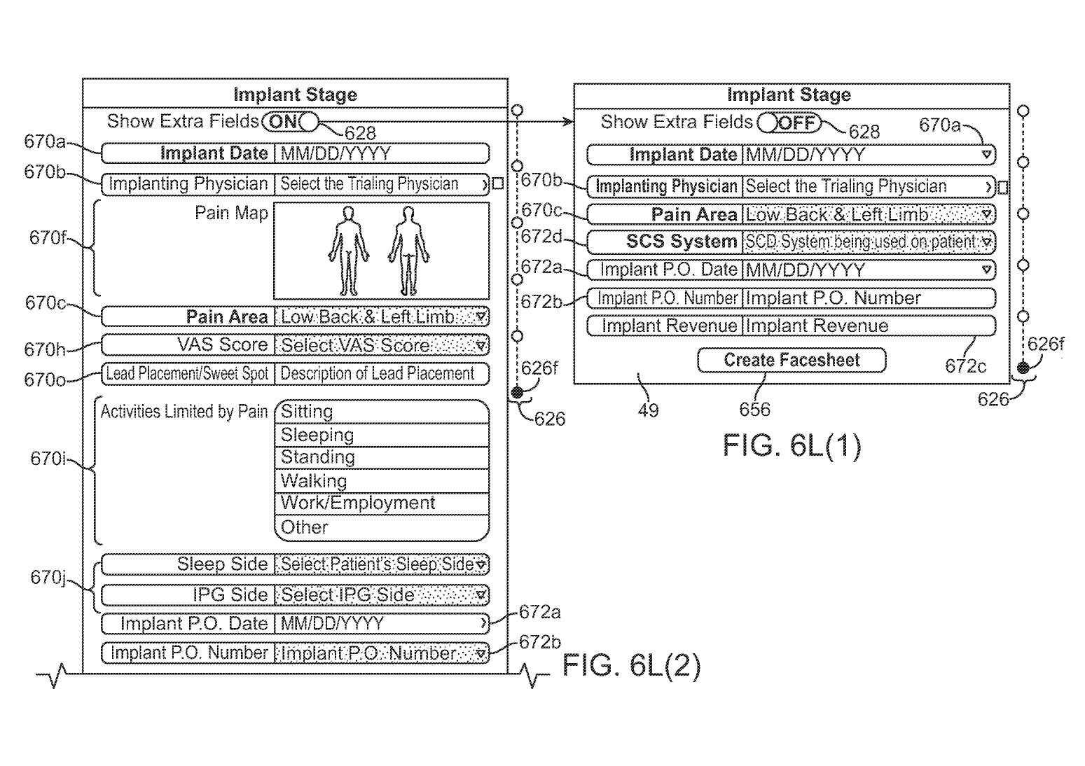

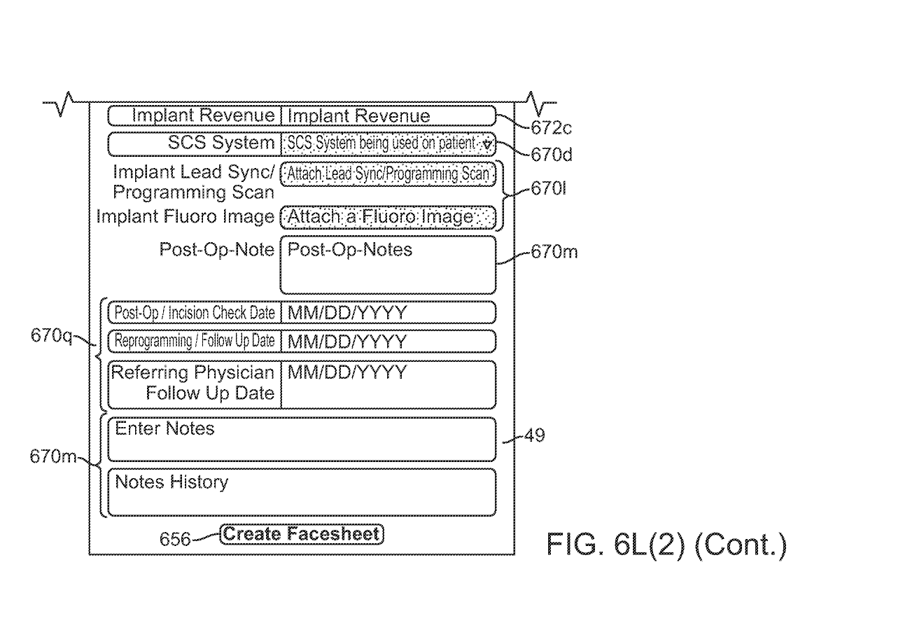

Turning to FIG. 6A, an exemplary Patient List page or screen is shown that may be presented on the display 28a when the Patients icon 48b is first selected from the main menu 48. As shown, when the Patients icon 48b is selected, the Patients icon 48b may be highlighted while the other icons of the main menu 48 may be dimmed or otherwise distinguished, e.g., to facilitate the user identifying the module that is currently active.

Generally, the information field 49 of the Patients List page may include a Title Row including a plurality of headings 610 over respective columns, and then rows 612 of patient information for individual patients (e.g., for those patients active within the selected territory). In the exemplary embodiment shown, the headings 610 include Name 610a, Status 610b, Phone 610c, and Flag 610d. The rows 612 beneath these headings 610 may be populated with corresponding information, e.g., the full patient names, status (e.g., based on the stages shown in FIG. 5), and phone number (or alternatively other preferred contact information) of patients included in the local database of the electronic device 18.

As shown, one or more of the patient rows may be highlighted by a flag under the Flag heading 610d, such as 612d-1 shown in FIG. 6A, e.g., to draw attention to a particular name in the Patient List. For example, a flag may be added or highlighted to indicate a recently added patient, a patient due for a follow-up or with an imminent deadline, and the like. The flags may be added by the user, if authorized, simply by touching the flag area in a particular patient row, e.g., 612d-1, associated with the desired patient, which may toggle the flag on or off. In addition or alternatively, a third party, e.g., an administrator, team member, territory manager, or other authorized person accessing the administrator server 12 (e.g., directly or via another electronic device 18), may add a flag to a name, e.g., to highlight a patient recently added to the medical database 14, due for follow-up, having an imminent deadline, and the like. When the local database is synchronized with the medical database 14, any such added (or removed) flags may be presented (or omitted) the next time the user selects the Patient List page.

In addition, as shown in FIG. 6A, the Patient List may include additional columns that provide further information, such as a column 610e of physician contact icons 612e, a column 610f of patient information icons 612f, and a column of “>” (“carrot” or “more information”) icons 612g. The physician contact icon, e.g., icon 612e-1, may indicate that a physician is treating the associated patient, e.g., during the current stage of the patient indicated in the Status column. The user may touch (or otherwise select) the physician contact icon 612e-1, whereupon a supplemental window (not shown) may be superimposed over the Patient List or otherwise presented on the display 28a that includes contact information for the physician. Alternatively, when the physician contact icon 612e-1 is selected, the application may replace the Patient List with a Physician Information page, such as those available using the Physician Information module 33 and/or selecting the Physician icon 48c from the main menu 48, as described elsewhere herein.

Similarly, the user may select the patient information icon, 612f-1, whereupon a supplemental window (not shown) may be superimposed over the Patient List or otherwise presented on the display 28a that includes additional contact information for the associated patient, e.g., a preferred communication mode, such as mailing address, phone number or texts or voice calls, e-mail address, caregiver, and the like. Alternatively, when a patient information icon is selected, the application may replace the Patient List with a Patient Information page (not shown), such as that shown in FIG. 6C and described elsewhere herein. The “>” icons 612g may indicate that additional information regarding the associated patients may be available. This information may be accessed, e.g., by selecting the “>” icon associated with a particular patient or by touching (or otherwise selecting) the patient's name or other field in their particular row (other than on the other specific purpose active icons in that row). When such additional information is selected, the application may replace the Patient List with a Patient Information page (not shown), such as that shown in FIG. 6C or other current page associated with the patient's current status.

If the number of patient rows exceeds the available space in the information field 49, the user may scroll through the Patient List, e.g., sliding a finger up or down on the touchscreen or otherwise using known interface procedures (similar to other tables displayed using the application). The heading row 610 may remain substantially stationary while the patient rows move across the information field 49 and scroll off the top or bottom of the information field, depending upon the number of patient rows and the extent of scrolling directed by the user.

Returning to FIG. 6A, the information in the Patient List may be organized, filtered, and/or searched in a number of ways. For example, as shown, a Search field 614 may be provided, e.g., along a border of the information field 49, into which a user may type search terms to limit the number of patients included in the patient rows 612. In an exemplary embodiment, when the Search field 614 is selected, a keyboard or other interface (not shown) may be presented on the touchscreen, allowing the user to enter search terms, such as a patient's last name, a particular status (e.g., candidate), and the like. The processor 22 of the electronic device 18 may then filter the patients to include only those that satisfy the search term(s) entered.

In addition, the Patient List may include an alphabetical menu 616, and the user may input one of the letters, e.g., by touching or otherwise selecting a desired letter, to include only patients whose last name starts with the selected letter. When a letter is selected, that letter may be highlighted and/or otherwise distinguished from the other letters, e.g., to facilitate identifying which letter has been selected. With these functions, the remaining patient rows may be removed, e.g., until the search term(s) are removed from the Search field 614 or by selecting the highlighted letter from the alphabetical menu 616 (whereupon the highlighted letter may be unselected and returned to similar status as the other letters). Alternatively, when a letter is selected from the alphabetical menu 616, the application may keep all of the names but may automatically scroll to the location on the list where the last names begin with the selected letter, e.g., to facilitate scrolling through a long list of patients.

In addition, the patient rows may be sorted based on one or more of the columns 610, e.g., by Name 610a, Status 610b, and/or Flag status 610d. For example, the “V” icon adjacent the Name heading 610a may be selected to sort the patient rows alphabetically by last name, e.g., toggling between ascending and descending alphabetical order each time the “V” icon is selected (e.g., toggling the “V” icon with a “̂” icon, not shown). Similarly, the “V” icon adjacent the Status heading 610b may be selected to sort the patient rows by the stage of treatment of each associated patient (e.g., with the patients in each stage sorted together and then listed alphabetically based on the Name heading 610a). For example, the patient rows may be selected to list the patients according to the status order shown in FIG. 5 (again with the patient rows being toggled between ascending and descending order).

Finally, the “V” icon adjacent the Flag icon 610d may be selected to move all patient rows including a highlighted Flag to the top of the rows, e.g., again with the patient rows further sorted by the name heading 610a and/or Status heading 610b, as desired. For example, the user may select this heading to bring all newly added or newly status-changed patients to the top of the Patient List, which may facilitate reviewing the associated patients without having to scroll through the entire list.

Optionally, the user may have the ability and/or authority to add patients to the patient list. For example, as shown in FIG. 6A, a “+” icon or button 618 may be included, e.g., along the border of the information field 49, which may be selected by the user to add a patient. In an exemplary embodiment, the user may be provided an information card or other inquiry that was filled out by a new patient or their caregiver, e.g., at a physician's office, online, at a conference, seminar, or other meeting, etc., indicating that the patient is interested in considering treatment. The user may add the patient including any information provided with the inquiry.

Turning to FIG. 6B, an exemplary Add Patient page or screen is shown that may be presented when the “+” button 618 is selected from FIG. 6A. As shown, the Add Patient page generally includes the main menu 48 and information field 49, similar to other pages. Instead of the Patient List, however, a number of patient information fields 620 are presented in the information field 49 to allow the user to enter information regarding the new patient being added. In the exemplary embodiment shown, the fields may include Patient Name fields 620a (e.g., for last name, first name, and optionally middle name(s) or initial(s)), Phone Number 620b (optionally with additional fields available for additional contact information), and Source 620c. The Source field 620c may be used to identify referral sources for patients who have been added to the medical database 14, e.g., doctor referral, online inquiry, information card, and the like, as described elsewhere herein. Optionally, the fields may also include Caregiver fields 620d, e.g., to enter information regarding a caregiver for the patient and/or other information fields (not shown), as described elsewhere herein.

When the necessary fields are completed, the user may select the Save icon or button 622a, whereupon the new patient may be added to the temporary database and/or to the local database. When the electronic device 18 is synchronized with the medical database 14 via the administrator server 12, the information for the new patient may also be added to the medical database 14 (and synchronized with other devices having a local database including data for the same territory including the patient). Alternatively, if the user decides not to enter the patient, the user may select the Cancel icon or button 622b, whereupon the fields may be cleared. Once either the Save button 622a or the Cancel button 622b is selected (optionally, with an additional confirmation window or field being presented, which must be accepted or declined by the user), the Add Patient page may be replaced with a Contact Information page, such as that shown in FIG. 6C and described further below.

In addition, the newly added patient may automatically be assigned a status, e.g., Candidate Stage 50, as identified in FIG. 5. Thereafter, if a Patient List is presented on the display 28a (or on another electronic device 18 once the data is synchronized), the newly added patient will be included in the Patient List with their status defaulted to Candidate.

Returning to FIG. 6A, when a patient is successfully added or an individual patient in Candidate stage is selected from the Patient List (e.g., by selecting the “>” icon 612g or other active field of that patient's row shown in FIG. 6A), a Contact Information page or screen may be presented on the display 28a, such as that shown in FIG. 6C. Once again, the Contact Information page may include the main menu 48 and an information field 49, which may include relevant information for the selected patient. The Contact Information page may also include a header 624, e.g., including the patient's name 624a (e.g., generic name LIF HS shown) and, optionally, one or more menu icons or buttons allowing the user to perform various actions.

For example, the header 624 may include a Patients icon or button 624b, which may be selected to return to the Patient List page of FIG. 6A (or other previous page that was presented immediately before the Contact Information page of FIG. 6C). The header 624 may also include a Send Email icon or button 624c, e.g., which may allow the user to communicate with the patient. For example, when the Send Email button 624c is selected, an e-mail window or field (not shown) may be superimposed over the information field 49, allowing the user to enter a desired message to the patient. Once saved, the message may be transmitted to the patient, e.g., when the electronic device 18 is synchronized with the medical database 14 via the administrator server 12. The server 12 may identify that a message is included in the data being synchronized, and arrange to transmit the message to the intended patient. Alternatively, the e-mail may be transmitted directly by e-mail software resident on the electronic device 18, e.g., without requiring communication with the administrator server 12.

Alternatively, the Send Email button 624c may be replaced with a Communication icon or button (not shown). For example, the patient may have a preferred mode for receiving communications other than e-mail, e.g., text message, regular mail, and the like, and the button 624c may default to the preferred mode of communication when selected.

In a further alternative, the Communication icon or button (or another icon or button provided adjacent the Send Email button 624c) may allow the user to communicate with the patient, review past communications, and/or modify or override standard communications scheduled to be sent to the patient, e.g., after advancement from one stage to another, as described elsewhere herein. For example, if the Communication button is selected, a separate page may be presented on the display including past communications to and/or from the patient, future scheduled communications, and the like. The user may select any such communications to review them, may select a future scheduled communication for modification or cancellation, and/or may create a new communication to send to the patient (spontaneously or based on an inquiry or other communication from the patient).

For example, after a patient is advanced from one stage of treatment to the next, one or more standard communications may be scheduled to send to the patient, e.g., including general information regarding the next stage, demographic information, scheduling, and the like. The default may that the communications are automatically sent upon advancement, after a preset time period (e.g., to provide an opportunity to modify or override), or only upon approval of a representative assigned to the patient. In the latter situations, the authorized representative may select the scheduled communication(s) and modify them, e.g., to customize the communication based on their contact with the patient, to cancel the communication (e.g., because a procedure has been rescheduled or a patient has reconsidered proceeding). Optionally, multiple communications may be provided on a single subject that include different tones, e.g., that present information more delicately or bluntly, and the representative may select an appropriately toned communication to send to the patient, e.g., based on the their previous experience with the patient.

Returning to FIG. 6C, in addition, the Contact Information page (and other individual Patient Information pages, as described further below) may include a Scale or Status Indicator 626 adjacent the information field 49, e.g., vertically along the display 28a opposite the main menu 48, as shown in FIG. 6C. The Scale 626 may provide a visual indication of the current status of the patient. For example, with additional reference to FIG. 5, the Scale 626 may include a plurality of indicators 626a-626f that correspond to the stages shown in FIG. 5. As shown, the first indicator 626a may correspond to the Candidate stage 50, the second indicator 626b to the Rep Contact stage 51, the third indicator 626c to the Trial Pre-Op stage 52, the fourth indicator 626d to the Trial stage 53, the fifth indicator 626e to the Implant Prep stage 54, and the sixth indicator 626f to the Implant stage 55. Optionally, one or more additional indicators (not shown) may be provided if there are additional stages are available for the patients, such as Post-Implant Follow-Up.

In this manner, the Scale 626 may provide an immediate visual indicator to the user of the current stage for the selected patient. In addition, the indicators 626a-626f may provide shortcuts to earlier information pages than the current stage for the selected patient. For example, for a patient who is at any stage but the Candidate stage 50, the user may select an earlier indicator from the Scale 626 (above the currently highlighted indicator) to review previous information regarding the patient. For example, for a patient in the Implant stage 55 (which will be indicated by the sixth indicator 626f being highlighted), the user may select any of the indicators above the sixth indicator 626f to review previous information, e.g., regarding the Trial stage and the like, as described elsewhere herein.

With continued reference to FIG. 6C, for a patient at the Candidate stage (first indicator 626a), the information field 49 may include general Contact Information for the patient. For example, the information fields may include one or more Name fields 620a (not shown in FIG. 6C), Phone Number fields 620b (which may be expanded and/or scrolled if multiple numbers are provided), Source field 620c (e.g., for entering how the patient learned of the treatment), Address fields 620d (e.g., street address, city, state, etc.), Email field 620e, Date of Birth field 620f, Gender field 620g, and General Notes field 620h. Optionally, one or more of the contact fields may be highlighted or other indicated as a preferred communication mode for the patient.

Optionally, as shown in FIGS. 6C(1) and 6C(2), in an alternative embodiment, the Contact Information field may be expanded or collapsed, e.g., to provide a minimum number of fields (e.g., fields required before the patient can be advanced to the next stage, as shown in FIG. 6C(1)) and a maximum number of fields (e.g., including optional fields, as shown in FIG. 6C(2)). In this alternative, a Show Extra Fields icon or button 628 may be provided, e.g., in the header or otherwise adjacent the information field 49. With the Extra Fields button 628 in the “off” position shown in FIG. 6C(1), only the patient Name fields 620a and Source field 620c may be presented, while with the Extra Fields button 628 in the “on” position shown in FIG. 6C(2), all of the optional fields 620b-620i may be presented. As with other pages in the application, if the information field 49 is too small to include all of the information included on the page, the user may scroll up or down to move between regions of the page and view all of the information available.

Returning to FIG. 6C, the Contact Information page may include an “Advance to Rep Contact Stage” icon or button 630, e.g., at the bottom of the information field 49. This button 630 may remain inactive until all of the necessary fields on the Contact Information page are completed. For example, as shown in FIG. 6C(1), only the Name fields 620a and Source field 620c may need to be completed, whereupon the “Advance” button 630 may become highlighted or otherwise active, indicating that the user may proceed to the next stage. At any time during subsequent stages, the user may return to the Contact Information page, e.g., to add, update, and/or review information regarding the patient. To complete such changes, the user may select the Edit icon or button 624d shown in FIG. 6C, whereupon the information fields may become active, allowing the user to make changes, similar to the original entries described above.

Optionally, other personnel may complete the Contact Information page, rather than a sales representative or other user. For example, a third party authorized to access the administrator server 12 and/or medical database 14 (e.g., using another electronic device 18) may enter candidates for one or multiple territories. Thereafter, once the user launches the application and synchronizes with the medical database 14, any new candidate patients that have been added to the medical database 14 within the user's territory may be added to the local database. At any time after successfully completing the Candidate stage 50 shown in FIG. 5, the user may select the patient and advance to the Rep Contact Stage 51. For example, from the Patient List page of FIG. 6A, the user may select the desired patient (whose status is Candidate under Status heading 610c), whereupon the Contact Information page similar to FIG. 6C may be presented. The user may then select the Advance button 630, e.g., after selecting the Edit button 624d, if necessary, to proceed to the next stage.

Optionally, when the Advance button 630 is selected, one or more activities may be generated by the application. For example, an Activities page may be generated automatically, e.g., including patient information, such as name, contact information, and the like, including one or more predetermined activities, e.g., to schedule a call or otherwise contact the patient. The application may automatically select a default date for the activity (e.g., thirty days from the current date) or the user may select a date and/or time to schedule the call. In addition, the application may automatically assign the activity to the current logged-in user, or alternatively, the user may select a responsible employee, e.g., the user him/herself or another member of their team. Alternatively, rather than the application automatically generating an activity, the user may manually select the Activities icon 48a from the main menu 48, and enter an activity. Examples of Activities pages are described further elsewhere herein.

In addition, optionally, when the Advance button 630 is selected, one or more standard communications may be scheduled to be sent to the patient. For example, as described elsewhere herein, general information regarding the next stage may be sent to the patient, e.g., via the preferred communication mode associated with the patient. Optionally, before send such communications, a notice may be sent to the representative associated with the patient, e.g., to confirm that the communication should be sent, to modify, and/or cancel the communication, as described elsewhere herein. Such communications and notices may be scheduled and/or sent during each of the stages described herein.

Turning to FIG. 6D, an exemplary Rep Contact Stage page or screen is shown that may be presented on the display 28a when the “Advance to Rep Contact Stage” button 630 is selected from the Candidate Stage page of FIG. 6C or when a patient is selected from the Patient List of FIG. 6A whose status is “Rep Contact Stage.” Generally, similar to other pages, the page may include the main menu 48, header 624, and information field 49, with the information field 49 including information related to contact with the patient, e.g., as shown in FIGS. 6D(1) and 6D(2), indicating whether the patient is interested in undergoing treatment.

For example, as shown in FIG. 6D, the information field 49 may include a First Contact Date field 632a (e.g., entered by the user when the patient is first called, met, or otherwise contacted), physician information fields 632c (e.g., including primary physician, referring physician, trial physician, and the like), DVD received field 632d, education date field 632e (e.g., confirming if and/or when the patient has received information regarding treatment options, procedures, and the like), ambassador fields 632f, notes field(s) 632g (e.g., for the user to enter any miscellaneous desired information regarding the patient), and the like. In addition, the Rep Contact Stage page may include an “Advance to Trial Pre-Op Stage” icon or button 634, e.g., at the bottom of the information field 49, which may remain inactive until all of the necessary fields are completed.

In the embodiment shown in FIGS. 6D(1) and 6D(2), the information field 49 may be expanded or collapsed, e.g., to provide a minimum number of fields (e.g., fields required before the patient can be advanced to the next stage, as shown in FIG. 6D(1)) and a maximum number of fields (e.g., including optional fields, as shown in FIG. 6D(2)). As shown in FIG. 6D(1), the necessary fields include the First Contact Date field 632a and the Candidate Status field 632b. For example, when a sales representative, clinical specialist, or other team member consults with the patient, they may confirm whether the patient has decided to proceed with treatment, e.g., to an initial or trial treatment. The user may enter the date of contact in the First Contact Date field 632a and, optionally, may enter any subsequent contacts and/or information shared with or received by the patient in the appropriate fields of the expanded page shown in FIG. 6D(2). Additional information, such as physician information, may be entered by the user or accessed if previously entered for the patient.

During the initial or subsequent contact, the user may inquire whether the patient would like to proceed to trial treatment. For example, for pain management treatment, trial may involve implanting leads (not shown) for a spinal cord stimulation system at least partially in the patient's body, e.g., with an external controller (also not shown) used to provide treatment on a temporary or trial basis. Other trial procedures may involve implanting leads and/or other systems at other locations in the patient's body, e.g., the brain, abdomen, and the like, as described elsewhere herein. After trial, if the patient wants to proceed to permanent implant treatment, the trial leads and external controller (and/or other systems) may be replaced with a fully implanted system, as described elsewhere herein.

If the patient confirms that they would like to proceed to trial treatment, the user may select the Candidate Status field 632b, whereupon a menu may be presented including available options, e.g., “yes,” “no,” or “undecided.” When “yes” is selected and entered, the “Advance” icon or button 634 may become highlighted or otherwise active, and the user may then select the Advance button 634 to proceed to the next stage of the application. If the patient indicates that they are not interested in treatment, the user may select “no” whereupon the patient will become inactive (e.g., after a confirmation prompt and/or a predetermined time), e.g., skipping the other stages shown in FIG. 5 to inactive 56, whereupon the patient may eventually be archived and/or removed from the active database.

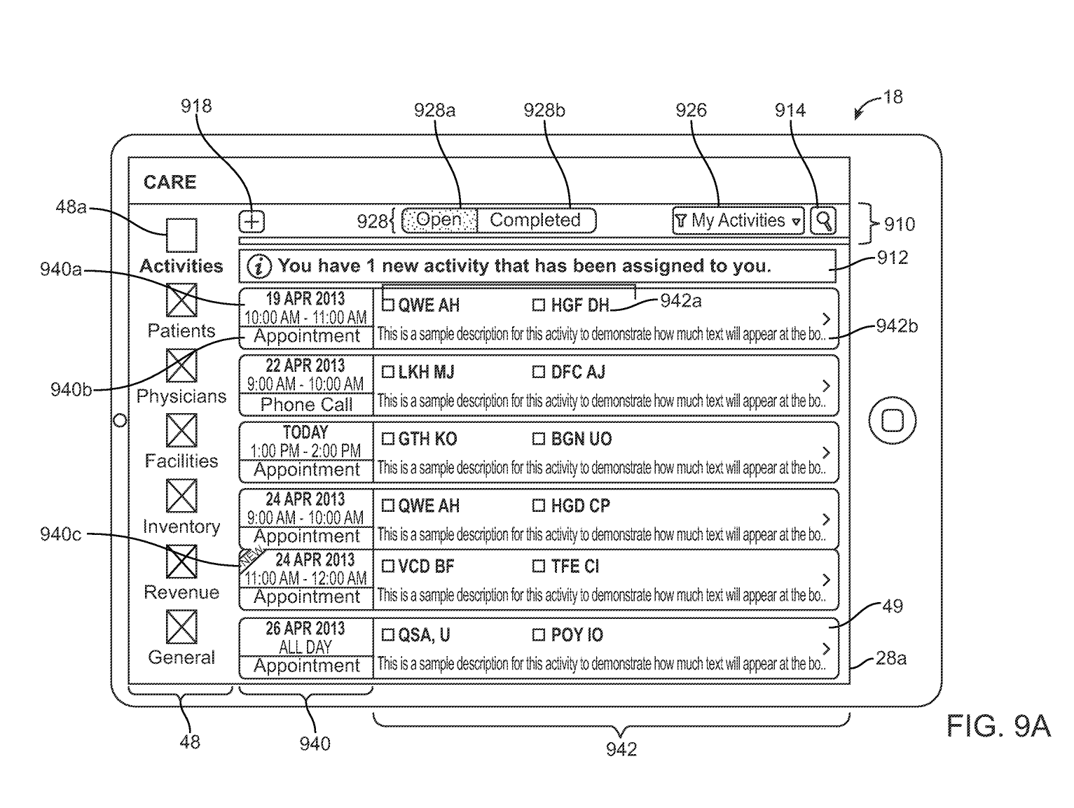

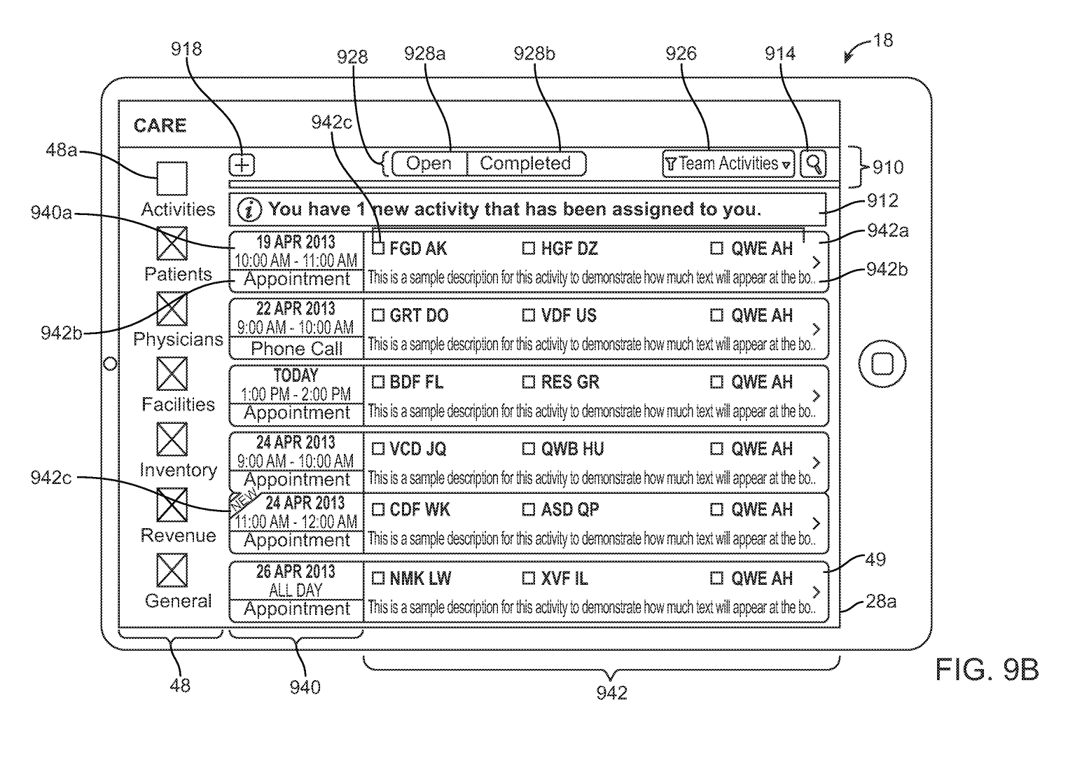

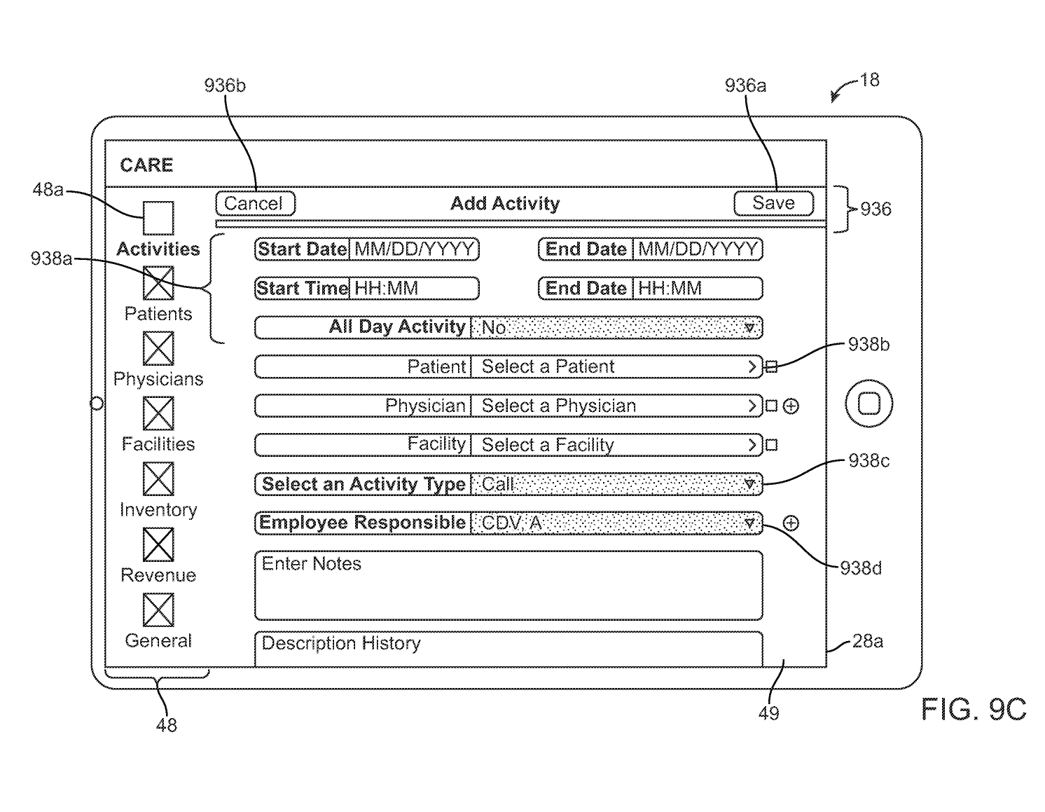

If the patient indicates that they are still considering whether to proceed, the user may select “undecided,” thereby maintaining the patient at the current Rep Contact Stage 51 in FIG. 5. Optionally, when this status is selected, the application may automatically prompt the user whether to enter an Activity, e.g., presenting a page or screen similar to that shown in FIG. 6E or 9C and described elsewhere herein, to schedule a future call or other follow-up to the patient. The scheduled date and/or time for such an activity may be set by default (e.g., thirty days from the current date) or may be entered by the user, e.g., similar to other activities described elsewhere herein.

It will be appreciated that other selections in the information field 49 may prompt similar inquires about entering an Activity. For example, as shown in FIG. 6D(2), the optional fields may include Insurance Status and/or Medical Clearance Required 632h. If the user selects or enters that such approvals have not yet been received, an Activity window may open to prompt the user to schedule a follow-up call, meeting, or other activity, e.g., with the patient's physician, insurance carrier, and the like, similar to the Add Activity page shown in FIG. 6E or 9C.

Turning to FIG. 6E, an exemplary Patient Activity page or screen is shown that may be presented on the display 28a when the user is prompted to enter an activity from a patient page, such as the Rep Contact Stage page shown in FIG. 6D(2). Similar to other pages, the Patient Activity page includes the main menu 48 (with the Patients icon 48b still highlighted), information field 49, and a header 636. The header 636 includes a Save icon or button 636a, e.g., to save activity information, and a Patient Name icon or button 636b (e.g., showing generic name IOP KJ of the patient), e.g., to cancel the activity (e.g., after a confirmation prompt) and return to the previous Patient Information page, such as that shown in FIG. 6D(2). The information field 49 may include one or more fields related to the activity, e.g., Date and Time fields 638a, Patient Information field 638b, Activity Type field 638c, Employee field 638d (e.g., showing generic name CDV, A for the employee), and the like.

For an activity triggered from a Patient Information page, such as the Rep Contact page of FIG. 6D, one or more of the fields may be automatically populated. For example, the Patient Information field 638b may automatically include the name of the patient from the previous Patient Information page, and the Employee field 638d may include the name of the user logged into the electronic device 18. If the activity triggered is a follow-up call (e.g., based on a patient being “undecided” or having an unapproved insurance status or clearance), the Activity Type field 638c may also be automatically selected and/or the date and time fields 638a may be automatically populated (e.g., with a date thirty days or other preset time period from the current date). The user may select and edit any prefilled field(s), e.g., if they want to assign the call to another team member, change the date, enter information in any unfilled fields, as desired, and then select the Save button 636a. The Activity page may then be closed, and the previous page or screen may be presented on the display 28a.

Turning to FIG. 6F, a portion of an exemplary Trial Pre-Op Stage page or screen is shown that may be presented on the display 28a when the “Advance to Trial Pre-Op Stage” button 634 is selected from FIG. 6D or when a patient is selected from the Patient List of FIG. 6A whose status is “Trial Pre-Op Stage.” Generally, similar to other pages, the page may include the main menu 48, the header 624, the Scale 626, and the information field 49, with the information field 49 including patient information fields 640 related to proceeding to trial treatment, such as insurance information, patient condition, and the like, e.g., as shown in FIGS. 6F(1) and 6F(2). The Scale 626 may include the third indicator 626c highlighted with the other indicators dimmed, e.g., to provide a visual indication that the patient is in the Trial Pre-Op stage, similar to other Patient Information pages.

As shown, the header 624 may include the patient's name 624a, a Save icon or button 624e, and a Cancel icon or button 624f. For example, the user may select the Save button 624e to add any changed or new information entered in the information fields 640 to the temporary and/or local database. Conversely, the user may select the Cancel button 624f to remove any changed or new information entered into the information fields 640, e.g., replacing the information fields 640 with previous information from the temporary and/or local database or returning the fields 640 to blank or default settings if no previous information was ever entered.

Optionally, as shown in FIGS. 6F(1) and 6F(2), the information field 49 may be expanded or collapsed, e.g., to provide a minimum number of fields 640 (e.g., fields required before the patient can be advanced to the next stage, as shown in FIG. 6F(1)) and a maximum number of fields 640 (e.g., including optional fields, as shown in FIG. 6F(2)). In this embodiment, a Show Extra Fields icon or button 628 may be provided, e.g., in the header 624 or otherwise adjacent the information field 49, similar to other patient information pages herein.

In addition, the Trial Pre-Op Stage page may include an “Advance to Trial Pre-Op Stage” icon or button 642, e.g., at the bottom of the information field 49, which may remain inactive until all of the necessary fields are completed, similar to other Patient Information pages. As shown in FIG. 6F(1), the necessary fields may include a Primary Insurance field 640a, Pain Area field(s) 640b, Trialing Physician field 640c, and Scheduled Trial Date field 640d. This (and other optional) information may be obtained by the user from one or more interviews, calls, and/or other consultation with the patient, and/or their caregiver, physician, and the like.

For example, the user may enter the primary insurance carrier for the patient by selecting the Primary Insurance field 640d, whereupon a scrolling menu (not shown) may be presented in a window or otherwise on the page with available carriers, which the user may scroll through to select the carrier. Alternatively, the field 640d (and/or other fields) may simply be a text box allowing the user to enter the name of the carrier (and/or other text), e.g., using a keyboard or other interface (not shown) presented on the display 28a, e.g., over a portion of the information field 49. Optionally, as shown in FIG. 6F(2), secondary insurance carrier information may also be entered in a similar manner, if desired. Alternatively, one of both of these fields may already be populated, e.g., from information entered previously for the patient.

Similarly, the Pain Area field 640b and/or optional fields 640e-640g may be used to enter information regarding the patient's symptoms or condition. As described elsewhere herein, an exemplary application for the systems and methods herein are for pain treatment of patients; however, it will be appreciated that different aspects of the systems and methods may be applicable to other patient conditions and/or treatments.

For example, the Pain Area field 640b (or other Condition Area, not shown, if appropriate) may be selected, whereupon a scrolling menu (not shown) may be presented in a window on the page including available selections, e.g., identifying one or more regions of the patient's body (and/or other symptoms, e.g., if used for other medical conditions instead of pain treatment). The user may select one (or optionally more) regions from the menu, e.g., based on feedback from the patient where they are experiencing pain (or other symptoms), which may be saved and displayed in the field 640b. If the field 640b only accepts one region, additional fields may be provided, e.g., to allow the user to enter additional primary or secondary regions of the patient's body experiencing pain.

The user may also enter the name of the physician scheduled to perform the procedure in the Trialing Physician field 640c. For example, the user may select the field 640c, whereupon a menu of physicians (not shown) may be presented in a window on the information field 49. The menu may default to include the names of one or more physicians already associated with the patient. Alternatively, the menu may include the names of all of the physicians within the geographical region or otherwise included in the local database. The user may scroll through the available options and select the correct physician. In a further alternative, selecting the Trialing Physician field 640c may open a new page, e.g., similar to the Physicians List page described elsewhere herein, which may allow the user to select a physician and then return to the Trial Pre-Op Stage page of FIG. 6F. In addition or alternatively, the physician who referred the patient for treatment may be presented in the Referral MD field 640h, which may be automatically populated from earlier patient information pages.

Optionally, the Trialing Facility field 640i may be provided to identify the hospital, clinic, or other healthcare facility at which the procedure is scheduled to be performed. In an exemplary embodiment, the facility field 640i may be automatically populated, e.g., based on a default facility associated with the trialing physician entered in the Trialing Physician field 640c. If desired, the user may then select the field 640i, e.g., to present a menu of facilities (not shown) to change the facility to a different one than the default. Alternatively, the field 640i may remain blank and the user may select the field 640i to select a facility from a menu. The menu may include a list of all facilities associated with the trialing physician, within the geographical region, and/or otherwise included in the local database. The user may scroll through the available options and select the correct facility. Alternatively, selecting the Trialing Facility field 640f may open a new page, e.g., similar to the Facilities List page described elsewhere herein, allowing the user to select a facility from the Facilities List.

In addition, the user may select the Scheduled Trial Date field 640d to enter the scheduled date for a trial procedure. For example, the user may select the field 640d, whereupon a keyboard or other interface (not shown) may be presented on the information field 49 to enter the date, e.g., in a format presented in the field 640d. Alternatively, a calendar or other menu (also not shown), e.g., similar to that shown in FIG. 6K, may be presented, which may allow the user to scroll or move through the calendar to select the desired date. Optionally, when a date is entered into the field 640d, the application may prompt the user to enter an Activity, e.g., to attend the procedure, order parts for the procedure, notify or confirm with the facility and/or trialing physician, and the like. For example, after the date is entered, an Activity window may be presented on the display 28a, such as that shown in FIG. 6E or 9C, which may automatically populate at least some fields, e.g. the patient's name, scheduled date, trialing physician, facility, team member (default being the user), and the like. The user may modify any information they wish to change and/or add information for any other fields before saving the Activity and returning to the Trial Pre-Op Stage page. For example, if another team member is going to attend the procedure, the user may change the team member to the person scheduled to attend.

Optionally, with continued reference to FIG. 6F(2), the user may include additional information related to the patient, e.g., based on one or more interviews or other consultation with the patient and/or their caregiver. For example, a pain (or other condition) score may be entered in the VAS Score field 640f to indicate the degree of pain, e.g., based on a 1-10 scale, that the patient indicates they are experiencing. In addition or alternatively, the user may enter one or more patient activities in the Activities Limited by Pain fields 640g, e.g., to indicate activities that the patient indicates are impaired due to their pain (or other condition).

The Trial Pre-Op Stage page may also include a Pain Map field 640e, which may provide an interactive method for identifying and/or managing the patient's condition and/or treatment. For example, as shown in FIG. 6F(2), the Pain Map field 640e may include a graphical image of at least a portion of a body 644a, e.g., a silhouette or other line drawing of the front and back of a generic human body. The graphical image may include a representation of an entire human body, as shown, or the graphical image may include a representation of only a portion of the human body, e.g., including only those portions likely to be impacted or involved in a patient's condition and/or treatment. For example, for some treatments, the graphical image may include only the upper half of the body, the torso of the body, the head and shoulders, the abdomen, the lower half of the body, and the like (not shown), if desired.

The user may select the Pain Map field 640e, whereupon an enlarged graphical image of the body 644a may be presented in the information field 49 of a new page or screen, such as that shown in FIG. 6G (e.g., labeled the “Mark Pain Areas” page). On this page, the information field 49 may become an active input interface, e.g., allowing the user to enter indicia 646 superimposed over the graphical image 644a, e.g., based on consultation with the patient.

For example, using the touchscreen, the user may simply touch and move a finger, a stylus, pen, or other tool, and the like (not shown) over the display 28a to draw indicia 646 that the application then superimposes over the graphical image of the body 644a, e.g., lines, hatching, numbers, and the like. As shown, the user has created indicia 646 circling the lower back region of the body 644a and writing a number “5” adjacent the body, e.g., to identify a region the patient is experiencing pain (the lower back region) and enter a pain score (five) identified by the patient during the consultation. Any indicia 646 superimposed over the body 644a may be provided in a different color than that used for the body. In an exemplary embodiment, the graphical image of the body 644a may be black while the indicia 646 added when the patient draws on the display 28a may be red, thereby allowing the indicia 646 to be easily distinguished from the graphical image of the body 644a itself.

Also as shown, the Mark Pain Areas page may include one or more icons or buttons to allow the user to edit and/or save information entered, e.g., indicia 646 added to the graphical image 644a. For example, as shown, a Done icon or button 644b may be provided that may be selected by the user to indicate that they are finished entering indicia and want to return to the Trial Pre-Op Stage page of FIG. 6F. In addition, an Undo icon or button 644c and/or a Reset icon or button 644d may be provided to edit indicia added. For example, the Undo button 644c may be selected to remove the most recently added indicia and/or the Reset button 644d may be selected to remove all indicia added since the page was opened (and return to the original blank graphical image 644a). In addition, the header 624 may include a Patient Name (or “Cancel”) icon or button 624g, which may be selected to return to the Trial Pre-Op Stage page without saving any of the indicia added to the graphical image. Optionally, the Mark Pain Areas page may include one or more menus (not shown), e.g., providing one or more drawing tools to allow the user to add preset indicia, e.g., shapes, arrows, lines, and/or text boxes, similar to known drawing aids.

When the Done button 644b is selected, the application may save a copy of the graphical image with indicia, e.g., to create a consultation image that may be saved in the temporary and/or local database. As described elsewhere herein, the consultation image may be used later to allow the user (or another team member using another electronic device receiving the consultation image after synchronization) to follow treatment of the patient, e.g., after a trial procedure and/or additional treatment. Optionally, the user may be able to make a copy of the consultation image, e.g., to print or e-mail a copy to the patient, one or more of the physicians, and the like. For example, one or more icons or buttons and/or menus (not shown) may be provided on the Mark Pain Areas page of FIG. 6G or on the Trial Pre-Op Stage page of FIG. 6F that may allow the user to print or save a copy of the consultation image.

When the user returns to the Trial Pre-Op Stage page of FIG. 6F, the consultation image may replace the blank graphical image 644a, e.g., thereby providing a reduced size consultation image including the indicia added by the user, e.g., similar to that shown in FIG. 6H. The consultation image, as well as the other condition information entered on the Trial Pre-Op Stage page may facilitate managing and/or monitoring the patient during subsequent treatment. For example, as described further below, at least some of the information may be included in the patient information pages for later stages.

Turning to FIG. 6H, a portion of an exemplary Trial Stage page or screen is shown that may be presented on the display 28a when the “Advance to Trial Stage” button 642 is selected from FIG. 6F or when a patient is selected from the Patient List of FIG. 6A whose status is “Trial Stage.” The Trial Stage page may be used before, during, or after the patient has undergone a trial treatment (but after the patient has confirmed that they want to proceed to trial treatment), e.g., to obtain feedback from the patient and/or determine whether the patient would like to proceed with permanent, long term, or other subsequent treatment. In addition, the Trial Stage page may be used to record sales and/or other business-related information from the trial procedure.

For example, with respect to spinal cord stimulation (“SCS”) pain treatment, during the trial stage, the patient may undergo a surgical procedure in which a trial set of leads is implanted, e.g., into or along the patient's spine, and an external controller (e.g., an External Trial Stimulator or “ETS”) is worn on a belt or otherwise carried on the patient's body. The ETS may be operated to deliver stimulating electrical energy via the leads to the patient's spine and/or other regions of the body. In other procedures (such as those described elsewhere herein), other temporary or trial systems may be implanted in the patient's body.

The Trial Stage page may be used to record information related to the system used for the patient and/or the procedure itself. In addition, after one or more initial time periods, e.g., immediately after, one or more days after, and/or a week or more after, the patient may be consulted to obtain feedback regarding their trial pain treatment, and/or determine whether the patient would like to have the trial system replaced with a permanently implanted system, as described elsewhere herein. In addition, sales or other business-related information fields 652 may be entered, e.g., related to any devices, such as leads or a controller, used during the trial procedure.

Generally, as can be seen in FIG. 6H, the page may include the main menu 48, the header 624, the Scale 626, and the information field 49, similar to other pages, with the information field 49 including patient information field 650 and sales information fields 652 related to the trial, e.g., as shown in FIGS. 6H(1) and 6H(2). As shown, the header 624 may include the patient's name 624a, a Save icon or button 624e, and a Cancel icon or button 624f, similar to the Trial Pre-Op Stage page. For example, the user may save new or changed information entered into the field 650, 652 by selecting the Save button 624e or cancel any changes by selecting the Cancel button 624f (returning the fields to their previous entries or defaults). The Scale 626 may have the fourth indicator 626d highlighted with the other indicators dimmed to provide a visual indication of the current stage of the patient, also similar to other pages.

Optionally, as shown in FIGS. 6H(1) and 6H(2), the information field 49 may be expanded or collapsed, e.g., to provide a minimum number of patient information field 650 and/or sales information fields 652 (e.g., fields required before the patient can be advanced to the Implant Prep stage, as shown in FIG. 6H(1)) and a maximum number of field 650, 652 (e.g., including optional fields, as shown in FIG. 6H(2)). In this embodiment, a Show Extra Fields icon or button 628 may be provided, e.g., in the header 624 or otherwise adjacent the information field 49, similar to other pages herein. Alternatively, multiple expansion/collapse buttons (not shown) may be provided, if desired, e.g., to expand or collapse portions of the page, e.g., those related to patient information and/or those related to sales or other business information.

In addition, the Trial Stage page may include an “Advance to Implant Prep Stage” icon or button 654, e.g., at the bottom of the information field 49, which may remain inactive until all of the necessary fields are completed, similar to other Patient Information pages herein. As shown in FIG. 6H(1), the necessary fields may include a Trial Date field 650a, Trialing Physician field 650b, Pain Area field 650c, Trial Result field 650d, and Candidate Status field 650e. Optionally, the necessary fields may also include a Trial P.O. Date field 652a, Trial P.O. Number field 652b, and Trial Revenue field 652c, as shown.

In the exemplary embodiment shown in FIG. 6H(2), the optional fields may include a Pain Map field 650f (similar to the Pain Map field 640e, shown in FIG. 6G and described elsewhere herein), additional Pain fields 650g, VAS Score field 650h, Activities Limited by Pain fields 650i, additional Patient Information fields 650j (e.g., to enter the primary side on which the patient sleeps and/or which hand is dominant), Entry and ETS fields 650k (e.g., to enter the location where the trial lead(s) were introduced into the patient's body, such as identifying the nearest vertebra where the patient's body was accessed, and/or the side of the patient's body for the external controller), Image fields 650l (e.g., to save images from the procedure, as described elsewhere herein), Procedure Notes fields 650m (e.g., to enter pre-op and follow-up notes), % of Pain Relief field 650n (e.g., to enter percentage of pain relief after consultation with the patient), Placement Improvement field 650o (e.g., to enter a description of how the location of the lead(s) may be improved for a permanent implant), and the like.

At least some of the fields may be automatically populated by information from the Trial Pre-Op Stage page, such as the trial date, trialing physician, and pain area. If the information changed between the information entered during the Trial Pre-Op stage, the user may select the relevant fields and make any desired changes. For example, the user may update the date of the actual procedure in the Trial Date field 650a and/or update the physician performing the procedure in the Trialing Physician field 650b if either has changed. When such changes are made, the original source fields, e.g., on previous Patient Information pages may also be updated with the changed information.

Similarly, the Pain Map field 650f, additional Pain fields 650g, VAS Score field 650h, Activities Limited fields 650i, and/or others may be populated with information from the Trial Pre-Op Stage page. For example, the Pain Map field 650f may include the consultation image saved after consulting with the patient, as described above with reference to FIG. 6G. The user may update one or more of these fields after the procedure, e.g., based upon consultation with the patient, e.g., to indicate the level of pain reduction experienced by the patient and/or what activities are still being impaired by their pain. Optionally, if the user changes any of these fields, the information may be saved in conjunction with the previous information (not shown), e.g., in fields adjacent one another to allow comparison of the feedback received from the patient after the trial procedure with their original symptom information.

In addition, the user may be able to update and/or add information to the consultation image presented in the Pain Map field 650f by selecting the field 650f, similar to the procedure described with reference to FIG. 6G. For example, as shown in FIG. 6I, when the Pain Map field 650f is selected, an enlarged graphical image may be presented in the information field 49 of a new page or screen (also labeled “Mark Pain Areas” or otherwise). The information field 49 may once again become an active input interface, e.g., allowing the user to enter trial indicia 658 superimposed over the graphical image 644a and consultation indicia 646 previously added to the graphical image 644a, e.g., based on further consultation with the patient after the trial procedure.

For example, as shown, the user has created indicia 658, including hatching over the lower back region of the body 644a and the original indicia 646 and writing a number “3” adjacent the body, e.g., to identify a region of the patient's body where their pain has been reduced and to enter a new pain score identified by the patient following the trial. In addition or alternatively, the user may update the VAS Score field 650h with the patient's new pain score.

Any trial indicia 658 superimposed over the consultation image may be provided in a different color than that used for the body 644a and/or the consultation indicia 646. In an exemplary embodiment, the trial indicia may be yellow, thereby allowing the trial indicia 658 to be easily distinguished from the graphical image of the body 644a itself and the consultation indicia 646. Thus, as shown in FIG. 6I, the pain map may include both the original pain regions and the coverage being provided by the trial pain treatment system.

Once the user has completed adding any desired indicia to the pain map, the user may select the Done button 644b to indicate that they are finished entering indicia and want to return to the Trial Stage page of FIG. 6H. In addition or alternatively, the header 624 may include a Patient Name (or “Cancel”) icon or button 624g, which may be selected to return to the Trial Stage page without saving any of the indicia added to the graphical image.

When the Done button 644b is selected, the application may save a copy of the graphical image with indicia, e.g., to create a trial treatment image that may be saved in the temporary and/or local database. Similar to the consultation image, the trial treatment image may be used later to allow the user (or another team member using another electronic device receiving the consultation image after synchronization) to follow additional treatment of the patient, e.g., after a permanent SCS implant procedure and/or additional treatment.

Returning to FIG. 6H(2), if desired, the user may associate one or more additional image files with the Trial Stage page. For example, as shown, Trial Lead Sync/Programming Scan and Attach a Fluoro Image fields 6501l may be provided, which allow the user to attach image files related to the trial procedure. During a SCS trial procedure, the trialing physician may acquire one or more images of the patient's body, e.g., using fluoroscopy or other imaging methods, showing the location of the lead(s) implanted in the patient's body.

If the user selects the Attach a Flouro Image field 650l, a window or page may be superimposed over the Trial Stage page or otherwise presented on the display 28a, and the user may be prompted to take a digital photograph using the camera 29 of the electronic device 18. After confirming with the trialing physician, the user may take one or more digital photographs of desired fluoroscopic images and save them as image files in the temporary or local database. Thus, images from the trial procedure, e.g., showing the entry site and/or or other location of the lead(s) implanted in the patient's body may be saved for later use, e.g., during further treatment, such as the Implant Prep or Implant stages, during further consultation with the patient, their physician(s), and the like, as described elsewhere herein.

Optionally, once one or more image files are saved, a thumbnail, title, or other identifier may be added to the Trial Stage page, e.g., under or otherwise adjacent the Attach a Fluoro Image field 650l to indicate the saved files. Subsequently, when the identifier for an image is selected, a new page may open allowing the user to view the image and, if desired, add indicia to the image. For example, a page may be presented similar to the Mark Pain Areas page of FIG. 6G or 6I, except with the fluoro or other image in place of the graphical image of the body 644a. Similar icons, buttons, and/or menus may be provided, allowing the user to add indicia, which may be superimposed over the original image, e.g., in a different, optionally selectable, color different than the image itself. When the user saves the modified image, the original image file may be replaced with a new image file including the added indicia. Alternatively, the user may be prompted to save the modified image by a different name, e.g., if the user wants to save the original image as well as the modified image.

Returning to FIGS. 6H(1) and 6H(2), the user may be able to print, e-mail, and/or otherwise generate a file including one or more images from the trial procedure and/or patient information (e.g., a PDF or other conventional file that may be printed or e-mailed). For example, as shown, a Create Facesheet icon or button 656 may be provided on the Trial Stage page, e.g., adjacent the Advance button 654, as shown. When the user selects the Create Facesheet button 656, a Create Facesheet page or screen may be presented on the display, such as that shown in FIG. 6J, including the main menu 48 and an information field 49 including a plurality of predefined regions 660 into which the user may add images and/or other information. For example, the user may select one of the regions 660, whereupon a menu may be superimposed over the Facesheet page or otherwise presented on the display 28a, allowing the user to select an image file, e.g., from a list of images associated with the patient. The user may select as many images as desired.

Alternatively, the Facesheet page may include one or more default regions, e.g., including predetermined images and/or information. For example, one of the regions may default to include the Pain Map trial treatment image associated with the patient, such as that shown in FIG. 6I. Another region may include patient information related to the trial, e.g., the patient's name, physician, and the like and/or pain information, such as that included in fields 650c, 650g, 650h, 650i shown in FIG. 6H(2). The user may replace the default regions, if desired, or simply add other images to the other regions available.

Once the user has added any desired images or information, the user may select the Send Facesheet icon or button 662, whereupon the application may generate a Facesheet file, e.g., a PDF file, or may immediately direct an available printer to generate a hardcopy of the Facesheet. At any time, the user may select the Patient Name icon or button 624g, e.g., in the header, to return to the Trial Stage page of FIG. 6H.

Returning to the Trial Stage page of FIG. 6H, after the trial procedure, the user may be required to select an entry for the Trial Result field 650d. When the field 650d is selected, a menu of available options (not shown) may be presented on the display 28a or an empty field may be provided into which the user may type an entry. In an exemplary embodiment the Trial Result menu may include options such as “completed,” “postponed,” and “failed.” For example, if the trial procedure was successfully completed, the user may select the “completed” option to indicate the success of the procedure, which is a necessary predicate before the patient can be consulted for follow-up and/or further treatment.

If the trial procedure was not completed, the user may select “postponed” to indicate that the procedure was canceled, e.g., due to patient or physician schedules, conflicts, or other issues. Optionally, when the “postponed” option is selected, the user may be prompted to enter a new trial date in the Trial Date field 650a or the field 650a may be defaulted to blank and/or to provide a reason for the postponement. In addition, the application may prompt the user to enter a new Activity, e.g., a follow-up call or other contact with the patient, trialing physician, facility, and the like, to set a new trial date. If the “failed” option is selected, a window or field may be presented, prompting the user to provide a reason for the failure of the procedure. In the event of a failed procedure, the application may also prompt the user to enter a new Activity, e.g., similar to the “postponed” option.

After successful completion of a trial procedure, the user may consult with the patient on one or more occasions, e.g., to follow-up on the results of the trial, and add information to the Trial Stage page based on such consultation(s). For example, the user may enter information in the % of Pain Relief field 650n, and/or add notes in the Notes fields 650m based on consultation with the patient, e.g., immediately post-op, after 1-2 days, and after 3-7 days, and/or may update information in the pain fields 650c, 540g, 650h, or 650i populated from the Trial Pre-Op stage. Once the patient has completed the trial, the user may consult with the patient to determine whether the patient would like to proceed to permanent implant or other further treatment. For example, the user may select the Candidate Status field 650e to enter the patient's status. If the patient confirms that they would like to proceed to permanent implant treatment, the user may select the Candidate Status field 650b, whereupon a menu may be presented including available options, e.g., “yes,” “no,” or “undecided.”

When “yes” is selected and entered, the “Advance to Implant Pre Stage” icon or button 654 may become highlighted or otherwise active (assuming that all of the other necessary fields have also been filled). The user may then select the Advance button 654 to proceed to the next stage of the application, as described further elsewhere herein. If the patient indicates that they are not interested in further treatment, the user may select “no” whereupon the patient will become inactive (e.g., after a confirmation prompt and/or a predetermined time), e.g., skipping the other stages shown in FIG. 5 to inactive 56, whereupon the patient may eventually be archived and/or removed from the active database. Finally, if the patient is still considering whether to proceed, the user may select “undecided,” thereby maintaining the patient at the current Trial Stage 53 in FIG. 5. Optionally, when this status is selected, the application may automatically prompt the user whether to enter an Activity, e.g., presenting an Add Activity page such as that shown in FIG. 6E or 9C, to schedule a future call or other follow-up to the patient, as described elsewhere herein.

In addition, after the trial treatment is completed, the user may schedule or enter the date in which any implanted devices are to be removed from the patient's body in the Lead Pull Date field 650p. For example, for trial SCS pain treatment, the trial lead(s) need to be removed from the patient's body, e.g., to be replaced with a set of permanently implanted lead(s) and an implanted controller (rather than the external controller used during trial). The user may enter the date of the scheduled removal in the field 650p, e.g., after consultation with the patient, trialing physician, treatment facility, and the like. When a date is entered in the Lead Pull Date field 650p, the user may be prompted to create an Activity, e.g., presenting an Add Activity page such as that shown in FIG. 6E or 9C, to attend the procedure themselves or to assign the Activity to another team member, similar to other Activities described elsewhere herein.

Returning to FIGS. 6H(1) and 6H(2), the Trial Stage page may also be used to record sales and/or business information related to the trial procedure. For example, when the patient confirms that they want to proceed to trial, the user may be provided a purchase order, e.g., from the physician's office, associated facility, and the like, for the system to be used. The date, P.O. number, and amount of the purchaser order may be entered in fields 652a, 652b, 652c, respectively. Optionally, the user may enter information regarding the lead(s), controller, and/or other devices of the system used during the trial procedure, e.g., Serial Nos., System model, and the like in respective fields 652 shown in FIG. 6H(2).

Turning to FIG. 6K, an exemplary Implant Prep Stage page or screen is shown that may be presented on the display 28a when the “Advance to Implant Prep Stage” button 654 is selected from FIG. 6H or when a patient is selected from the Patient List of FIG. 6A whose status is “Implant Prep Stage.” The Implant Prep Stage page may be used after the patient has undergone a successful trial treatment and confirmed that they want to proceed to permanent implant or other subsequent treatment.

For example, with respect to spinal cord stimulation (“SCS”) pain treatment, during the Implant stage, a permanent set of leads and controller may be implanted, e.g., into or along the patient's spine and/or elsewhere in the patient's body. In other procedures (such as those described elsewhere herein), other permanent or long term systems may be implanted in the patient's body. The Implant Prep Stage page may be used to record information related to the scheduling of the implant procedure.

Generally, as can be seen in FIG. 6K, the page may include the main menu 48, the header 624 (e.g., similar to other pages), the Scale 626 (now with the fifth indicator 626e highlighted), and the information field 49, with the information field 49 including implant procedure information fields 664. Optionally, the information field 49 may be expanded or collapsed, e.g., to toggle between a minimum number of necessary fields and a maximum number of fields (not shown), in which case a Show Extra Fields icon or button (also not shown) may be provided, similar to other Patient Information pages. In addition, the Implant Prep Stage page may include an “Advance to Implant Stage” icon or button 668, e.g., at the bottom of the information field 49, which may remain inactive until all of the necessary fields are completed, similar to other pages herein.

In an exemplary embodiment, the necessary fields may include an Implanting Physician field 664, an Implanting Facility field 664b, and a Scheduled Implant Date field 664d. Optionally, the fields 664 may also include an Implant Consult Date field 664c, Notes field 664e, and/or Implant Authorization Date fields (not shown). Optionally, the Implanting Physician and Implanting Facility fields 664a, 664b may default to the same physician and facility from the trial procedure, or the fields 664a, 664b may default to blank until the user selects them and enters or selects a physician and facility, similar to other methods herein. The user may select the Implant Consult Date field 664c and/or enter notes in the Notes field 664e after consultation with the patient, e.g., to confirm the patient's intention to proceed with the implant and/or to provide any additional information to the patient.

Once a date is scheduled for the implant procedure, the user may select the Scheduled Implant Date field 664d and enter the date, e.g., from a calendar menu as shown in FIG. 6K or manually entering the date in appropriate portions of the field (not shown). Once the necessary fields 664 are filled, the Advance button 668 may become highlighted and/or active, similar to other pages, whereupon the user may select the Advance button 668 to advance the patient's status to the Implant Stage.

Turning to FIG. 6L, a portion of an exemplary Implant Stage page or screen is shown that may be presented on the display 28a when the “Advance to Implant Stage” button 668 is selected from FIG. 6K or when a patient is selected from the Patient List of FIG. 6A whose status is “Implant Stage.” Similar to the Trial Stage page, the Implant Stage page may be used before, during, or after the patient has undergone a permanent implant procedure or other subsequent treatment following trial, e.g., to record information from the procedure, obtain feedback from the patient, and/or record sales other business-related information from the implant procedure.

For example, with respect to spinal cord stimulation (“SCS”) pain treatment, during the implant stage, the patient may undergo a surgical procedure in which a permanent set of leads and a controller are implanted, e.g., into or along the patient's spine or elsewhere in the patient's body, as described elsewhere herein. In other procedures (such as those described elsewhere herein), other permanent or long term systems may be implanted in the patient's body.

Generally, as can be seen in FIG. 6L, the page may include the main menu 48, the header 624, the Scale 626 (with the sixth indicator 626f highlighted), and the information field 49, with the information field 49 including patient information fields 670 and sales information fields 672 related to the implant procedure, e.g., as shown in FIGS. 6L(1) and 6L(2). Optionally, as shown in FIGS. 6L(1) and 6L(2), the information field 49 may be expanded or collapsed, e.g., to toggle between a minimum and maximum number of patient information fields 670 and/or sales information fields 672, e.g., similar to the Trial Stage page.

As shown in FIG. 6L(1), the minimized information field 49 may include an Implant Date field 670a, Implanting Physician field 670b, Pain Area field 670c, Implant P.O. Date field 672a, Implant P.O. Number field 672b, Implant Revenue field 672c, and SCS System field 672d, as shown.

Conversely, as shown in FIG. 6L(2), the maximized information field 49 may also include a Pain Map field 670f (similar to the Pain Map fields 640e, 650f, shown in FIGS. 6G and 6I), VAS Score field 670h, Activities Limited by Pain fields 670i, additional Patient Information fields 670j, Image fields 670l, and Notes fields 670m, which may be selected, edited, and the like, similar to the corresponding fields on the Trial Page.

At least some of the fields may be automatically populated by information from the Implant Prep Stage page, such as the Implant Date, Implanting Physician, and Pain Area fields 670a-670c, similar to the Trial Stage page. If the information changed between the information entered during the Implant Prep stage, the user may select the relevant fields and make any desired changes. Similarly, the Pain Map field 670f, VAS Score field 670h, Activities Limited fields 670i, and/or others may be populated with information from the Implant Prep Stage page.

For example, the Pain Map field 670f may include the trial treatment image saved after consulting with the patient post-trial, as described above with reference to FIG. 6I. The user may update one or more of these fields after the procedure, e.g., based upon consultation with the patient. Optionally, if the user changes any of these fields, the information may be saved in conjunction with the previous information (not shown), e.g., in fields adjacent one another to allow comparison of the feedback received from the patient between pre-trial consultation, the trial procedure, and the implant procedure.

In addition, the user may be able to update and/or add information to the trial treatment image presented in the Pain Map field 670f by selecting the field 670f, similar to the procedure described with reference to FIGS. 6G and 6I. For example, when the Pain Map field 670f is selected, an enlarged graphical image may be presented in the information field 49 of a new page or screen (not shown), e.g., allowing the user to enter implant indicia (also not shown) superimposed over the trial treatment image, e.g., based on further consultation with the patient after the implant procedure. Any implant indicia 658 superimposed over the trial treatment image may be provided in a different color than that used for the body 644a and/or previous indicia 646, 658, e.g., green or blue, to easily distinguish the implant indicia. Once the user has completed adding any desired indicia to the pain map, the user may select the Done button (not shown) to save their changes and return to the Implant Stage page of FIG. 6L. When the Done button is selected, the application may save a copy of the graphical image with indicia, e.g., to create an implant treatment image that may be saved in the temporary and/or local database.

Returning to FIG. 6L(2), if desired, the user may associate one or more additional image files with the Implant Stage page, e.g., using the Lead Sync/Programming Scan and/or Attach a Fluoro Image fields 670l, similar to the Trial Stage page. For example, during the implant procedure, the implanting physician may acquire one or more images of the patient's body, and the user may take a digital photograph using the camera 29 of the electronic device 18 of the image(s). Optionally, the user may subsequently select one of the images and add indicia, which may be superimposed over the original image, e.g., in a different, optionally selectable, color different than the image itself, as described elsewhere herein.

Returning to FIGS. 6L(1) and 6L(2), the user may be able to print, e-mail, and/or otherwise generate a file including one or more images from the trial procedure and/or patient information (e.g., a PDF or other conventional file that may be printed or e-mailed). For example, as shown, a Create Facesheet icon or button 656 may be provided on the Implant Stage page, which may be used similar to the Create Facesheet button 656 on the Trial Stage page, and as described elsewhere herein.

Returning to the Implant Stage page of FIG. 6L, after successful completion of an implant procedure, the user may consult with the patient on one or more occasions, e.g., to follow-up on the results of the trial, and add information to the Implant Stage page based on such consultation(s), e.g., similar to the Trial Stage page. In addition, after the implant procedure, the user may schedule or enter one or more follow-up dates, e.g., in the Post-Op/Incision Check Date, Reprogramming/Follow-Up Date, and Referring Physician Follow-Up Date fields 670q. For example, the user may enter appropriate dates in these field 670q, e.g., after consultation with the patient, implanting physician, referring physician, treatment facility, and the like. When a date is entered in one of these fields 670q, the user may be prompted to create an Activity, e.g., presenting an Add Activity page such as that shown in FIG. 6E or 9C, to attend a follow-up or to assign the Activity to another team member, similar to other Activities described elsewhere herein.

Returning to FIGS. 6L(1) and 6L(2), the Implant Stage page may also be used to record sales and/or business information related to the implant procedure. For example, when the patient confirms that they want to proceed to implant, the user may enter the date, P.O. number, and amount of the purchaser order may be entered in fields 672a, 672b, 672c, respectively. Optionally, the user may enter information regarding the system used during the implant procedure, e.g., identifying the model system used in the SCS System field 672d.

Referring to FIG. 5, optionally, an Implant Follow-Up stage (not shown) may be included after the Implant Stage 55, e.g., and the one or more pages may be provided to enter information related to further patient follow-up, e.g., at predetermined intervals and/or other times after the Implant Stage. Such pages (not shown) may include fields similar to those shown in FIGS. 6L(1) and 6L(2) and/or may include other information obtained from the patient, their physician, and the like. Finally, as shown in FIG. 5, once the follow-up and/or any remaining dates for the patient pass, the patient may be advanced to inactive status 56. For example, after a predetermined time period, the patient information may be archived, e.g., retained in the central medical database 14 and removed from the databases distributed to the electronic devices 18, as described elsewhere herein.

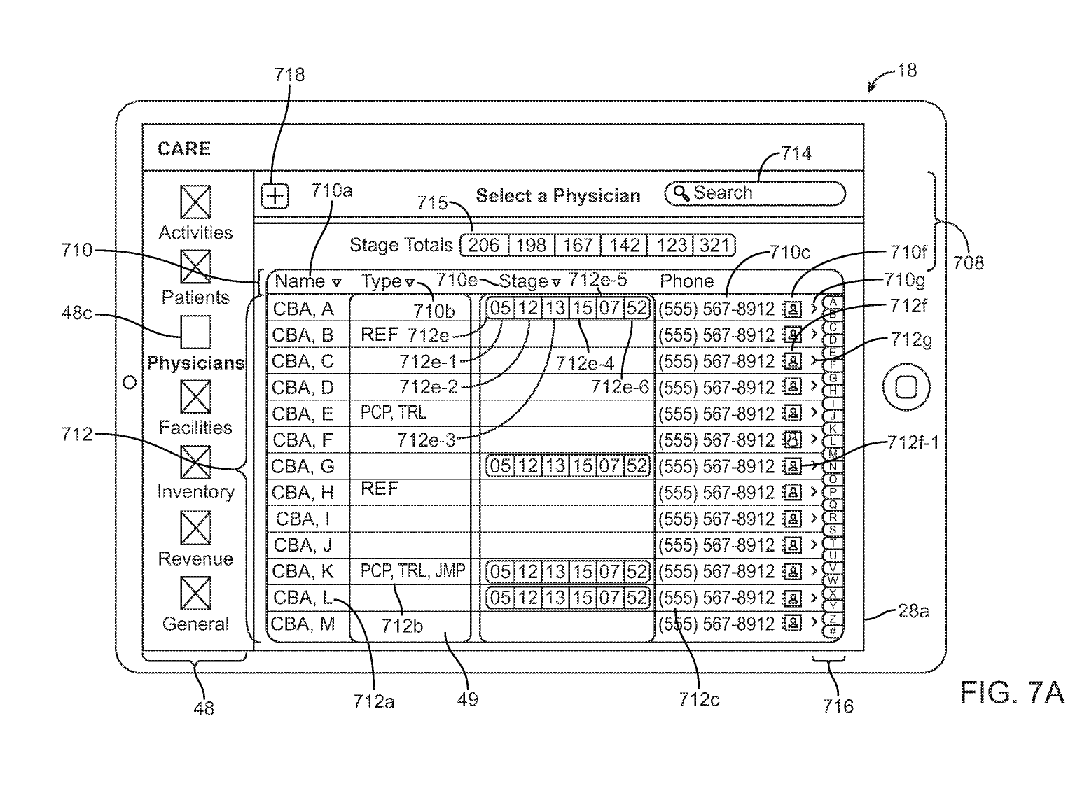

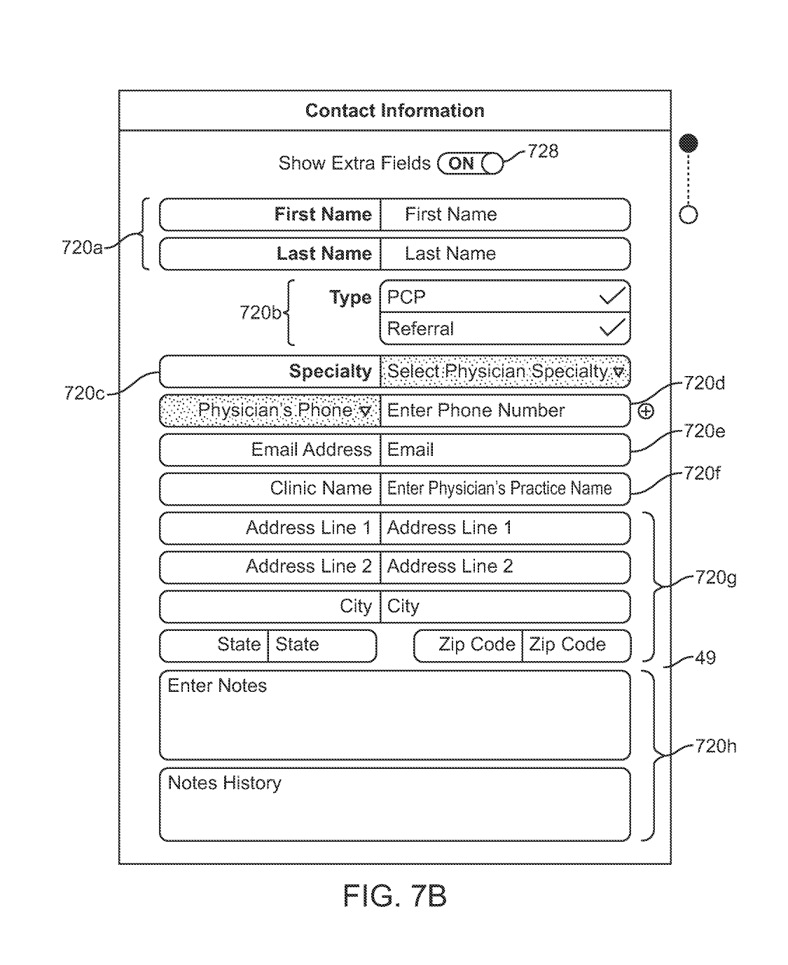

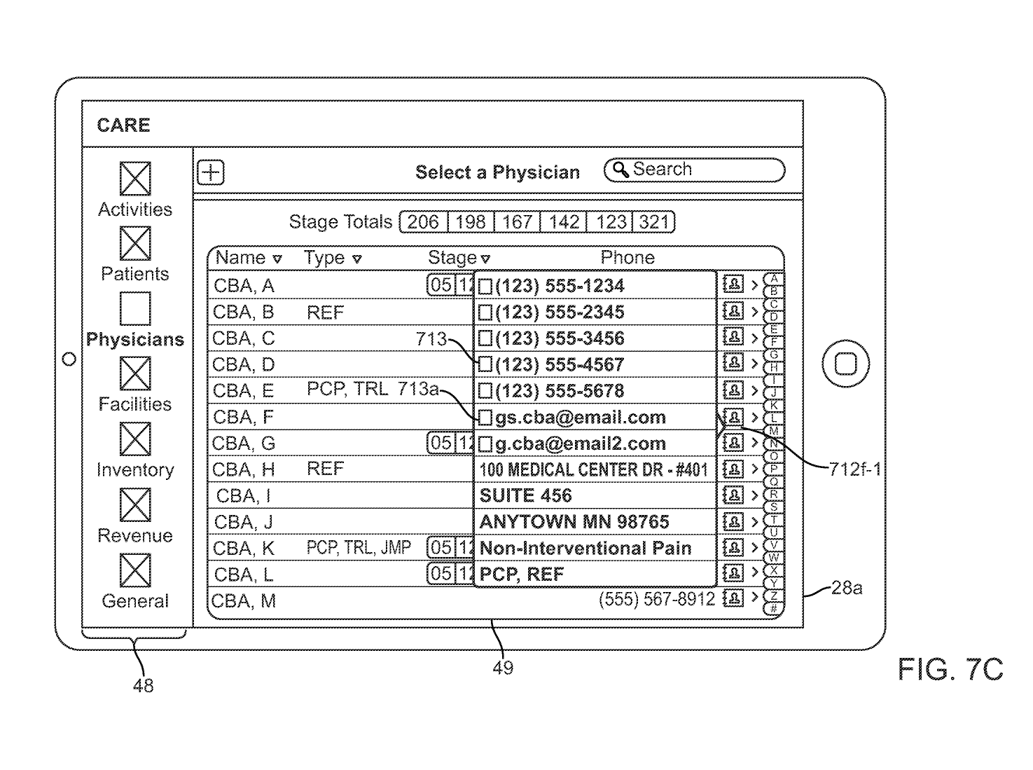

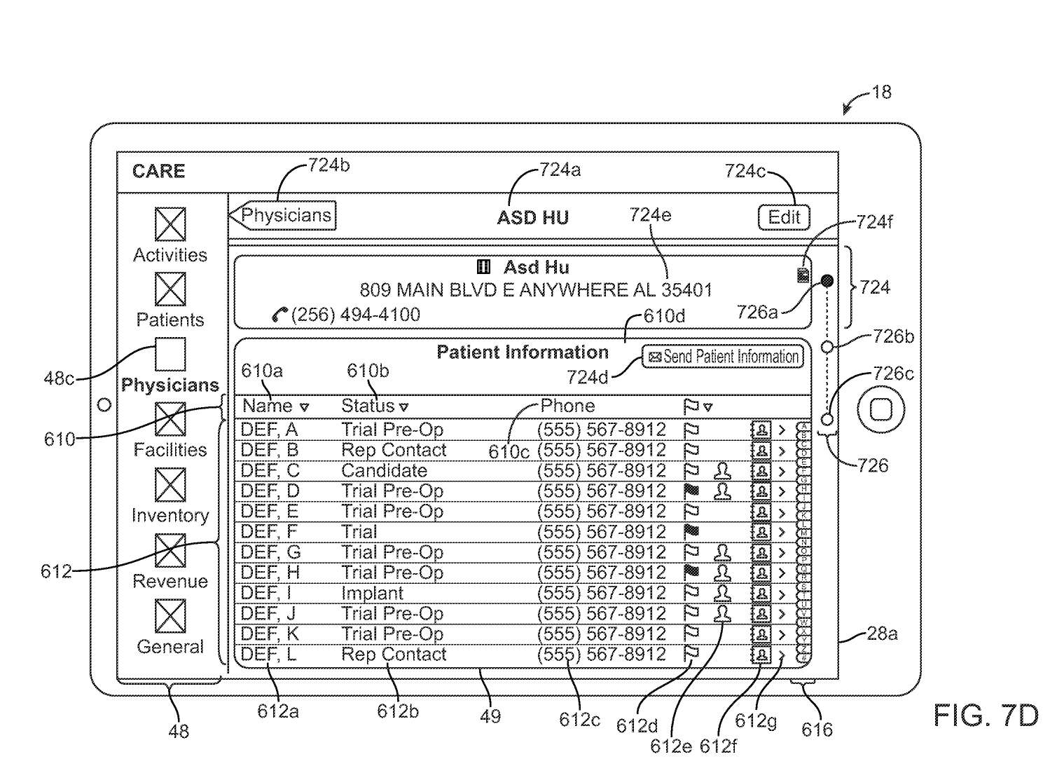

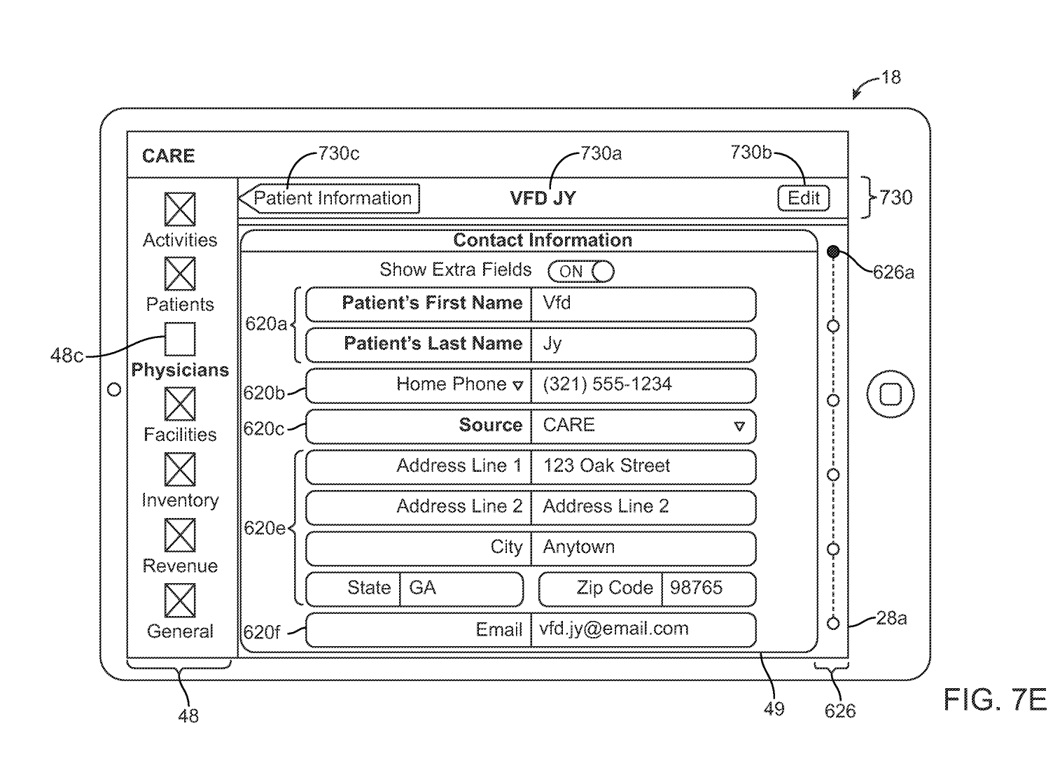

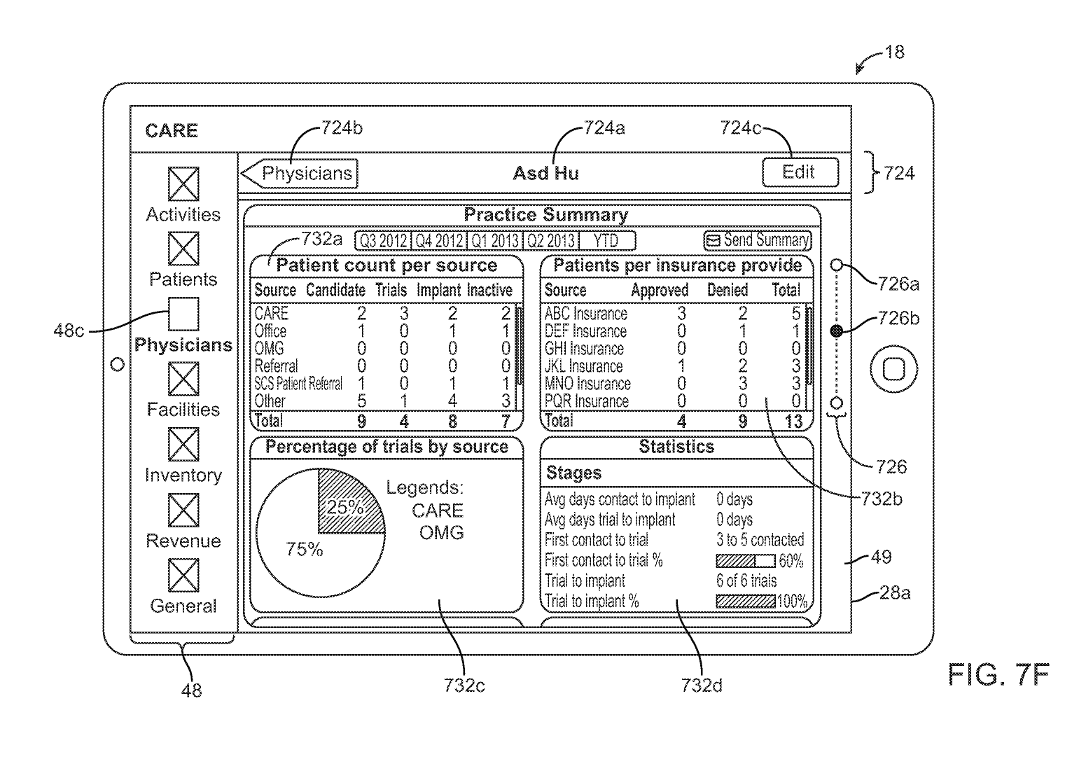

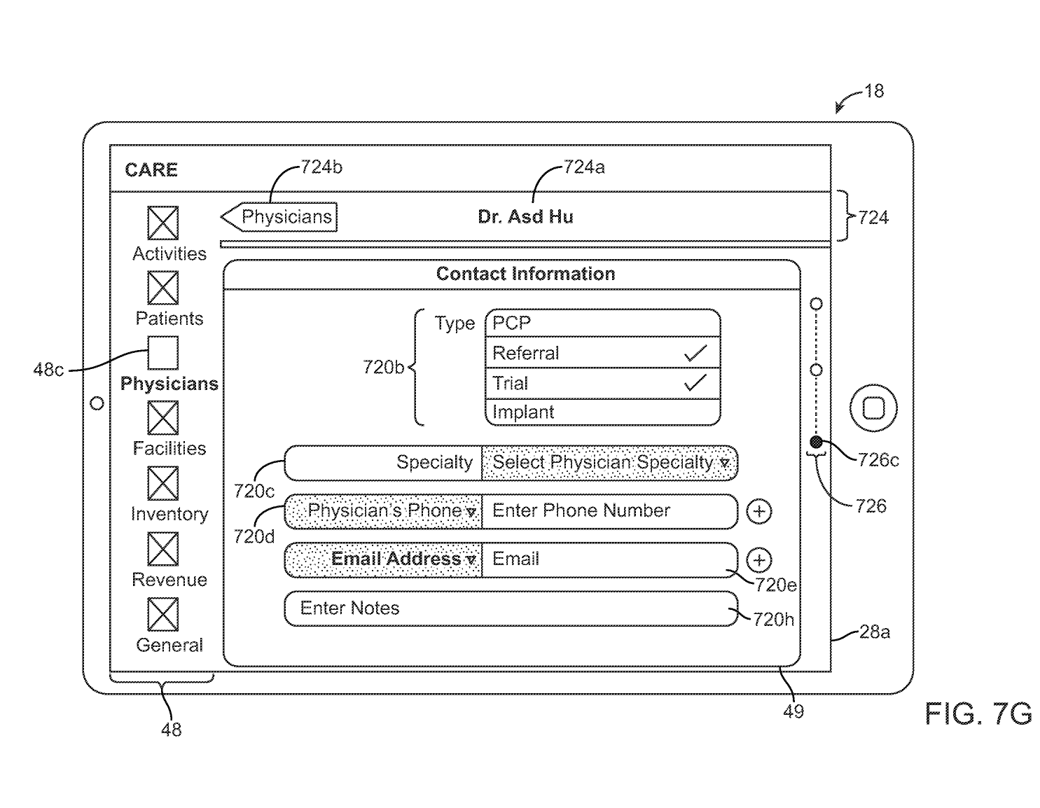

Turning to FIG. 7A, an exemplary Physician List page or screen is shown that may be presented on the display 28a when the Physicians icon 48c is selected from the main menu 48. As shown, when the Physicians icon 48c is selected, the Physicians icon 48c may be highlighted while the other icons of the main menu 48 may be dimmed or otherwise distinguished, similar to other selections from the main menu 48.

Generally, when the Physicians icon 48c is selected, the processor 22 of the electronic device 18 (shown in FIG. 2) may access the local database to obtain names of physicians within the territory and present on the display 28a information related to their treatment of and/or relationships with patients included in the local database. For example, as described further below, the processor 22 may access the local database to determine the number of patients associated with each physician and present graphically a summary of how many of physician's patients are at various stages of treatment, e.g., between the candidate stage and trial or implant stages, such as the stages shown in FIG. 5 and described elsewhere herein. Alternatively, rather than using the local database, the processor 22 may communicate an inquiry to the administrator server 12 requesting the information, e.g., including the current territory, username, and/or other identifiers limiting the segment of the medical database 14 whose physicians and patients are to be included in the results. The administrator server 12 may access the medical database 14 to determine the number of patients associated with each physician in the territory and their current stages of treatment. The administrator server 12 may then communicate the patient totals for each physician back to the electronic device 18, and the processor 22 may present the information on the display 28a, e.g., for review and/or analysis by the user.

FIG. 7A shows an exemplary embodiment of a Physicians List page for presenting physician information including a graphical summary or “Stage” banner summarizing the status of patients associated with physicians within the territory. As shown, the information field 49 of the Physician List page may include a Title Row including a plurality of headings 710 over respective columns, and then rows 712 of physician information for individual physicians (e.g., for those physicians active within the selected territory). In the exemplary embodiment shown, the headings 710 include Name 710a, Type 710b, Phone 710c, and Stage 710e. The rows 712 beneath these headings 710 may be populated with corresponding information, e.g., the full names of the physicians, the physician type (e.g., referring physician (REF), primary care physician (PCP), trialing physician (TRL), implanting physician (IMP), and the like), and phone number (or alternatively other contact information), for all of the physicians included in the local database of the electronic device 18.

Similar to the Patient List page, if the number of physician rows exceeds the available space in the information field 49, the user may scroll through the Physician List, e.g., sliding a finger up or down on the touchscreen (or otherwise via a user interface), with the heading row 710 remaining substantially stationary while the physician rows 712 move across the information field 49. Also similar to the Patient List page, the information in the Physician List page may be organized, filtered, and/or searched in a number of ways. For example, as shown in FIG. 7A, a Search field 714 may be provided, e.g., in a header 708 or otherwise along a border of the information field 49, into which a user may type search terms to find a specific physician or otherwise limit the number of physicians included in the physician rows 712. In addition, the Physician List may include an alphabetical menu 716, and the user may input one of the letters, e.g., by touching or otherwise selecting a desired letter, to include only physicians whose last name starts with the selected letter or, alternatively, jump to the section of the list where the last names begin with the selected letter. The physician rows 712 may also be sorted based on one or more of the columns 710, e.g., by Name 710a (e.g., toggling between alphabetical and reverse alphabetical order) or Type 710b (e.g., sorting the physicians alphabetically based on type of physician).

Optionally, the user may have the ability and/or authority to add physicians to the Physicians List. For example, as shown in FIG. 7A, a “+” icon or button 718 may be included, e.g., in the header 708 or otherwise along the border of the information field 49, which may be selected by the user to add a physician (e.g., after the user has verified that the physician does not exist in the local database, e.g., based on review of the Physician List or other confirmation).

Turning to FIG. 7B, an exemplary information field 49 for a Physician Contact Information page or screen is shown that may be presented when the “+” button 718 is selected from FIG. 7A. Generally, the Contact Information page may include the main menu 48 (not shown) and information field 49, similar to other pages herein. Optionally, the information field 49 may be collapsible, e.g., to include only required fields, and expandable, e.g., to include additional optional fields, similar to other pages herein. If so, the Contact Information page may also include a Show Extra Fields icon or button 728, as shown in FIG. 7B, which may be selected to toggle between the collapsed and expanded fields.

As shown in FIG. 7B, a number of physician information fields 720 may be presented in the information field 49 to allow the user to enter information regarding the new physician being added. In the exemplary embodiment shown, the fields may include Physician Name fields 720a (e.g., for last name, first name, and optionally middle name(s) or initial(s), not shown), Type 720b (e.g., allowing selection of available types of physician, such as those identified above, from a pull down or other submenu), and Specialty 720c (e.g., allowing selection of available specialties from a pull down or other menu, not shown).

In addition, multiple contact fields may be provided, such as Physician's Phone field 720d (optionally, with additional fields available for additional phone numbers, not shown), Email Address field 720e, Clinic Name field 720f (e.g., to enter the physician's practice), Address fields 720g, and Notes fields 720h. Optionally, if the physician is associated with one or more medical facilities in the local database, one or more Facilities fields (now shown) may be provided, allowing the user to associate the physician with facilities within the local database. Such information may be used to automatically populate fields and/or submenus when the physician is selected on other pages, such as the Patient Information pages described elsewhere herein.

Similar to the Add Patient page shown in FIG. 6B, when the necessary fields are completed, the user may select a Save icon or button (not shown) adjacent the information field 49, whereupon the new physician may be added to the temporary database and/or to the local database. When the electronic device 18 is synchronized with the medical database 14 via the administrator server 12, the information for the new physician may also be added to the medical database 14 (and synchronized with other devices having a local database including data for the same territory including the physician). Alternatively, if the user decides not to enter the physician, the user may select a Cancel icon or button (also not shown), whereupon the fields may be cleared. Once either the Save or Cancel button is selected (optionally, with an additional confirmation window or field being presented, which must be accepted or declined by the user), the user may be returned to the Physician List page of FIG. 7A.

With continued reference to FIG. 7A, the Stage column 710e may provide a graphical summary regarding patients associated with each physician, for example, summarizing the stage of treatment of that physician's patients, e.g., based on the stages shown in FIG. 5, as described elsewhere herein. As shown in FIG. 7A, each physician row 712 identifying a physician having patients within the territory may include a Stage banner 712e under the Stage header 710e, with the Stage banner 712e including a plurality of fields, e.g., six, as shown, filled with numbers of patients associated with that physician separated by their current stage of treatment. When a physician is first added to the Physician List, the Stage banner 712e for that physician may be omitted, e.g., as shown in the second row of FIG. 7A. Alternatively, each physician row 712e may include a Stage banner with the fields remaining blank (or defaulted to “0” or other null indicator, not shown) if the physician does not yet have any patients associated with them. As patients are subsequently associated with the added physician (e.g., by the user or other team members), the Stage banner 712e fields may be updated, e.g., upon synchronization with the medical database 14.

In an exemplary embodiment where the treatment involves SCS pain management treatment, the fields may include the number of a) Candidates (e.g., “05” in the first field 712e-1 of row 1 in FIG. 7A), b) patients Contacted (by sales personnel or other users) (e.g., “12” in the second field 712e-2), c) patients undergoing Current Trials (e.g., “13” in the third field 712e-3), d) patients who have completed Successful Trials (e.g., “15” in the fourth field 712e-4), e) patients Scheduled for Implants (e.g., “07” in the fifth field 712e-5), and f) patients who have Completed implant procedures (e.g., “52” in the sixth field 712e-6).

Thus, the Stage banner 712e may provide a snap-shot of the patients associated with each physician, for example, to allow sales personnel and/or other users to analyze the physician's practice and/or patient relationships, e.g., to identify anomalies or other trends that may require action. For example, if a physician (e.g., a referring physician) has a large number of patients in the first Candidate field, but relatively few in the other fields, this may provide an indication that the physician may not be referring appropriate patients for treatment, since it appears that few have proceeded past the Candidate stage. This may prompt a member of a sales team to visit the physician and provide further education on the treatment, e.g., to facilitate the physician better identifying patients in the future who are likely to benefit from the treatment. In another example, if a physician has a large number of patients at an intermediate stage, e.g., at the Current Trials stage or Scheduled Implants stage with a substantial drop in patients for the following Successful Trials stage or Completed Implant stage, this may provide an indication that there is a delay related to the physician's patients. This may be caused by one or more issues, e.g., problems obtaining insurance approval, over-scheduling by the physician or associated medical facilities, failure to follow-up with the patients, and the like. Thus, such an indication may prompt a member of a sales team to contact the physician's office, e.g., to facilitate ensuring the patients complete treatment or are otherwise advancing the patients to the following stages.

For example, the user may create an Activity, e.g., using an Add Activity page such as that shown in FIG. 6E or 9C, assigned to themselves or another team member, to call, meet, or otherwise follow-up with the appropriate person or organization based on the analysis provided by the Stage banner 712e for one or more physicians. In addition or alternatively, a Flag or other status column (not shown) may be provided in the physician information fields, e.g., to allow a user to select a Flag or other indicator (not shown) in a particular row to highlight the physician in that row for further attention. In this manner, a number of physicians whose Stage banner 712e indicates that a follow-up is warranted may be distinguished (and optionally sorted similar to using the Flags in the Patient List pages) to facilitate subsequent action. Once a physician's patient flow or other issues have been remedied, the Flag or other indicator may be selected to remove the Flag for that physician e.g., to indicate that the physician has returned to normal status.

For physicians who appear to be properly referring and/or treating patients, the numbers of patients in each of the fields of the Stage banner 712e may maintain a dynamic steady state, e.g., with patients moving through each of the stages (and corresponding numbers consequently moving through each of the fields of the Stage banner 712e). The number of patients within the Completed field 712e-6 may accumulate and increase as patients undergo and complete final implant procedures and then become inactive.

The data with the Stage banners 712e of the patients may be limited to a default time frame. For example, the data may include totals for “life-to-date,” i.e., from the date when each physician was added to the medical database 14 to the present date. Alternatively, the data may be limited in other ways by default, e.g., based on the last twelve months from the present date, the last quarter from the present date, calendar year-to-date, calendar quarter-to-date, last calendar year, last calendar quarter, and the like.

Optionally, the user may be able to change the time frame for data included in the Stage banners 712e, e.g., by selecting the Stage header 710e, the Stage banners 712e, or other location (e.g., by selecting and holding over one of these fields) to open a submenu (not shown) including optional data ranges that may be selected (such as those date range options identified above). When a new date range is selected, the processor 22 (based on accessing the local database or after communicating with the administrator server 12) may present updated information within the Stage banners 712a based on the selected date range. Thus, the user may limit or expand data included within the Stage banners 712e, e.g., to identify recent trends, review past history, and the like, as desired.

In addition, as shown in FIG. 7A, a Total Stage Banner 715 may be provided, e.g., in the header 708 above Stage column 710e in the information field 49 or otherwise adjacent the information field 49. The Total Stage Banner 715 may include fields including the total number of patients within the territory (e.g., within the local database) separated by their current stage of treatment, similar to the Stage banners 712e of the individual physicians. Thus, a user, e.g., a territory manager, may easily review a snap-shot of the status of patients within the territory, e.g., to confirm at a high level that patients are being identified as candidates and being advanced through treatment in a desired manner. Optionally, the data included in the Total Stage Banner 715 may be limited to a selected date range, e.g., by selecting the Total Stage Banner 715 on the touchscreen or otherwise, whereupon a submenu (not shown) may be presented, allowing the user to select a desired date range for data included in the Total Stage Banner 715, similar to the individual physician Stage banners 712e.

In another option, one or more additional Total Stage Banners (not shown) may be provided adjacent the Total Stage Banner 715. For example, a Regional Total Stage Banner may be included that shows the status of all patients within the territory that includes the individual physician. Alternatively, a Total Stage Banner may be provided for the entire nation or business unit. Optionally, the user may be able to select the additional Total Stage Banner to change the parameters between these or other options, e.g., between territory, nation, business unit, and/or others.

Thus, in a similar manner, a territory manager may be able to easily review the individual physician's management of patients compared to the total numbers for the territory, nation, and/or business unit. For example, if the physician's totals vary dramatically from the territory's totals, the territory manager may want to investigate further the differences. Alternatively, if the physician's totals correspond proportionately to the territory's totals, the territory manager may confirm that the physician's treatment of patients corresponds is typical of other physicians in the territory (which may provide positive confirmation of the physician's performance or, if the totals indicate a bottleneck, the manager may recognize that the problem may be regional and not specific to the individual physician).

In addition, as shown in FIG. 7A, the Physician List may include additional columns that provide or allow access to further information, such as a column 710f of physician contact icons 712f, and a column 710g of “>” (“carrot” or “Physicians—Patient Information”) icons 712g. The physician contact icons 712f may be selected to present additional information regarding the selected physician, e.g., a “quick view” of information. For example, as shown in FIG. 7C, the user may select the physician icon 712e-1, whereupon a supplemental window 713 may be superimposed over the Physician List or otherwise presented on the display 28a that includes contact information for the physician, e.g., phone numbers, e-mail addresses, physical addresses, and the like.

One or more of the address fields may include a Contact icon or button 713a adjacent a contact reference (e.g., phone number, e-mail address), which may be selected, e.g., to call the selected physician, send the physician an e-mail, and the like, using the electronic device 18 or another device (e.g., a mobile phone, not shown). Optionally, the background, e.g., including the main menu 48 and/or information field 49, may be dimmed to facilitate review of the information in the window 713. To close the window 713, the user may simply touch a region of the touchscreen outside the window 713 or select a Close icon or button (not shown) that may be associated with the window 713.

With further reference to FIG. 7A, the “>” icons 712g for each physician may be selected to review more detailed information regarding the patients associated with that physician. For example, if the user selects the “>” icon 712g for a physician (and/or the region over the physician's name or other area of the physician's row not otherwise active for other purposes), the Physician List page may be replaced with a Physicians—Patient Information page, such as that shown in FIG. 7D.

The Physicians—Patient Information page may provide a list of patients associated with the selected physician, e.g., including their current stage, contact information, and the like. Generally, similar to other pages, the Physicians—Patient Information page may include the main menu 48 (with the Physicians icon 48c still highlighted) and an information field 49 including a Patient List, which may be similar to that shown in FIG. 6A, except that the list is limited only to patients associated with the selected physician. In addition, the Physicians—Patient Information page may include a header 724, e.g., including the physician's name 724a and, optionally, one or more menu icons or buttons allowing the user to perform various actions. For example, the header 724 may include a Physicians icon or button 724b, which may be selected to return to the Physician List page of FIG. 7A. Optionally, the header 724 may include a banner field 724e, e.g., including contact information for the selected physician, e.g., address, phone number, e-mail address, and the like. In addition, the header 724 may include a Notes icon 724f, which may be selected to review any notes saved regarding the physician, e.g., from the Contact Information page Notes fields 720h (see, e.g., FIG. 7B).

The header 724 may also include an Edit icon or button 724c, e.g., which may be used to review and/or edit information related to the identified physician. For example, if the Edit button 724c is selected, the application may present a page similar to the Contact Information page of FIG. 7B. In this case, an Edit icon or button (not shown) may be provided, e.g., adjacent the information field 49 of the Contact Information page, allowing the user to activate and edit one or more fields. In the Edit mode, a Save and/or Cancel icon or button (also not shown) may again be provided to allow the user to save or cancel any changes made, similar to other pages herein.

Returning to FIG. 7D, optionally, the header 724 may also include a Send Patient Info icon or button 724d, which may be selected to generate a copy of the Patient List that may be e-mailed or printed. For example, if the user elects this button 724d, a window or another page may open (not shown), saving a copy of the Patient List in an available format (e.g., as a PDF file, JPEG, and the like) as an attachment to an e-mail, which the user may send to themselves, another team member, the physician themselves, and the like. Once sent, the user may be returned to the Physicians—Patient Information page.

Within the information field 49 of the Physicians—Patient Information page, a Patient List of information may be presented, similar to that shown in FIG. 6A, except limited to patients associated with the identified physician. As shown, the Patient List includes a Title Row including a plurality of headings 610 over respective columns, and then rows 612 of patient information for individual patients. In the exemplary embodiment shown, the headings 610 include Name 610a, Status 610b, Phone 610c, and Flag 610d. The rows 612 beneath these headings 610 may be populated with corresponding information, e.g., the full names, status (e.g., based on the stages shown in FIG. 5), and phone number of patients included in the local database of the electronic device 18. In addition, one or more of the patient rows may be highlighted by a flag under the Flag heading 610d, as described elsewhere herein.

Similar to the Patient List of FIG. 6A, the information in the Patient List in FIG. 7D may be organized, filtered, and/or searched in a number of ways. For example, the Patient List may include an alphabetical menu 616, and the user may input one of the letters, e.g., by touching or otherwise selecting a desired letter, to include only patients whose last name starts with the selected letter or automatically scroll to the location on the list where the last names begin with the selected letter. In addition, the patient rows may be sorted based on one or more of the columns 610, e.g., by Name 610a, Status 610b, and/or Flag status 610d, as described elsewhere herein.

In addition, the Patient List may include additional columns that provide further information, such as a column of physician contact icons 612e, a column of patient information icons 612f, and a column of “>” (“carrot” or “more information”) icons 612g. As described elsewhere herein, the user may select a physician contact icon 612e, whereupon a supplemental window (not shown) may be superimposed over the Patient List or otherwise presented on the display 28a that includes contact information for the physician associated with the selected patient. The physician identified when a physician contact icon 612e is selected may default to the patient's surgeon (e.g., expected to complete a trial or implant procedure, or other preset physician. Thus, a patient may appear on the Patient List even if the physician identified in the banner field 724e (whose patients are listed in the Patient List) is not the default physician associated with the patient, e.g., if the physician is their referring physician, primary care, physician, and the like, as will be appreciated by those skilled in the art.

With continued reference to FIG. 7D, the user may select a patient information icon, 612f, whereupon a supplemental window (not shown) may be superimposed over the Patient List or otherwise presented on the display 28a that includes additional contact information for the associated patient, e.g., address, additional phone numbers, caregiver, and the like. In addition, the user may select a “>” or “more information” icon 612g, whereupon a Patient Profile page or screen may be presented on the display 28a, such as that shown in FIG. 7E, that includes contact information for the associated patient, e.g., Patient Name fields 620, Phone field 620b, Source field 620c, Address fields 60e, and an Email field 620f. The Patient Profile page may include a header 730, e.g., including the patient's name 730a (e.g., again shown with a generic name VFD JY) and one or more icons or buttons, e.g., an Edit button 730b and a Patient Information button 730c.

Optionally, the Patient Profile page may be similar to the Candidate Stage page available from the Patients module, e.g., similar to the page shown in FIG. 6C. For example, as shown in FIG. 7E, a Scale 626 may be provided adjacent the information field 49 with the first indicator 626a highlighted. The user may be able to select the other indicators, if desired, e.g., to review additional information for the patient from other stages (if the patient has progressed to the selected stages or beyond).

If authorized, the user may be able to edit the information on the Patient Profile page, e.g., by selecting the Edit button 730b, whereupon the fields 620 may become active, allowing the user to add or change information. Once such editing is complete, the user may select a Save icon or button (not shown) to save any changes. The user may return to the Physicians—Patient Information, e.g., by selecting the Patient Information button 730c of FIG. 7D.

Optionally, the Physicians—Patient Information page may include a Scale 726, e.g., including a plurality of indicators 726a-726c. The Scale 726 may allow the user to access multiple pages related to the selected physician in addition to the Patient List. For example, when a user initially selects a physician from the Physicians List of FIG. 7A, the application may default to present the Physicians—Patient Information page on the display 28a, and the first indicator 726a may be highlighted. The user may thereafter select the second or third indicators 726b, 726c to present additional physician-specific pages, as described further below, and/or return to the Physicians—Patient Information page by selecting the first indicator 726a.

For example, if the user selects the second indicator 726b, a Practice Summary page or screen may be presented on the display 28a, e.g., similar to that shown in FIG. 7F. Similar to other pages herein, the Practice Summary page includes the main menu 48 (with the Physicians icon 48c highlighted), the header 724, and the information field 49, which may include one or more windows 732 including information related to the practice of the selected physician (identified in the name field 724a of the header 724).

The Practice Summary page may provide additional breakdown and/or statistical information regarding the selected physician's practice, which may facilitate the user to strategize their sales and/or activities related to the physician. With additional reference to FIGS. 1 and 2, when the second indicator 726b on the scale 726 is selected, the processor 22 of the electronic device 18 may access the local database stored in memory 24 and/or 25 and generate data to include in the Information Field 49. Alternatively, when the second indicator 726b is selected, the processor 22 may transmit a request via the communication interface 26 to the administrator server 12, e.g., including the physician's name and, optionally, a time constraint (e.g., year-to-date, an identified quarter, and the like, similar to the date ranges identified elsewhere herein). The administrator server 12 may access the medical database 14 to generate a response to the request including the data to be included in the information field 49 and transmit the response back to the electronic device 18.

As shown, the information field 49 may include a plurality of windows 732 including tables, graphs, charts, and the like regarding the physician's practice, such as a Patient Count Per Source window 732a, a Patient Per Insurance Provider window 732b, a Percentage of Trials by Source window 732c, and a Statistics window 732d. Optionally, additional windows may be included (not shown), and the user may scroll up or down to review the additional available windows.

In addition, the windows 732 may be preset and fixed, e.g., such that the same data categories and/or configuration of information are presented in the windows 732 in each of the team electronic devices 18 (when the Practice Summary page is selected). Thus, the windows 732a-732d may be substantially the same when the Practice Summary is selected for the same physician and date range regardless of the user's electronic device. Alternatively, the windows 732 may be customized, e.g., by touching and holding individual windows 732, selecting a submenu (not shown) adjacent the windows 732, and the like. In this alternative, the submenu may include the windows shown in FIG. 7F as well as other options available.

In the particular example shown in FIG. 7F, the first window 732a includes a table identifying Sources from which patients initially learn about available treatments, e.g., as entered in field 620c of FIG. 6C, and described elsewhere herein (Source column)) and showing Totals of the identified physician's patients who originated from each Source, e.g., separated by the current stages of the patients (Candidate, Trials, Implant, Inactive columns). Thus, a user who is a sales representative may be able to identify which sources are generating more candidate patients, as well as patients who complete treatment, for the identified physician. Similarly, the third window 732c includes a pie chart showing a breakdown of the physician's patients by Source who have proceeded to trials (or, alternatively, to other stages, such as final implant stage, and the like).

The second window 732b may include a table identifying insurance providers (Source column) and showing Totals of the physician's patients insured by each provider, e.g., separated by whether the providers have approved or denied the patients' treatments (Approved, Denied, and Total columns). Thus, for example, a sales rep may be able to identify groups of patients whose insurance provider are denying coverage, which may motivate the sales rep to contact the physician, the insurance provider, or both to identify potential problems and solutions to ensure patients are able to obtain treatment.

The fourth window 732d may include a plurality of statistics related to the physician's practice, e.g., average days from a patient being identified as a candidate to completing trial or final implant, percentage or total numbers of patients who have completed trial or implant relative to the total number of candidates identified by or otherwise associated with the physician, and the like. Such statistics may allow a sales rep to determine whether the physician is properly referring patients likely to complete treatment and/or whether the physician is ensuring timely treatment of their patients. It will be appreciated that other statistics may be included, if desired, e.g., to facilitate sales reps and/or other personnel to ensure patients are properly identified and/or treated in a timely manner.

Turning to FIG. 7G, when the third indicator 726c on the Scale 726 is selected, an exemplary Physician Summary page or screen is shown that may be presented on the display 28a, which may provide more detailed information regarding the selected physician. Similarly to other pages, the third indicator 726c may be highlighted on the Scale 726 relative to the other indicators 726a, 726b. The Physician Summary page may include the physician's name 724a in the header 724 and contact information for the physician in fields 720 of the information field 49, e.g., similar to fields shown in FIG. 7B. The user may edit the information by selecting the Edit button 724c and/or return to the Physician List page of FIG. 7A by selecting the Physicians button 724b.

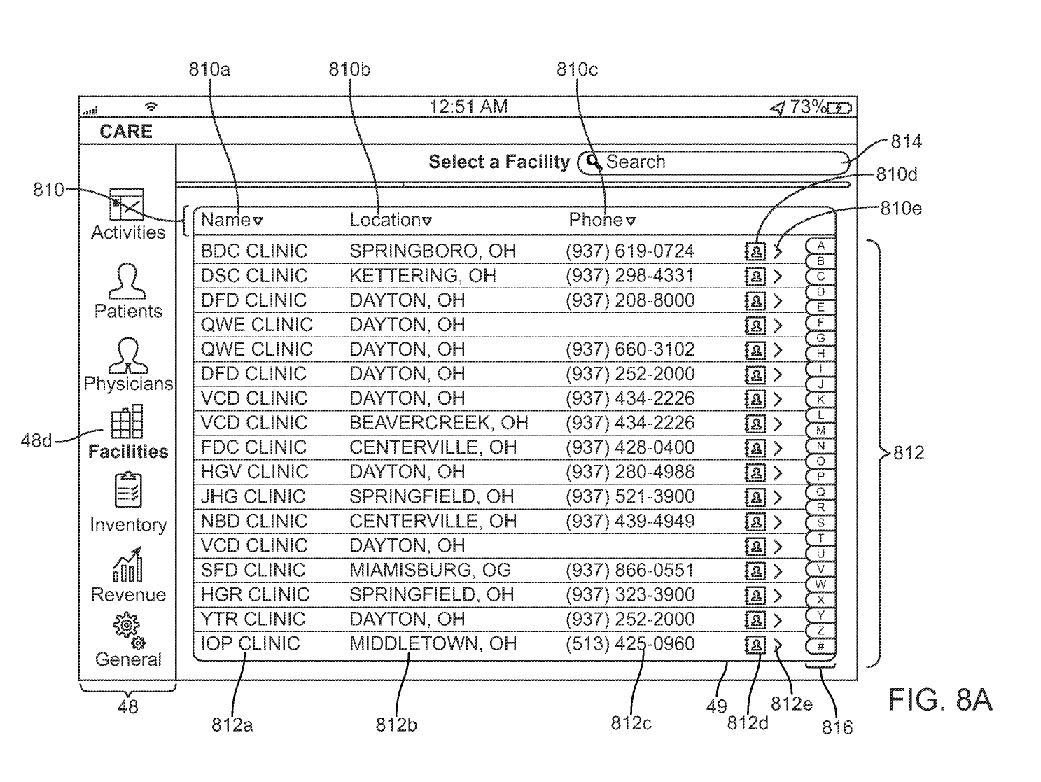

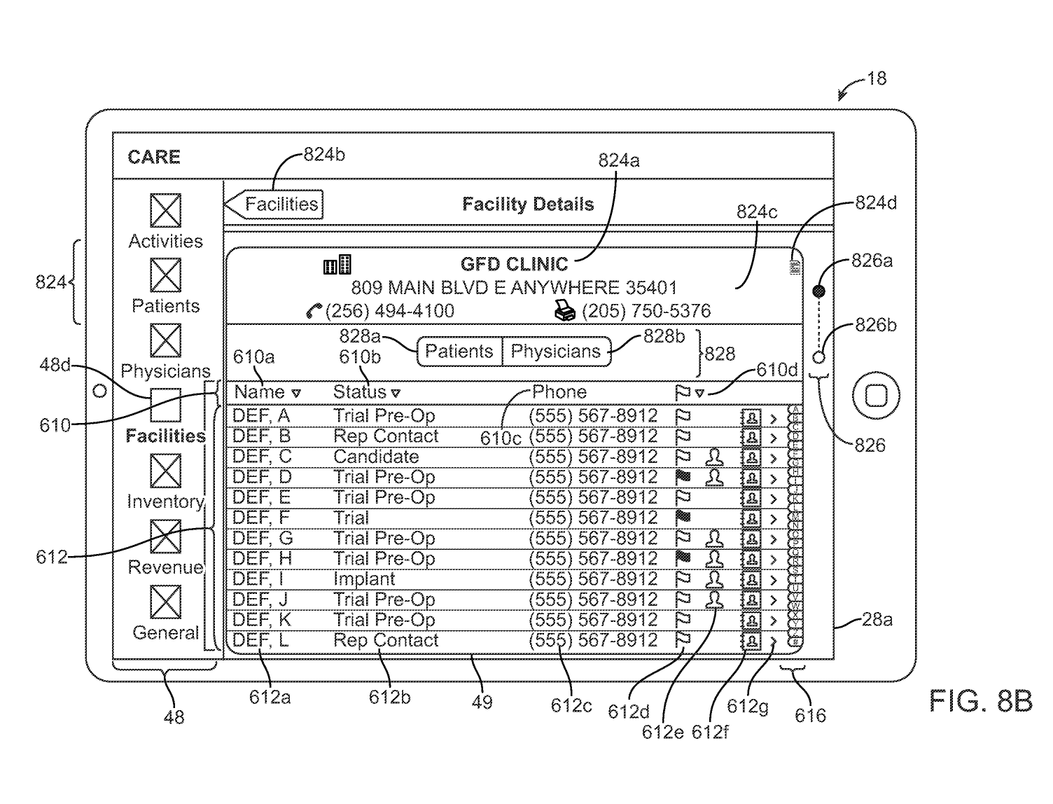

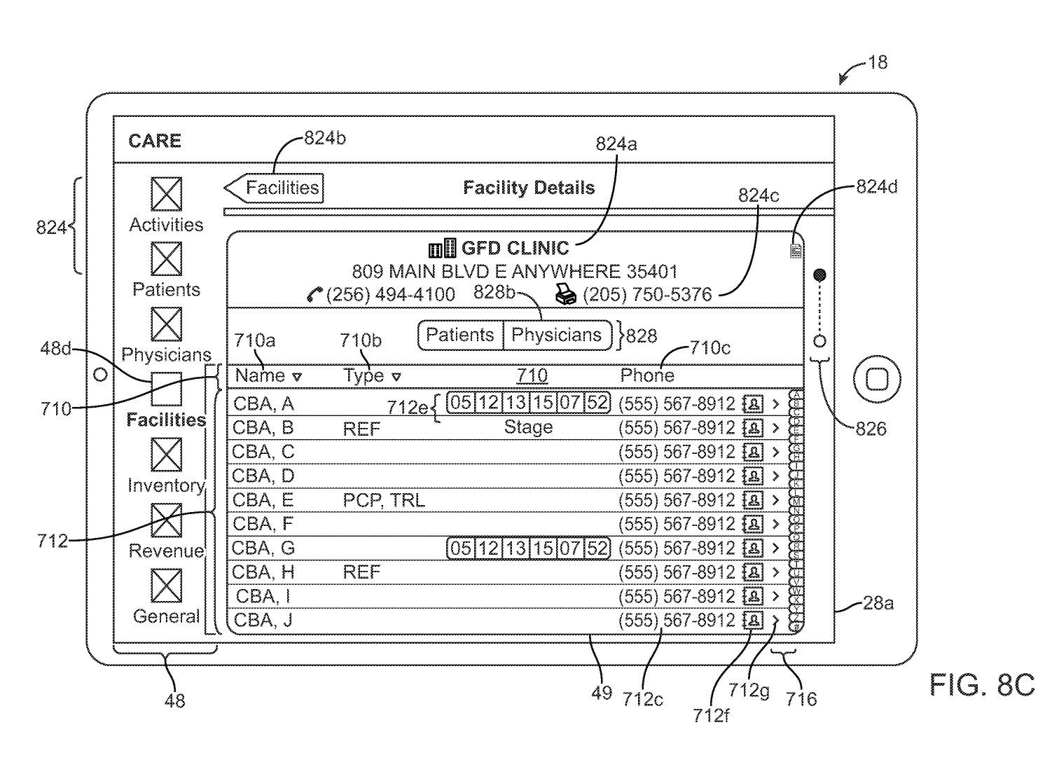

Turning to FIG. 8A, an exemplary Facilities List page or screen is shown that may be presented on the display 28a when the Facilities icon 48d is selected from the main menu 48. Similar to other pages, when the Facilities icon 48d is selected, the Facilities icon 48d may be highlighted while the other icons of the main menu 48 may be dimmed or otherwise distinguished.

Generally, when the Facilities icon 48d is selected, the processor 22 of the electronic device 18 (shown in FIG. 2) may access the local database to obtain names of facilities within the territory and present information on the display 28a regarding the facilities and/or their relationships with patients and/or physicians included in the local database within the information field 49.

For example, FIG. 8A shows an exemplary embodiment of a Facilities List page that may be initially presented in which the information field 49 includes a Title Row including a plurality of headings 810 over respective columns, and rows 812 of facility information for individual facilities (e.g., for those facilities active within the selected territory of the local database). In the exemplary embodiment shown, the headings 810 include Name 810a, Location 810b, and Phone 810c. The rows 812 beneath these headings 810 may be populated with corresponding information, e.g., the name of each facility 812a, the location of the facility 812b, and the main phone number (or alternatively other contact information) 812c, for all of the facilities included in the local database of the electronic device 18.

In addition, additional columns may be provided that provide or allow access to further information, such as a column 810d of facility contact icons 812d, and a column 810e of “>” (“carrot” or “Facility Details”) icons 812e. The facility contact icons 712f may be selected to present additional information regarding the selected facility, e.g., a “quick view” of information, similar to that shown in FIG. 7C, except including facility information rather than physician information. The “>” icon 812e may be selected to present additional information, e.g., regarding patients and/or physicians associated with a selected facility, e.g., as shown in FIGS. 8B and 8C and described further below.

Returning to FIG. 8A, similar to other List pages, if the number of facility rows 812 exceeds the available space in the information field 49, the user may scroll through the Facilities List, e.g., sliding a finger up or down on the touchscreen (or otherwise via a user interface), with the heading row 810 remaining substantially stationary while the facility rows 812 move across the information field 49. Also similar to other List pages, the information in the Facilities List page may be organized, filtered, and/or searched in a number of ways. For example, as shown in FIG. 8A, a Search field 814 may be provided, e.g., in a header or otherwise along a border of the information field 49, into which a user may type search terms to find a specific facility or subset of facilities, e.g., entering a name, location, and the like to limit the number of facilities listed in the facility rows 812.

In addition, the Facilities List may include an alphabetical menu 816, and the user may select one of the letters, e.g., by touching or otherwise selecting a desired letter, to include only facilities whose name starts with the selected letter or, alternatively, jump to the section of the list where the facility names begin with the selected letter. The facility rows 812 may also be sorted based on one or more of the columns 810, e.g., by Name 810a (e.g., toggling between alphabetical and reverse alphabetical order) or Location 810b (e.g., sorting the facilities alphabetically based on city or other location), similar to other lists herein.

Optionally, the user may have the ability and/or authority to add facilities to the Facilities List. For example, a “+” or “Add” icon or button (not shown) may be included, e.g., adjacent the information field 49, which may be selected by the user to add a facility. When the Add icon is selected, a Facility Contact Information page or screen may be presented including information fields to allow the user to enter information regarding the new facility being added, e.g., similar to the Physician Contact Information page of FIG. 7B. When the necessary fields are completed, the user may select a Save icon or button (not shown) adjacent the information field 49, whereupon the new facility may be added to the temporary database and/or to the local database. When the electronic device 18 is synchronized with the medical database 14 via the administrator server 12, the information for the new facility may also be added to the medical database 14, similar to other pages herein. Alternatively, if the user decides not to enter the facility, the user may select a Cancel icon or button (also not shown), whereupon the fields may be cleared. Once either the Save or Cancel button is selected (optionally, with an additional confirmation window or field being presented, which must be accepted or declined by the user), the user may be returned to the Facilities List page of FIG. 8A.

Optionally, the Facilities List page may include a column of Stage banners (not shown), e.g., similar to the Stage banners 712e shown in FIG. 7A, which may include a summary of how many of each facility's patients are at various stages of treatment, e.g., between the candidate stage and trial or implant stages, such as the stages shown in FIG. 5 and described elsewhere herein.

Turning to FIGS. 8B and 8C, exemplary Facility Details pages or screens are shown that may be presented on the display 28a when a “>” icon 812e is selected from the Facilities List page of FIG. 8A for a selected facility. Generally, the Facility Details pages include the main menu 48 (with the Facilities icon 48d still highlighted), a header 824, and an information field 49 including either a Patient List, e.g., as in FIG. 8B, or a Physician List, e.g., as in FIG. 8C. The header 824 may include the facility's name 824a, and, optionally, one or more menu icons or buttons allowing the user to perform various actions. For example, the header 824 may include a Facilities icon or button 824b, which may be selected to return at any time to the Facilities List page of FIG. 8A. Optionally, the header 824 may include a banner field 824c, e.g., including contact information for the selected facility, e.g., address, phone number, e-mail address, and the like. In addition, the header 824 may include a Notes icon 824d, which may be selected to review any notes saved regarding the facility, e.g., from a Contact Information page (not shown).

In addition, the Facility Details pages may include a Patients/Physician menu 828, e.g., in the header including a Patient icon or button 828a and a Physician icon or button 828b. When the Patient icon 828a is selected, the Facility Details page of FIG. 8B may be presented, e.g., including a Patient List in the information field 49, while when the Physician icon 828b is selected, the Facility Details page of FIG. 8C may be presented, e.g., including a Physician List in the information field 49. When the “>” icon 812e for a selected facility is selected from the Facilities List of FIG. 8A, the default may be to present the Facility Details page of FIG. 8B including the Patient List, although alternatively, the default may be whichever Facility Details page was last presented after a “>” icon 812e was previously selected for a facility.

Turning to FIG. 8B, the Patient List within the information field 49 may be similar to that shown in FIG. 6A, except limited to patients associated with the selected facility. As shown, the Patient List includes a Title Row including a plurality of headings 610 over respective columns, and then rows 612 of patient information for individual patients. In the exemplary embodiment shown, the headings 610 include Name 610a, Status 610b, Phone 610c, and Flag 610d. The rows 612 beneath these headings 610 may be populated with corresponding information, e.g., the full names, status (e.g., based on the stages shown in FIG. 5), and phone number, of patients included in the local database who are associated with the selected facility. In addition, one or more of the patient rows may be highlighted by a flag under the Flag heading 610d, as described elsewhere herein.

Similar to the Patient List of FIG. 6A, the information in the Patient List in FIG. 8B may be organized, filtered, and/or searched in a number of ways. For example, the Patient List may include an alphabetical menu 616, and the user may input one of the letters, e.g., by touching or otherwise selecting a desired letter, to include only patients whose last name starts with the selected letter or automatically scroll to the location on the list where the last names begin with the selected letter. In addition, the patient rows may be sorted based on one or more of the columns 610, e.g., by Name 610a, Status 610b, and/or Flag status 610d, as described elsewhere herein.

The Patient List may include additional columns that provide further information, such as a column of physician contact icons 612e, a column of patient information icons 612f, and a column of “>” (“carrot” or “more information”) icons 612g. As described elsewhere herein, the user may select a physician contact icon 612e, whereupon a supplemental window (not shown) may be superimposed over the Patient List or otherwise presented on the display 28a that includes contact information for a primary physician associated with the selected patient, as described elsewhere herein. Similarly, the user may select a patient information icon, 612f, whereupon a supplemental window (not shown) may be superimposed over the Patient List or otherwise presented on the display 28a that includes contact information for the selected patient.

In addition, the user may select a “>” or “more information” icon 612g, whereupon a Patient Profile page or screen may be presented on the display 28a, similar to that shown in FIG. 7E, that includes contact information for the associated patient. Optionally, the Patient Profile page may a Scale 626, e.g., adjacent the information field 49, with the first indicator 626a highlighted. The user may then be able to select the other indicators, if desired, e.g., to review additional information for the patient from other stages (if the patient has progressed to the selected stages or beyond), edit information for the patient, and/or take other actions, similar to other pages herein. When desired, the user may return to the Facility Details page of FIG. 8B, e.g., by selecting a Facility Details icon or button (not shown), e.g., which may be provided instead of the Patient Information icon 730c shown in FIG. 7E.

Turning to FIG. 8C, when the Physicians icon 828b is selected from the Facility Details page of FIG. 8B (or the Physicians List is otherwise presented after a specific facility is selected from the Facility List of FIG. 8A), the Patient List within the information field 49 may be replaced with a Physician List, similar to that shown in FIG. 7A, except limited to physicians associated with the selected facility. As shown, the information field 49 of the Physician List page may include a Title Row including a plurality of headings 710 over respective columns, and then rows 712 of physician information for individual physicians (e.g., for those physicians associated with the selected facility). In the exemplary embodiment shown, the headings 710 include Name 710a, Type 710b, Phone 710c, and Stage 710e. The rows 712 beneath these headings 710 may be populated with corresponding information, e.g., the full names of the physicians, the physician type, and phone number (or alternatively other contact information), for all of the physicians associated with the selected facility.

Similar to the Patient List page, if the number of physician rows exceeds the available space in the information field 49, the user may scroll through the Physician List, e.g., sliding a finger up or down on the touchscreen (or otherwise via a user interface), with the heading row 710 remaining substantially stationary while the physician rows 712 move across the information field 49. Also similar to the Patient List page, the information in the Physician List page may be organized, filtered, and/or searched in a number of ways. For example, a Search field (not shown) may be provided, e.g., in a header 824 or otherwise along a border of the information field 49, into which a user may type search terms to find a specific physician or otherwise limit the number of physicians included in the physician rows 712.

In addition, the Physician List may include an alphabetical menu 716, and the user may input one of the letters, e.g., by touching or otherwise selecting a desired letter, to include only physicians whose last name starts with the selected letter or, alternatively, jump to the section of the list where the last names begin with the selected letter. The physician rows 712 may also be sorted based on one or more of the columns 710, e.g., by Name 710a (e.g., toggling between alphabetical and reverse alphabetical order) or Type 710b (e.g., sorting the physicians alphabetically based on type of physician). Optionally, the user may have the ability and/or authority to add physicians to the Physicians List from the Facilities Detail page of FIG. 8C, as described elsewhere herein.

With continued reference to FIG. 8C, the Stage column 710e may provide a graphical summary regarding patients associated with each physician associated with the selected facility, for example, summarizing the stage of treatment of that physician's patients, as described elsewhere herein. As shown, each physician row 712 identifying a physician associated with the selected facility may include a Stage banner 712e under the Stage header 710e, with the Stage banner 712e including a plurality of fields, e.g., six, as shown, filled with numbers of patients associated with that physician separated by their current stage of treatment. The total numbers in each of the fields of the Stage banner 712e may include only those patients also associated with the selected facility, or may include all of the patients associated with the identified physician within the entire territory. Optionally, the user may be able to add or limit the numbers of patients included in the Stage banners 712e, e.g., based on the selected facility, the entire territory, and/or based on date ranges, as described elsewhere herein.

Thus, the Stage banners 712e may provide a snap-shot of the patients associated with each physician for the selected facility, e.g., to allow sales personnel and/or other users to analyze the facility and their physicians' practice and/or patient relationships, e.g., to identify anomalies or other trends that may require action.

Optionally, the Facility Details/Physician List page of FIG. 8C may include a Total Stage Banner (not shown), e.g., in the header 824 above Stage column 710e or otherwise adjacent the information field 49. The Total Stage Banner may have fields including the total number of patients associated with the selected facility separated by their current stage of treatment, similar to the Stage banner 712e of the individual physicians. Thus, a user may easily review a snap-shot of the status of patients associated with the selected facility, e.g., to confirm at a high level that patients are being identified as candidates and being advanced through treatment in a desired manner. In another option, one or more additional Total Stage Banners (not shown) may be provided adjacent the Total Stage Banner, e.g., a Regional Total Stage Banner that shows the status of all patients within the territory that includes the individual facility, or a Total Stage Banner may be provided for the entire nation or business unit, similar to the Total Stage Banner discussed elsewhere herein with reference.

Returning to FIG. 8C, the Physician List may include additional columns that provide or allow access to further information, such as a column 710f of physician contact icons 712f, and a column 710g of “>” (“carrot” or “Physicians—Patient Information”) icons 712g, similar to the Physician List of FIG. 7A. For example, the physician contact icons 712f may be selected to present additional information regarding the selected physician, e.g., a “quick view” of information, as described elsewhere herein.

In addition, the “>” icons 712g for each physician may be selected to review more detailed information regarding the patients associated with that physician. For example, if the user selects the “>” icon 712g for a physician (and/or the region over the physician's designated for this purpose), the Physician List page may be replaced with a Physicians—Patient Information page, such as that shown in FIG. 7D. The Physicians—Patient Information page may provide a list of patients associated with the selected physician, e.g., also limited to the previously selected facility or including all of the physician's patient in the territory, including their current stage, contact information, and the like. Optionally, the user may then select individual patients from the Physicians—Patient Information page, e.g., to review more detailed information regarding the selected patient, as described elsewhere herein. At any time, the user may select a Facility Physicians or other “Return” icon or button (not shown), e.g., similar to the Physicians icon 724b of FIG. 7B, to return to the Physicians List page of FIG. 8C.

Turning to FIGS. 9A and 9B, exemplary Activities List pages or screens are shown that may be presented when the user selects the Activities icon 48b from the main menu 48. Similar to other pages, the Activities icon 48b may become highlighted on such pages, while the other icons of the main menu 48 may be dimmed or otherwise distinguished from the Activities icon 48b.

Generally, the Activities List page may include the main menu 48, a header 910, and an information field 49 including a list of activities. As shown, the header 910 may include one or more icons or buttons, which may be selected to perform various actions related to new or existing activities related to the user logged into the electronic device 18. For example, a “+” or Add icon or button 918 may be included, e.g., along the border of the information field 49, which may be selected by the user to add an activity.

When the “+” icon 918 is selected, an Add Activity page or screen may be presented on the display 28a, such as that shown in FIG. 9C. In particular, as shown in FIG. 9C, the Add Activity page may include the main menu 48 (with the Activities icon 48a still highlighted), the information field 49, and a header 936. Generally, the header 636 may include a Save icon or button 936a, e.g., to save activity information, and a Cancel icon or button 936b, e.g., to cancel the activity (e.g., after a confirmation prompt) and return to the previous Activities List page, such as that shown in FIGS. 9A and 9B. The information field 49 may include one or more fields related to the new activity being added, e.g., Date and Time fields 938a, Patient Information field 938b, Activity Type field 938c, Employee field 938d, and the like.

Optionally, one or more of the fields may be automatically populated, e.g., depending on the page from which the Add Activity page is selected. For example, the Employee field 938d may automatically include the name of the user logged into the electronic device 18. If the Add Activity page is presented from a Patient Information page (e.g., those shown in FIGS. 6A-6L), the Patient field 938b may automatically include the name of the individual patient from the previous Patient Information page. If the new activity is triggered based on a suggested follow-up, the Activity Type field 938c may also be automatically selected and/or the date and time fields 938a may be automatically populated (e.g., with a date thirty days or other preset time period from the current date).

The user may select and edit any prefilled field(s), e.g., if they want to assign the activity to another team member, change the associated patient, change the date, enter information in any unfilled fields, as desired. Alternatively, all of the fields 938 may be initially blank and the user may fill information as desired or required by the available fields. Once the information for the new activity is entered, the user may select the Save button 936a to save the new activity in the temporary and/or local database. The Add Activity page may then be closed, and the previous page or screen may be presented on the display 28a. Alternatively, the user may select the Cancel icon 936b to clear the fields and/or exit the Add Activity page and return to the previous page, e.g., one of the Activities List of FIG. 9A or 9B.

Returning to FIG. 9A, an exemplary Activities List page is shown that may include a list of activities within the information field 49 that are assigned to the user logged into the electronic device 18. For example, when the Activities icon 48a is first selected from the main menu 48, the default may be to present activities assigned to the user logged into the electronic device 18, as shown in FIG. 9A. A My/Team Activities icon or button 926 may be provided, e.g., in the header 910 or other location adjacent the information field 49, allowing the user to switch between activities assigned to them individually and activities assigned to one or more team members.

For example, if the My Activities icon 926 shown in FIG. 9A is selected, the processor 22 may toggle between the Activities List shown in FIG. 9A and the Activities List shown in FIG. 9B (changing the My Activities icon 926 to Team Activities, as shown in FIG. 9B). Alternatively, when the My Activities icon 926 is selected, a pulldown menu or other submenu (not shown) may be presented allowing the user to select an available option, e.g., My Activities, Team Activities, or other options (not shown).

In addition, the header may include a set of Filter icons or buttons 928, e.g., to allow the user to present either only open or unfinished activities, e.g., by selecting the Open icon or button 928a, or only completed or inactive activities, e.g., by selecting the Completed icon or button 928b. When the Activities icon 48a is first selected from the main menu 48, the default may be to present only Open activities, although alternatively other defaults may be used (e.g., defaulting to Open or Completed activities based on the most recent type of activities previously presented) or the user may be prompted to select one of the available Filter icons 928 before any activity information is presented in the information field 49.

Optionally, the user may be able to search for one or more activities, e.g., by selecting a Search icon or button 914 in the header 910 or elsewhere adjacent the information field 49. For example, when the user selects the Search icon 914, an active field may be opened to allow the user to enter one or more search terms, e.g., an activity category, a name (e.g., of a patient, physician, team member, or medical facility), a date, and/or word searches. When one or more such terms are entered, the processor 22 may access the local database to search for activities that meet the search criteria and present only the matching activities in the Activity List. Otherwise, the default may be to present all of the activities assigned to the logged-in user, to the user's team, and the like based on the selections or defaults from header menu options 926 and/or 928.

As shown in FIGS. 9A and 9B, the list of activities may generally include a Date column 940 and an Activity Information column 942, e.g., with optional headings, not shown, above rows of activities. For example, the fields under the Date column 940 may include a Date Information field 940a and an Activity Category field 940b for the activity. The Date Information field 940a may include one or more of a date and/or time of the activity (e.g., 19 Apr. 2013, as shown in the first row), a relationship of the activity date to the current date (e.g., “today,” as shown in the third row, yesterday, or tomorrow, not shown), and/or a duration of the activity (e.g., 10:00 am to 11:00 am, as shown in the first row, other blocks of time, “all day,” as shown in the last row, and the like). The Activity Category field 940b may provide an identifier of the type activity, such as Appointment, Phone Call, Trial Procedure, Implant Procedure, which may facilitate reviewing a list of activities without having to read the details in the Activity Information fields.

The Activity Information fields 942 may include a Party List field 942a (again including generic names, e.g., QWE AH and HGF DH) and a Detailed Description field 942b. The Party List field 942a may include one or more names of parties associated with the activity, e.g., one or more patients, physicians, team members, medical facilities, and the like, and the Detailed Description field 942b may include a freeform or other description of the activity itself.

In the exemplary embodiment shown in FIG. 9A, for an Activities List of the user's activities, the Party List field 942a may include up to two relevant parties. The parties listed may be prioritized in a predetermined manner, for example, either patient/physician, patient/facility (if there is no associated physician), patient alone (if there is no associated physician or facility), physician/facility (if there is no associated patient), physician alone (if there is no associated patient or facility), or facility alone (if there is no associated patient or physician).

Alternatively, in the exemplary embodiment shown in FIG. 9B, for an Activities List of team activities, the Party List field 942a may include up to three (or any other present number of) relevant parties. The parties listed may again be prioritized in a predetermined manner, for example, either patient/physician/team member, patient/facility/team member (if there is no associated physician), patient/team member (if there is no associated physician or facility), physician/facility/team member (if there is no associated patient), physician/team member (if there is no associated patient or facility), facility/team member (if there is no associated patient or physician), or team member alone (if there is no associated patient, physician, or facility).

As shown, the activities may be sorted chronologically, e.g., with the earliest dates at the top of the list and the latest dates at the bottom of the list. If the Activities List is longer than may be presented in the information field 49, the user may scroll up or down to review other activities on the Activities List, similar to other pages herein. Optionally, the activities on the Activities List may be sorted in other ways, e.g., reverse chronologically, e.g., by selecting a region above the columns and/or opening a submenu (not shown) in the header 910 or information field 49.

In addition or alternatively, the user may select a party associated one of the activities in the list, for example, by selecting an icon or button adjacent the party's name, e.g., button 94c adjacent the generic name “FGD AK” in the first row, whereupon a list of activities that identify the selected party may be included in the Activities List and any that do not identify the selected party may be omitted.

In addition, as shown in FIG. 9A, the header 910 may include a New Activity banner or field 912, which may provide a notice to the user of new activities added to the user's Activity List and/or added since the most recent time the user selected the Activities icon 48a from the main menu 48. For example, activities that have been assigned to the user or otherwise added by another team member or person, e.g., using another electronic device 18 that synchronizes with the medical database 14, may be added to the local database when the user's electronic device 18 synchronizes with the medical database 14, thereby qualifying as a new activity. In the exemplary embodiments shown in FIGS. 9A and 9B, the New Activity banner 912 indicates that “1 new activity” has been assigned to the user.

Optionally, to facilitate locating and/or reviewing new activities, a Flag or other indicator may be associated with each new activity. For example, as shown in FIG. 9A, a “New” indicator 940c has been included in the Date column 940 for the new activity, e.g., over or adjacent the Date information field 940a for the activity. After the user has selected and reviewed the activity, the “New” indicator 940c may be removed. Alternatively, the information field 49 may include a separate Flag column (not shown) adjacent one of the other columns, e.g., similar to the Flag columns used in other Lists. In this alternative, new activities may include a Flag, which may be selected and removed, e.g., after the user has reviewed the activity.

In addition, if desired, the user may select an activity to review more detailed information. For example, the user may select, e.g., touch and hold, the row of a desired activity, whereupon the Activities List may be replaced with an Activity Detail page or screen, which may be similar to the Add Activity page of FIG. 9C. When the user has finished reviewing (and/or editing the activity), the user may select a Back icon or button (not shown), e.g., similar to the Save or Cancel icons shown in FIG. 9C to return to the Activities List page.

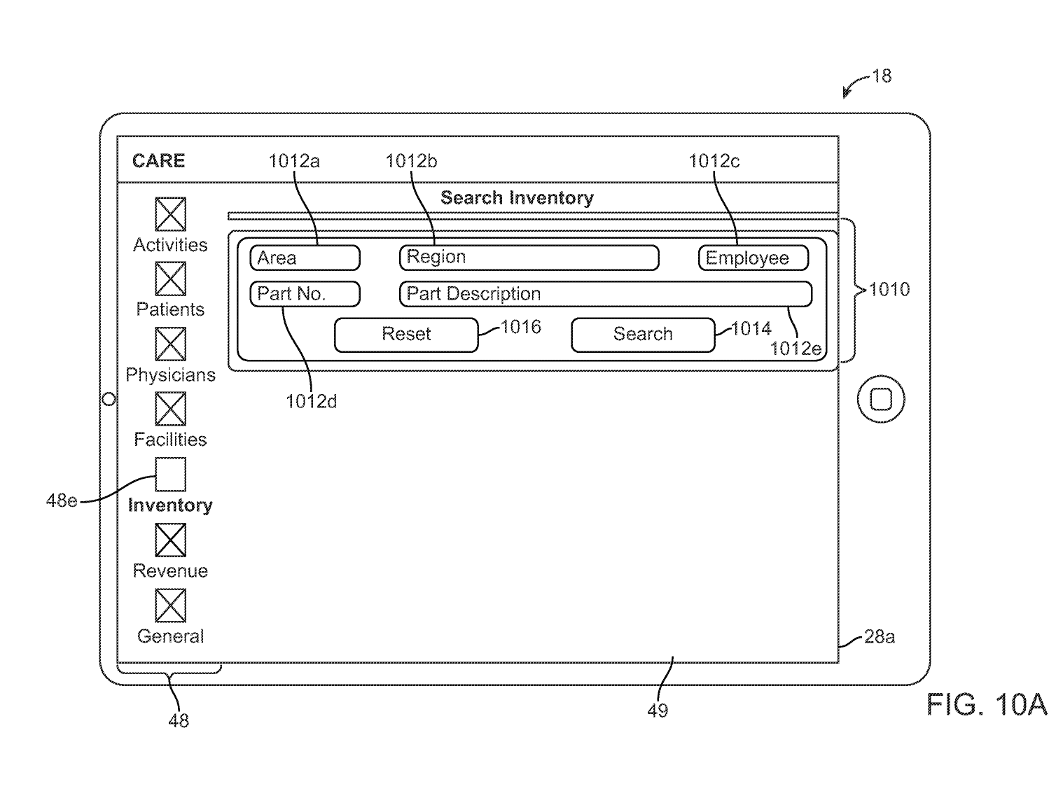

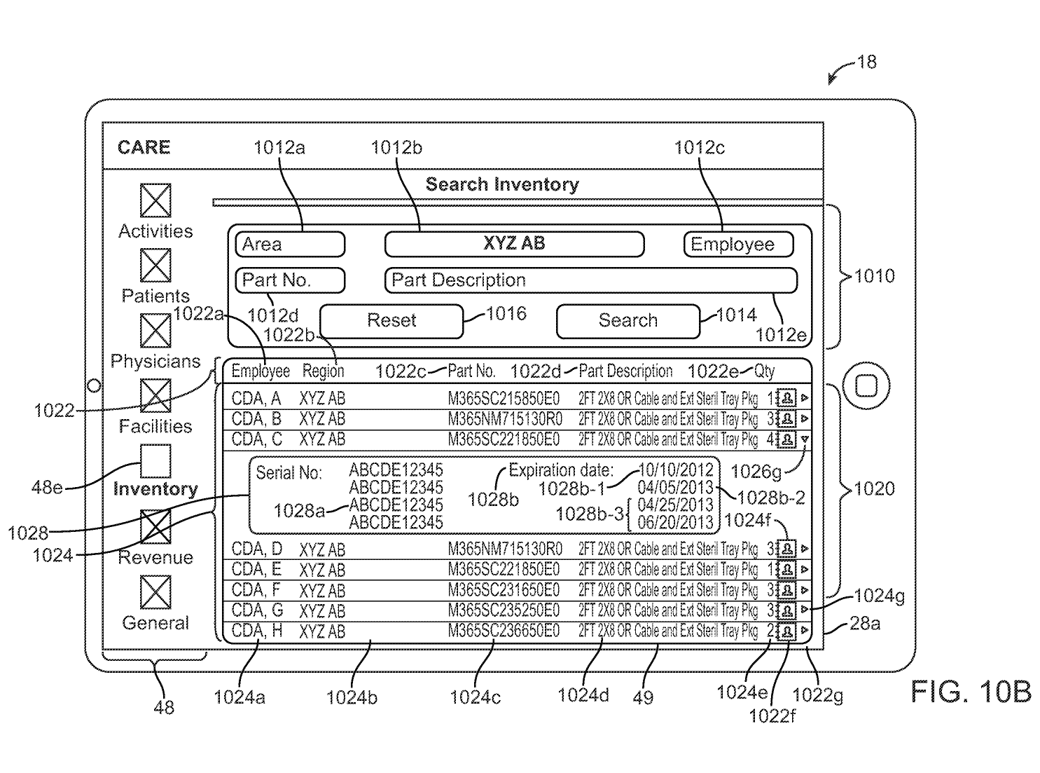

Turning to FIG. 10A, the application may also allow the user to search for one or more products of interest. For example, in some medical fields, sales representatives may be allocated inventory of systems, components, or other parts, e.g., from a central warehouse or other inventory system. Thus, in addition to or instead of having a central location for parts, the sales reps may maintain a supply of parts that may be used when called for during a procedure.

For example, within the field of spinal cord stimulation or “SCS” treatment, sales reps and/or other team members may keep a number of leads, external stimulators, implantable stimulators, external controllers, and the like in their possession or personal inventory. Thus, when the sales rep attends a trial or implant procedure, the sales rep may access their personal inventory for parts for the procedure rather than requesting parts from a central location. Such distributed inventory arrangements may facilitate timely treatment of patients as opposed to waiting for parts to ship from a central warehouse.

To facilitate maintaining such a distributed inventory arrangement, the medical database 14 may maintain a current inventory of products assigned to each sale rep or other team member within each territory. With additional reference to FIGS. 1 and 2, when electronic devices 18 synchronize with the medical database 14, they may receive current inventory information for the territories selected for the respective electronic devices 18, thereby providing a searchable inventory database. Alternatively, the local databases may not include distributed inventory information, and instead the electronic devices 18 may send search inquiries to the administrator server 12, which may access the medical database 14 and provide relevant search results to the electronic devices 18, as described further below.

For example, turning to FIG. 10A, an exemplary Inventory Search page or screen is shown that may be presented on an electronic device 18 when the Inventory icon 48e is selected from the main menu 48. Similar to other pages, when selected, the Inventory icon 48e may be highlighted or otherwise distinguished from the other icons of the main menu 48.

As shown, the information field 49 of the Inventory Search page may include a Search Window 1010, e.g., including one or more search fields 1012, a Search icon or button 1014, and a Reset icon or button 1016. The Search Window 101 may include a number of search fields 1012 into which the user may enter search terms, e.g., an Area field 1012a, Region field 1012b, Employee field 1012c, a Part No. field 1012d, and a Part Description field 1012e. The user may enter one or more terms into one or multiple fields 1012, and then select the Search icon 1014 to prompt the processor 22 to access and search the local database or send a search inquiry to the administrator server 12. If the user decides to change the search criteria, at any time, the user may select the Reset icon 1016 to clear any search fields 1012 and start over.

The search fields 1012 may be freeform fields or may include pulldown or other fixed option submenus (not shown). For example, within the territory of the local database, there may be a fixed number of Areas or Regions, and so when the user selects the Area field 1012a or Region field 1012b, a pulldown submenu may be presented with the available areas or regions, and the user may scroll through the options until they find and select the desired area or region. Similarly, the user may select the Employee field 1012c, which may result in a pulldown submenu being presented including a list of all of the employees within the territory (or within an area or region, if also selected from the Area or Region fields 1012a, 1012b).

Also similarly, if the number of available parts is limited, the user may select the Part No. field 1012d, whereupon a pulldown submenu of part numbers may be presented through which the user may scroll and select a desired part number. Alternatively, the Part No. field 1012d may allow the user to enter all or a portion of a part number into the Part No. field 1012d. The processor 22 may attempt to predict the desired part number as the number is entered, or may simply wait for the user to enter as much information as they want before selecting the Search icon 1014. Finally, the user may also enter terms to describe the part or parts they desire in the Part Description field 1012e, which may facilitate locating desired part(s) for which the user does not know the part number.

For example, if the user learns that they need to attend a procedure at a certain geographical location but do not have one or more parts for the procedure, they may conduct a search selecting the area or region including the location of the procedure in the Area or Region fields 1012a, 1012b, and the part number and/or part description in the Part No. and/or Part Description fields 1012d, 1012e. The user may then select the Search icon 1014 to obtain search results that match the criteria entered. In another example, the user may know that a particular team member has certain parts and may select that team member in the Employee field 1012c with or without entering additional information in the Part No. and/or Part Description fields 1012d, 1012e.

Turning to FIG. 10B, an exemplary Search Results page or screen is shown in which a region has been selected in the Region field 1012b and the Search icon 1014 has been selected to initiate a search. As shown, the information field of the Search Results page may include a Results Field 1020, e.g., an Inventory List below or otherwise adjacent the Search Field 1010.

As explained above, if the local database includes current inventory information, the processor 22 of the electronic device 18 may access the local database and identify any parts that satisfy the search criteria, in this case any parts within the region “XYZ AB” (again a generic name for the territory) entered in the Region field 1012b, and generate a list of available parts.

Alternatively, if the local database does not include current inventory information, the processor 22 may transmit a search request, via the communication interface 26 of the electronic device 18, to the administrator server 12, e.g., via the network 10 with the request identifying the entries in the search fields 1012 (again in this case any parts within the region “XYZ AB” entered in the Region field 1012b). The administrator server 12 may then access the medical database 14 and identify any parts that satisfy the search criteria, and send a data file back to the electronic device 18 including a list of available parts satisfying the request.

Thereafter, whether from the local database or the administrator server 12, the processor 22 may then present on the display 28a the list of available parts, optionally including additional information associated with each part in the Inventory List 1020. For example, as shown in FIG. 10B, the Inventory List 1020 include a Title Row 1022 of headings and rows 1024 including information parts satisfying the search criteria. In the exemplary embodiment shown, the headings 1022 include Employee 1022a, Region 1022b, Part No. 1022c, Part Description 1022d, and Quantity 1022e. The rows 1024 beneath these headings 1022 may be populated with corresponding information, e.g., the part nos. and descriptions 1024c, 1024d of the parts satisfying the search criteria, the names of the employees or team members 1024a whose personal inventories include the available parts, the regions 1024b of the team members 1024b, and the number of each of the parts 1024e in the team members' personal inventories.

In addition, the Inventory List 1020 may include additional columns, e.g., a column of Employee Contact icons 1022f, and a column of “>” or “More Information” icons 1022g. The Employee Contact icons 1022f may be selected to present additional information regarding a selected team member, e.g., providing a “quick view” of information. For example, similar to the window shown in FIG. 7C, the user may select an Employee Contact icon 1022f, whereupon a supplemental window (not shown) may be superimposed over the Inventory List or otherwise presented on the display 28a that includes contact information for the selected team member, e.g., phone numbers, e-mail addresses, physical addresses, and the like.

The “>” icon 1022g may be selected by the user to present additional information regarding the parts identified in the selected row. For example, an “>” icon may be selected, whereupon the “>” icon may be toggled to a “V” icon 1026g, as shown in FIG. 10B, and a supplemental window 1028 may be presented within or adjacent the Inventory List 1020. For example, the supplemental window 1028 may be presented immediately below the row of the selected “>” icon such that the team member name, part no., and other information for the selected part may still be seen. The next row below the selected row may be pushed down below the supplemental window 1028, as shown (or the supplemental window 1028 may be superimposed over rows below the selected row). When the “V” icon 1026g is selected again, the supplemental window 1028 may be removed and the “>” icon returned, thereby collapsing the following rows back adjacent the selected row.

The supplemental window 1028 may include specific information regarding the parts identified in the selected row, e.g., individual Serial Nos. 1028a and/or expiration dates 1028b for the parts in the possession of the identified team member, as shown. For example, certain medical devices may have a date by which the devices must be used to treat a patient, e.g., implanted or otherwise used. After the shelf life or “expiration” date, the devices should not be used to treat a patient, but may still be used for other purposes, e.g., as samples for patients, physicians, and the like to learn more about the devices.

Optionally, as shown, the expiration dates 1028b may be color coded to identify a status of each of the available parts relative to their expiration dates. For example, expiration date 1028b-1 in the supplemental window 1028 may be colored red or another color indicating that the identified part is past its expiration date. Expiration date 1028b-2 may be colored gold or another color indicating that the identified part is close to its expiration date, e.g., within a thirty day or other preset range from its expiration date. Expiration dates 1028b-3 may be colored black or yet another color (e.g., similar to other text in the supplemental window 1028 and/or the Inventory List 1020) indicating that the identified parts are not close to their expiration dates, e.g., outside of a thirty date or other present range from their expiration dates.

In this manner, the user may be able to quickly and easily identify available parts that have not yet reached their expiration date. In particular, if a user has a procedure coming up and needs parts from another team member, they may identify parts that are close to their expiration dates (but not yet expired) and use those in order to avoid the parts reaching their expiration dates. Parts that are beyond their expiration date may be selected for demonstration or other purposes, if desired. Thus, color coding the expiration dates and/or Serial Nos. of the individual parts may enhance that parts close to their expiration dates are selected and used before those having a substantially longer shelf life remaining.

Optionally, when the user identifies an available part that they would like to obtain, they may initiate contact with the team member in possession of the desired part, e.g., to arrange delivery of the selected medical device. For example, the user may select the Employee Contact icon 1024f for the desired team member, whereupon a supplemental window (not shown) may be presented that includes the team member's contact information. The user may then be able to contact the team member and request that the team member ship or deliver the desired part. For example, the supplemental window may include an E-mail icon (not shown), and the user may select the icon to send an e-mail communication to the team member.

The communication may be sent directly to the team member (i.e., without going through the administrator server 12 but through other existing communications networks, such as the network 10), e.g., using e-mail software available on the electronic device 10. Alternatively, the electronic device 18 may send a communication, via the communication interface 26, to the administrator server 12 intended for delivery to the other team member's electronic device 18. For example, the communication may request that the other team member ship the desired part, or personally deliver the desired part to the physician and/or medical facility where the procedure is to be performed or to the user. In addition, the communication may identify the specific serial no. of a desired part, e.g., to request that a part approaching its expiration date be delivered.

Optionally, the information in the Inventory List 1020 may be sorted in one or more ways. For example, one or more of the headings 1022 may include associated icons or active fields (not shown), which may be selected whereupon the rows 1024 may be sorted based on the selected heading(s) 1022. For example, a user may select the Employee heading 1022a to see what parts each team member within the territory has that otherwise satisfy the other search criteria. In this manner, a user may be able to identify a single team member who has multiple parts that the user needs, thus facilitating the user obtaining the parts from a team member rather than having to coordinate delivery from several team members.

Alternatively, the user may select the Part No. or Part Description headings 1022c, 1022d to sort the parts by number or description. This may be useful if the user only entered a partial part no. or part description in the Part No. or Part Description search fields 1012d, 1012e, e.g., if the user did not know the complete part no. or description, if the user wanted to search for multiple parts having similar partial part nos. or descriptions, and the like.

In another alternative, the Inventory List 1020 may include one or more additional columns in addition to or instead of those shown in FIG. 10B, or the user may be able to expand or add one or more columns to the Inventory List. For example, it may be desirable to add the Serial No. or Expiration Date columns shown in the supplemental window 1028 in the Inventory List 1020, and then sort parts by their expiration date. In this manner, the user may search for specific parts throughout an area or region and sort them to select the parts closest to their expiration date.

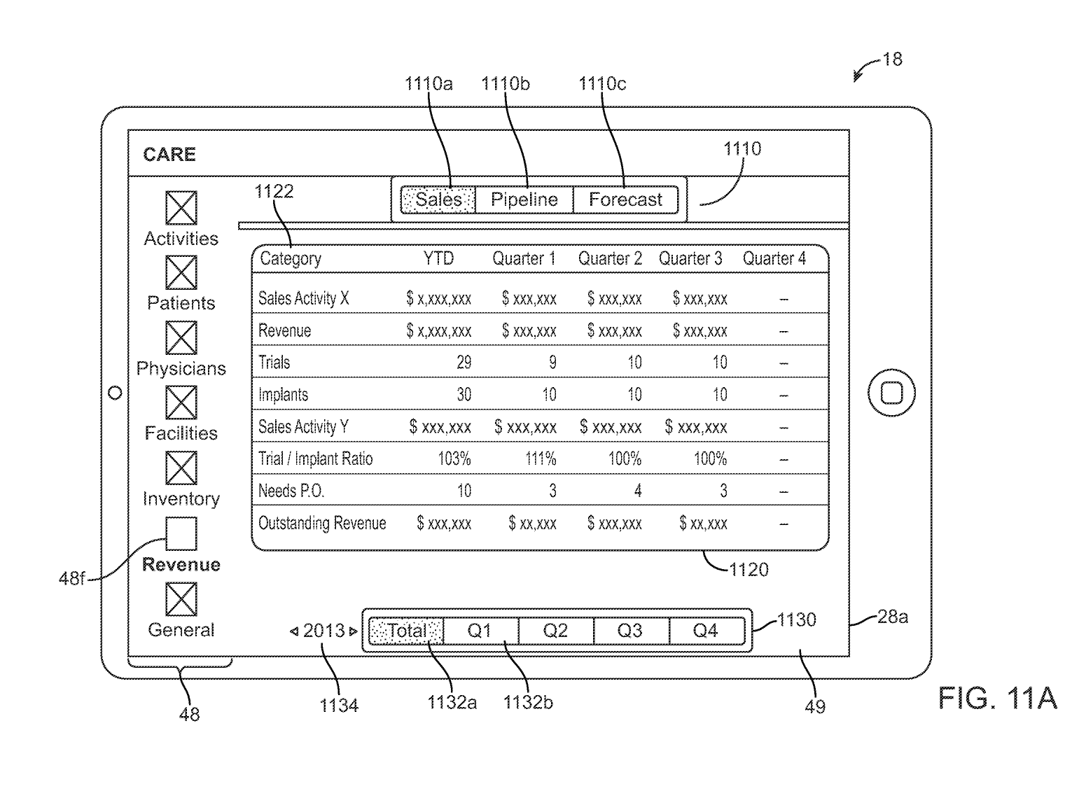

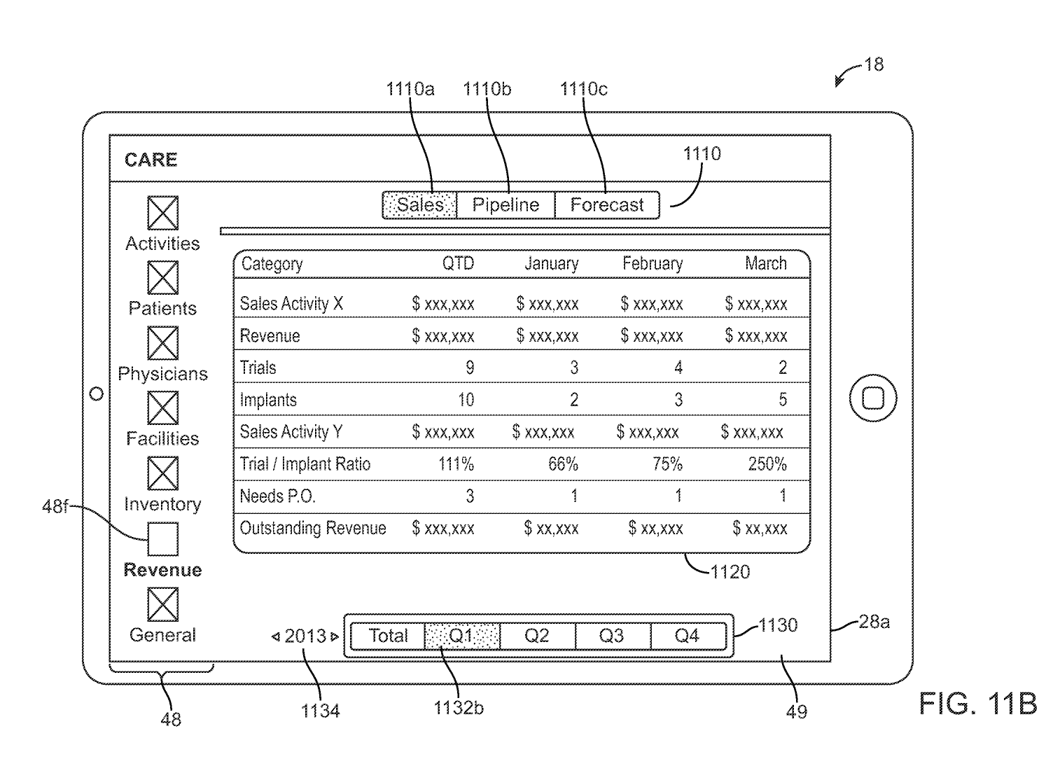

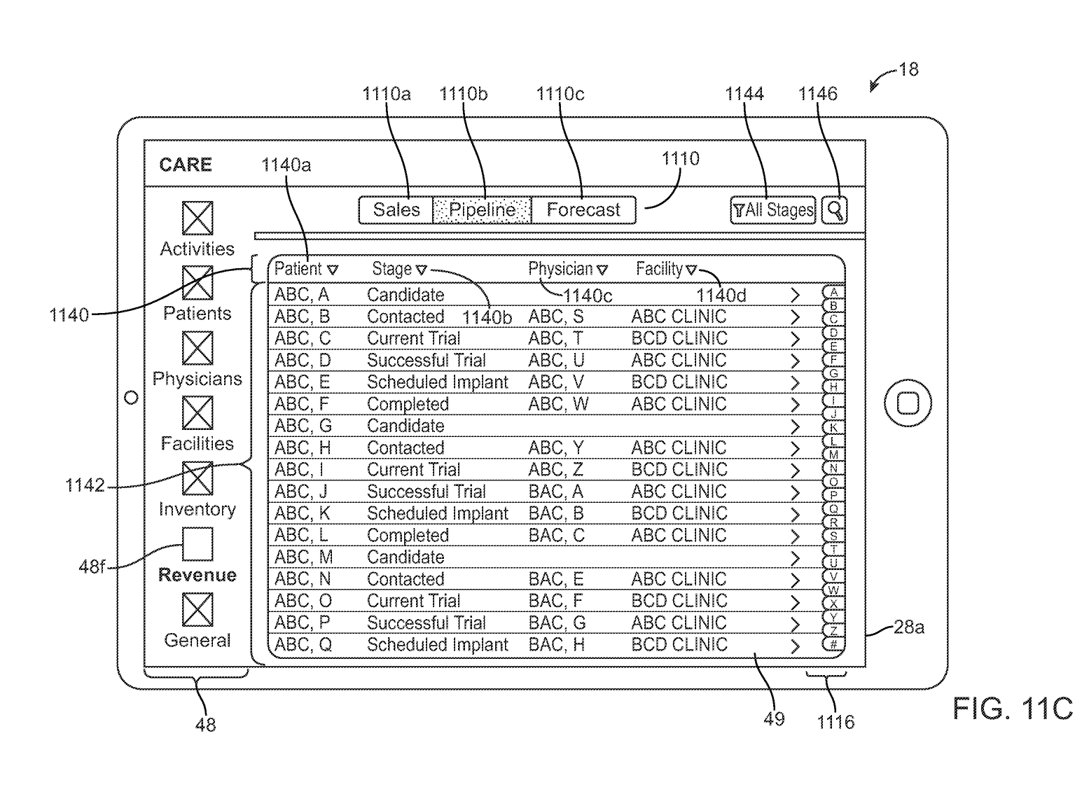

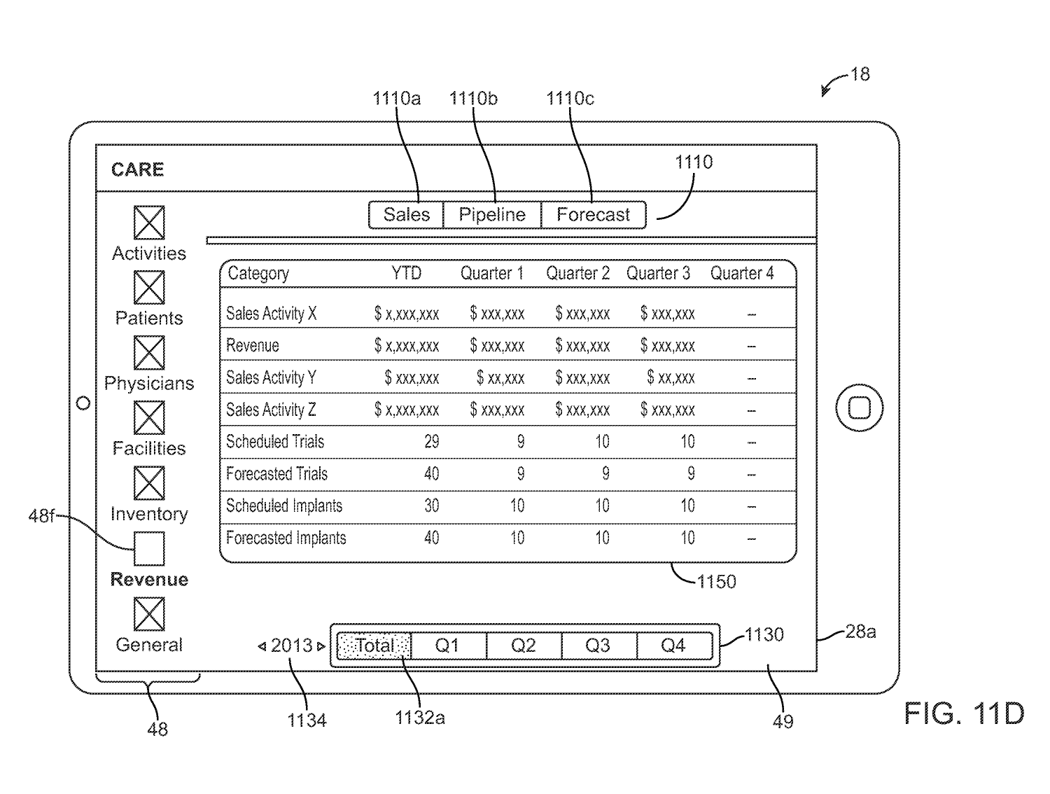

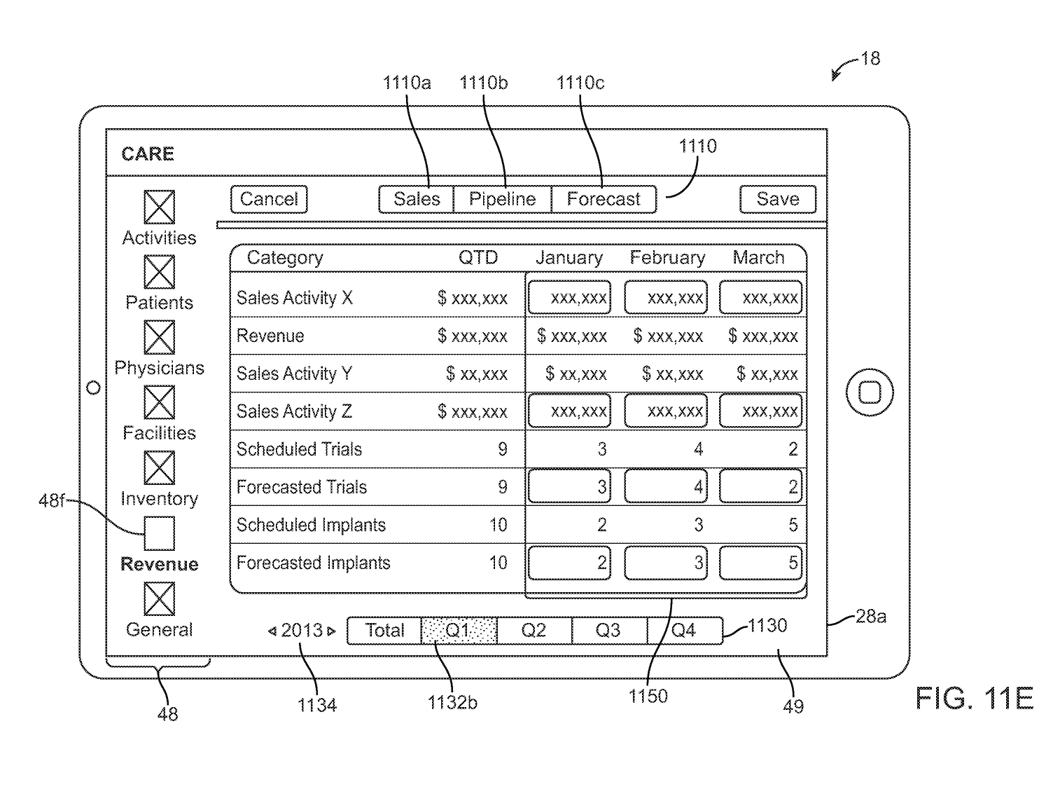

Turning to FIGS. 11A-11E, exemplary pages or screens are shown that may be presented when the Sale Activities icon 48f is selected from the main menu 48. Similar to other pages herein, the Sales Activities icon 48f may be highlighted relative to the other icons of the main menu 48, and an information field 49 may be presented, which includes information related to sales of medical devices, e.g., based on actual sales of products used to treat patients, to predict future sales, and the like.

Generally, as shown in FIG. 11A, the information field 49 may include data accessed from the local database of the electronic device 18 and presented on the display 28a. Alternatively, the data may be acquired by sending a request to the administrator server 12, which may then access the medical database 14 to generate the requested data and transmit the data back to the electronic device 18 for presentation on the display 28a.

FIG. 11A may represent a default Sales Tab page that is presented when the Sales Activities icon 48f is initially selected from the main menu 48. Alternatively, the Pipeline Tab page of FIG. 11C or the Forecast Tab page of FIG. 11D may be the default page. Regardless, each of the pages may include a tab menu 1110, e.g., including a Sales icon or button 1110a, a Pipeline icon or button 1110b, and a Forecast icon or button 1110c, which may allow the user to toggle between the pages of FIGS. 11A, 11C, and 11D, respectively.

FIG. 11A shows an exemplary page in which the information field 49 includes a Sales Summary window 1120, which may provide information regarding products sold and used to treat patients, e.g., in trial procedures or long term implant procedures, such as those described elsewhere herein. In addition, the information field 49 may include a calendar menu 1130, e.g., including a plurality of quarter icons or buttons 1132 allowing the user to change a date range for information included in the Sales Summary window 1120.

For example, as shown in FIG. 11A, the Total icon 1132a is selected, whereupon sales data for the entire calendar year (or year-to-date for the current year) are included in the Sales Summary window 1120. By comparison, in FIG. 11B, the Q1 icon 1132b has been selected in the calendar menu 1103, whereupon sale data for only the first three months of the calendar year are included in the Sale Summary window 1120. The calendar menu 1130 may also include a Year menu 1134, e.g., which may be selected to change the year while the quarter icons 1132 identify the period of the identified year for which data is included in the Sales Summary window 1120.

Turning to FIG. 11C, when the Pipeline icon 1110b is selected, the information field 49 may include a Patient List, e.g., identifying patients who are still considering treatment, scheduled to complete treatment, but have not yet become inactive. The Patient List generally includes a Title Row including headings 1140, such as Patient Name 1140a, Stage 1140b, Physician 1140c, and Facility 1140d, and the rows 1142 may include the names of patients, their current stage, and the physician and/or medical facility associated with respective patients. Similar to other lists, the Patient List may be sorted, e.g., by selecting one of the headings 1140, by selecting a letter from an alphabetical menu 1116, or by using a Search Field 1146, e.g., to search for specific patients, stages, physicians, or facilities. In addition, a Stage menu 1144 may be provided, allowing the user to include patients at all stages, or selecting individual stages from a pulldown menu of the Stage menu 1144 to include only patients currently at the selected stage.

Turning to FIGS. 11D and 11E, exemplary pages are shown when the Forecast icon 1110c is selected. In these pages, the user may display and edit sales forecasts for the user in the Sales Forecast window 1150.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A system for managing patients during medical treatment, comprising:
a server;
a medical database communicating with the server, the medical database including patient information associated with patients within a territory undergoing medical treatment, the medical information including a status of each patient indicating a stage of treatment, one or more pre-treatment stages, and one or more treatment stages;
a communication interface for communicating between the server and a plurality of team electronic devices associated with at least one respective team member within the territory, the communication interface configured to receive communications from individual team electronic devices indicating that patients have advanced between stages of treatment, whereupon the server updates the status of the patients in the medical database to reflect the current status of patients between the stages of treatment;
the server configured to, via the communication interface, synchronize a local database of the team electronic devices with the medical database to update the local database with the statuses of patients in the medical database such that team members may review the current status of an individual patient in the medical database.

2. The system of claim 1, wherein at least some of the communications include a confirmation that identified patients have advanced from one of a candidate for treatment stage to a pre-treatment stage, or a pre-treatment stage to a treatment stage.

3. The system of claim 1, wherein at least some of the communications include a confirmation that identified patients have advanced from one of a candidate for treatment stage to a trial pre-op stage, a trial pre-op stage to a trial treatment stage, a trial treatment stage to an implant prep stage, or an implant prep stage to an implant stage.

4. The system of claim 2, wherein at least some of the communications confirm that an identified patient has advanced from a candidate for treatment stage to a pre-treatment stage, and wherein at least some of the communications include a consultation image including a graphical image of at least a portion of a body and consultation indicia added to the graphical image using a team electronic device that identifies one or more regions of the identified patient's body for treatment based at least in part on the identified patient's input, the server updating the medical database to include the consultation image.

5. The system of claim 4, wherein at least some of the communications confirm that an identified patient, previously advanced from a candidate for treatment stage to a pre-treatment stage, has been further advanced to a treatment stage indicating that the identified patient has been scheduled for treatment, the communications including information regarding the scheduled treatment of an identified patient comprising one or more of a physician expected to complete the scheduled treatment, a treatment date for the scheduled treatment, a treatment facility where the scheduled treatment is to be completed, a team member assigned to attend the scheduled treatment, insurance information for the identified patient, and one or more regions of the identified patient's body intended for the scheduled treatment.

6. The system of claim 5, wherein at least some of the communications from a first team member electronic device sending the communications includes an activity assigned to a second team member requesting the second team member attend the scheduled treatment, the server configured to communicate the activity to a second team member electronic device.

7. The system of claim 5, wherein at least some of the communications confirm that an identified patient scheduled for treatment has completed treatment, the communications including a treatment image comprising the consultation image of the identified patient and treatment indicia added to the graphical image using a team electronic device that identifies one or more regions of the identified patient's body affected by the treatment based at least in part on the patient's input, the server updating the medical database to include the treatment image.

8. The system of claim 7, wherein at least some of the communications include one or more photographs taken with a team member electronic device of images related to treatment of the identified patient, the server updating the medical database to include the one or more photographs.

9-10. (canceled)

11. The system of claim 2, wherein, when the server receives a confirmation that an identified patient has advanced from one of a candidate for treatment stage to a pre-treatment stage, or a pre-treatment stage to a treatment stage, the server is configured to send a communication to the identified patient including information regarding the pre-treatment stage or treatment stage.

12. The system of claim 11, wherein the server is configured to send a communication to a representative assigned to the identified patient to provide the representative an opportunity to override or customize the communication to the identified patient before the communication is sent to the identified patient.

13. A method for managing patients during medical treatment using a server communicating with a plurality of team electronic devices associated with respective team members within a territory; a medical database communicating with the server that includes patient information associated with patients within the territory undergoing medical treatment, the medical information including a status of each patient indicating a stage of treatment between a candidate for treatment stage, one or more pre-treatment stages, and one or more treatment stages, the method comprising:
receiving, at the server, a first communication from a team electronic device indicating that a patient at a candidate for treatment stage has decided to proceed with treatment, the server updating the status of the patient to pre-treatment stage;
receiving, at the server, a second communication from a team electronic device indicating that the patient has been scheduled for treatment, the server updating the status of the patient in the medical database to treatment stage; and
receiving, at the server, a third communication from a team electronic device indicating that the patient has completed treatment,
wherein the server intermittently synchronizes the medical database with local databases on the team electronic devices to update the local databases with information regarding the patient including the status of the patient.

14. The method of claim 13, wherein the second communication includes information related to the scheduled treatment comprising at least one of a physician name identifying the physician expected to complete the scheduled treatment, a treatment date for the scheduled treatment, a treatment facility where the scheduled treatment is to be completed, a team member assigned to attend the scheduled treatment, insurance information for the patient, and one or more regions of the patient's body intended for the scheduled treatment, the server updating the medical database to include the information.

15. The method of claim 14, wherein the second communication further comprises a consultation image including a graphical image of at least a portion of a body, and consultation indicia added to the graphical image using a team electronic device that identifies one or more regions of the patient's body for treatment based at least in part on the patient's input, the server updating the medical database to include the consultation image.

16. The method of claim 15, wherein the third communication further comprises a treatment image including the consultation image and treatment indicia added using a team electronic device that identifies one or more regions of the patient's body affected by the treatment based at least in part on the patient's input, the server updating the medical database to include the treatment image.

17. The method of claim 16, wherein the third communication further comprises one or more photographs taken with a team member electronic device of images related to the treatment of the patient, the server updating the medical database to include the one or more photographs.

18. The method of claim 14, wherein the second communication further comprises an activity assigned to a team member requesting the team member attend the scheduled treatment, the method further comprising the server sending a communication including the activity to a team member electronic device used by the assigned team member.

19-26. (canceled)

27. The method of claim 13, wherein, in response to receiving one of the first and second communications, the server sends a communication to the patient including information regarding the pre-treatment stage or treatment stage.

28. The method of claim 27, wherein, before sending the communication to the patient, the server sends a communication to a representative assigned to the patient to provide the representative an opportunity to override or customize the communication to the patient.

29. (canceled)

30. A method for managing a patient during pain management treatment, comprising:
a) presenting on a display of a first team electronic device information regarding a patient who is a candidate for pain management treatment and a scale including a plurality of icons representing stages of treatment of the patient;
b) after initial consultation with the patient:
i) entering, via a user interface of the first team electronic device, patient information including confirmation that the patient would like to enter trial pain management treatment; and
ii) selecting an icon presented on the display of the first team electronic device to advance the patient to a trial pre-op stage;
c) thereafter, during or after pre-trial consultation with the patient:
i) presenting, on a display of a second team electronic device, information regarding the patient including information entered using the first team electronic device, wherein a second icon on the scale is highlighted relative to other icons on the scale indicating the patient is at the trial pre-op stage;
ii) entering, via a user interface of the second team electronic device, pain information regarding pain being experienced by the patient; and
iii) selecting an icon presented on the display of the second team electronic device to advance the patient to a trial stage;
d) thereafter, after a trial procedure in which a set of leads are implanted in the patient's body:
i) presenting, on a display of a third team electronic device, pain information regarding the patient including information entered using the second team electronic device, wherein a third icon on the scale is highlighted relative to other icons on the scale indicating the patient is at the trial stage; and
ii) entering, via a user interface of the third team electronic device, trial treatment information regarding pain treatment being experienced by the patient after the second procedure.

31-34. (canceled)

35. The method of claim 30, further comprising:
e) after consultation with the patient after the trial procedure:
i) presenting, on a display of a fourth team electronic device, patient information regarding the patient including information entered using the third team electronic device, wherein a third icon on the scale is highlighted relative to other icons on the scale indicating the patient is at the trial stage;
ii) entering, via a user interface of the fourth team electronic device, patient information including confirmation that the patient would like to complete implantation of a permanent pain management system; and
iii) selecting an icon presented on the display of the team electronic device to advance the patient to an implant prep stage;
f) thereafter, after confirming scheduling of a second procedure:
i) presenting, on a display of a fifth team electronic device, patient information regarding the patient, wherein a fourth icon on the scale is highlighted relative to other icons on the scale indicating the patient is at the implant prep stage; and
ii) selecting an icon presented on the display of the team electronic device to advance the patient to an implant stage;
g) thereafter, after a second procedure in which a second set of leads are implanted in the patient's body:
i) presenting, on the display of a sixth team electronic device, pain information regarding the patient, wherein a fifth icon on the scale is highlighted relative to other icons on the scale indicating the patient is at the implant stage; and
ii) entering, via a user interface of the sixth team electronic device, treatment information regarding pain treatment being experienced by the patient after the second procedure.

36-195. (canceled)
